(19) United States
(12) Patent Application Publication
(10) Pub. No.: US 2015/0141114 A1
(43) Pub. Date: May 21, 2015

(54) ELECTRONIC GAMING DEVICE WITH TREASURE SPIN FUNCTIONALITY

(71) Applicants: Steven Davis, Suwanee, GA (US); Jennifer Williamson, Norcross, GA (US); Jason Pawloski, Atlanta, GA (US)

(72) Inventors: Steven Davis, Suwanee, GA (US); Jennifer Williamson, Norcross, GA (US); Jason Pawloski, Atlanta, GA (US)

(73) Assignee: CADILLAC JACK, Duluth, GA (US)

(21) Appl. No.: 14/086,296

(22) Filed: Nov. 21, 2013

(51) Int. Cl. G07F 17/34

(52) U.S. Cl. CPC G07F 17/34
USPC 463/20

(57) ABSTRACT

Examples disclosed herein relate to an electronic gaming device including a memory, a processor, and a plurality of reels. The memory may include one or more treasure spin feature structures. The processor may generate one or more symbols to be located in the one or more areas. The processor may generate a first treasure symbol and move the first treasure symbol to a collection area, where the first treasure symbol has an equity value.

### FIELD

The subject matter disclosed herein relates to an electronic gaming device. More specifically, the disclosure relates to providing one or more treasure spin functionalities on a gaming device.

### INFORMATION

The gaming industry has numerous casinos located both worldwide and in the United States. A client of a casino or other gaming entity can gamble via various games of chance. For example, craps, roulette, baccarat, blackjack, and electronic games (e.g., a slot machine) where a person may gamble on an outcome.

Paylines of an electronic gaming device (e.g., a slot machine) are utilized to determine when predetermined winning symbol combinations are aligned in a predetermined pattern to form a winning combination. A winning event occurs when the player successfully matches the predetermined winning symbols in one of the predetermined patterns.

A player's entertainment while playing one or more games may be enhanced by utilizing one or more treasure spin functionalities on the gaming device. By increasing the player's entertainment level, the player's enjoyment of the game may be enhanced, which may increase a player's game playing period.

### BRIEF DESCRIPTION OF THE FIGURES

Non-limiting and non-exhaustive examples will be described with reference to the following figures, wherein like reference numerals refer to like parts throughout the various figures.

FIG. 1 is an illustration of the electronic gaming device, according to one embodiment.

FIG. 2 is an illustration of an electronic gaming system, according to one embodiment.

FIG. 3 is a block diagram of the electronic gaming device, according to one embodiment.

FIG. 4 is another block diagram of the electronic gaming device, according to one embodiment.

FIG. 5A is an illustration of treasure spin game play on a gaming device, according to one embodiment.

FIG. 5B is another illustration of treasure spin game play on a gaming device, according to one embodiment.

FIG. 5C is another illustration of treasure spin game play on a gaming device, according to one embodiment.

FIG. 5D is another illustration of treasure spin game play on a gaming device, according to one embodiment.

FIG. 5E is another illustration of treasure spin game play on a gaming device, according to one embodiment.

FIG. 5F is another illustration of treasure spin game play on a gaming device, according to one embodiment.

FIG. 5G is another illustration of treasure spin game play on a gaming device, according to one embodiment.

FIG. 5H is another illustration of treasure spin game play on a gaming device, according to one embodiment.

FIG. 5J is another illustration of treasure spin game play on a gaming device, according to one embodiment.

FIG. 5K is another illustration of treasure spin game play on a gaming device, according to one embodiment.

FIG. 5L is another illustration of treasure spin game play on a gaming device, according to one embodiment.

FIG. 5M is another illustration of treasure spin game play on a gaming device, according to one embodiment.

FIG. 5N is another illustration of treasure spin game play on a gaming device, according to one embodiment.

FIG. 5P is another illustration of treasure spin game play on a gaming device, according to one embodiment.

FIG. 5R is another illustration of treasure spin game play on a gaming device, according to one embodiment.

FIG. 6A is another illustration of treasure spin game play on a gaming device, according to one embodiment.

FIG. 6B is another illustration of treasure spin game play on a gaming device, according to one embodiment.

FIG. 6C is another illustration of treasure spin game play on a gaming device, according to one embodiment.

FIG. 6D is another illustration of treasure spin game play on a gaming device, according to one embodiment.

FIG. 6E is another illustration of treasure spin game play on a gaming device, according to one embodiment.

FIG. 6F is another illustration of treasure spin game play on a gaming device, according to one embodiment.

FIG. 6G is another illustration of treasure spin game play on a gaming device, according to one embodiment.

FIG. 6H is another illustration of treasure spin game play on a gaming device, according to one embodiment.

FIG. 7A is another illustration of treasure spin game play on a gaming device, according to one embodiment.

FIG. 7B is another illustration of treasure spin game play on a gaming device, according to one embodiment.

FIG. 7C is another illustration of treasure spin game play on a gaming device, according to one embodiment.

FIG. 7D is another illustration of treasure spin game play on a gaming device, according to one embodiment.

FIG. 7E is another illustration of treasure spin game play on a gaming device, according to one embodiment.

FIG. 7F is another illustration of treasure spin game play on a gaming device, according to one embodiment.

FIG. 7G is another illustration of treasure spin game play on a gaming device, according to one embodiment.

FIG. 7H is another illustration of treasure spin game play on a gaming device, according to one embodiment.

FIG. 7J is another illustration of treasure spin game play on a gaming device, according to one embodiment.

FIG. 7K is another illustration of treasure spin game play on a gaming device, according to one embodiment.

FIG. 7L is another illustration of treasure spin game play on a gaming device, according to one embodiment.

FIG. 7M is another illustration of treasure spin game play on a gaming device, according to one embodiment.

FIG. 7N is another illustration of treasure spin game play on a gaming device, according to one embodiment.

FIG. 8A is another illustration of treasure spin game play on a gaming device, according to one embodiment.

FIG. 8B is another illustration of treasure spin game play on a gaming device, according to one embodiment.

FIG. 8C is another illustration of treasure spin game play on a gaming device, according to one embodiment.

FIG. 8D is another illustration of treasure spin game play on a gaming device, according to one embodiment.

FIG. 8E is another illustration of treasure spin game play on a gaming device, according to one embodiment.

FIG. 8F is another illustration of treasure spin game play on a gaming device, according to one embodiment.

FIG. 8G is another illustration of treasure spin game play on a gaming device, according to one embodiment.

FIG. 8H is another illustration of treasure spin game play on a gaming device, according to one embodiment.

FIG. 8J is another illustration of treasure spin game play on a gaming device, according to one embodiment.

FIG. 8K is another illustration of treasure spin game play on a gaming device, according to one embodiment.

FIG. 8L is another illustration of treasure spin game play on a gaming device, according to one embodiment.

FIG. 8M is another illustration of treasure spin game play on a gaming device, according to one embodiment.

FIG. 8N is another illustration of treasure spin game play on a gaming device, according to one embodiment.

FIG. 8P is another illustration of treasure spin game play on a gaming device, according to one embodiment.

FIG. 8R is another illustration of treasure spin game play on a gaming device, according to one embodiment.

FIG. 8S is another illustration of treasure spin game play on a gaming device, according to one embodiment.

FIG. 8T is another illustration of treasure spin game play on a gaming device, according to one embodiment.

FIG. 8U is another illustration of treasure spin game play on a gaming device, according to one embodiment.

FIG. 8V is another illustration of treasure spin game play on a gaming device, according to one embodiment.

FIG. 8W is another illustration of treasure spin game play on a gaming device, according to one embodiment.

FIG. 8X is another illustration of treasure spin game play on a gaming device, according to one embodiment.

FIG. 9 is a game play flow diagram, according to one embodiment.

FIG. 10 is a flow diagram for game play, according to one embodiment.

FIG. 11 is a flow diagram for game play, according to one embodiment.

FIG. 12 is a flow diagram for game play, according to one embodiment.

FIG. 13 is a flow diagram for game play, according to one embodiment.

FIG. 14 is a flow diagram for game play, according to one embodiment.

FIG. 15 is a flow diagram for game play, according to one embodiment.

FIG. 16 is a flow diagram for game play, according to one embodiment.

### DETAILED DESCRIPTION

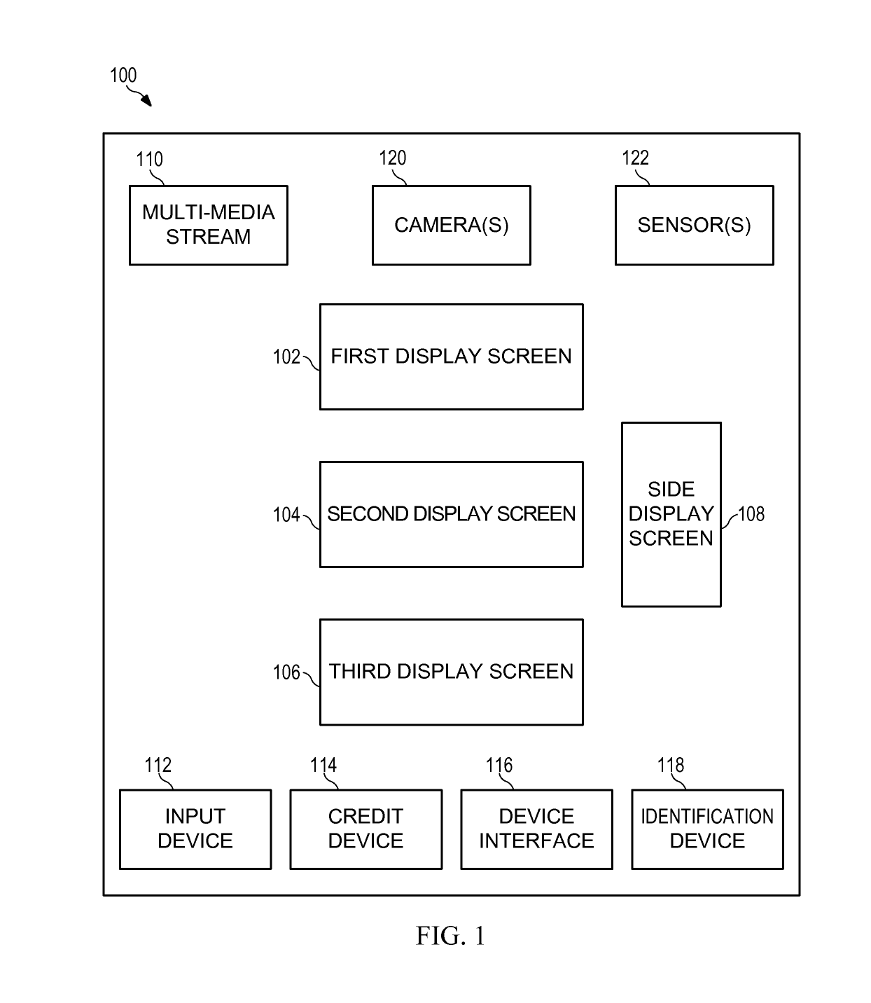

FIG. 1 is an illustration of an electronic gaming device 100. Electronic gaming device 100 may include a multi-media stream 110, a first display screen 102, a second display screen 104, a third display screen 106, a side display screen 108, an input device 112, a credit device 114, a device interface 116, and an identification device 118. Electronic gaming device 100 may display one, two, a few, or a plurality of multi-media streams 110, which may be obtained from one or more gaming tables, one or more electronic gaming devices, a central server, a video server, a music server, an advertising server, another data source, and/or any combination thereof.

Multi-media streams may be obtained for an entertainment event, a wagering event, a promotional event, a promotional offering, an advertisement, a sporting event, any other event, and/or any combination thereof. For example, the entertainment event may be a concert, a show, a television program, a movie, an Internet event, and/or any combination thereof. In another example, the wagering event may be a poker tournament, a horse race, a car race, and/or any combination thereof. The advertisement may be an advertisement for a casino, a restaurant, a shop, any other entity, and/or any combination thereof. The sporting event may be a football game, a baseball game, a hockey game, a basketball game, any other sporting event, and/or any combination thereof. These multi-media streams may be utilized in combination with the gaming table video streams.

Input device 112 may be mechanical buttons, electronic buttons, mechanical switches, electronic switches, optical switches, a slot pull handle, a keyboard, a keypad, a touch screen, a gesture screen, a joystick, a pointing device (e.g., a mouse), a virtual (on-screen) keyboard, a virtual (on-screen) keypad, biometric sensor, or any combination thereof. Input device 112 may be utilized to select one or more treasure spin gaming options, to make a wager, to control any object, to select one or more pattern gaming options, to obtain data relating to historical payouts, to select a row and/or column to move, to select a row area to move, to select a column area to move, to select a symbol (or image) to move, to modify electronic gaming device 100 (e.g., change sound level, configuration, font, language, etc.), to select a movie or song, to select live multi-media streams, to request services (e.g., drinks, slot attendant, manager, etc.), to select two-dimensional (“2D”) game play, to select three-dimensional (“3D”) game play, to select both two-dimensional and three-dimensional game play, to change the orientation of games in a three-dimensional space, to move a symbol (e.g., wild, multiplier, etc.), and/or any combination thereof. These selections may occur via any other input device (e.g., a touch screen, voice commands, etc.). Input device 112 may be any control panel.

Credit device 114 may be utilized to collect monies and distribute monies (e.g., cash, vouchers, etc.). Credit device 114 may interface with a mobile device to electronically transmit money and/or credits. Credit device 114 may interface with a player's card to exchange player points.

Device interface 116 may be utilized to interface electronic gaming device 100 to a bonus game device, a local area progressive controller, a wide area progressive controller, a progressive sign controller, a peripheral display device, signage, a promotional device, network components, a local network, a wide area network, remote access equipment, a slot monitoring system, a slot player tracking system, the Internet, a server, and/or any combination thereof.

Device interface 116 may be utilized to connect a player to electronic gaming device 100 through a mobile device, card, keypad, identification device 118, and/or any combination thereof. Device interface 116 may include a docking station by which a mobile device is plugged into electronic gaming machine 100. Device interface 116 may include an over the air connection by which a mobile device is connected to electronic gaming machine 100 (e.g., Bluetooth, Near Field technology, and/or Wi-Fi technology). Device interface 116 may include a connection to identification device 118.

Identification device 118 may be utilized to determine an identity of a player. Based on information obtained by identification device 118, electronic gaming device 100 may be reconfigured. For example, the language, sound level, music, placement of multi-media streams, one or more game functionalities (e.g., game type 1, game type 2, game type 3, etc.) may be presented, a treasure spin gaming option may be presented, a repeat payline gaming option may be presented, a pattern gaming option may be presented, historical gaming data may be presented, a row rearrangement option may be presented, a column rearrangement option may be presented, a row area rearrangement option may be presented, a column area rearrangement option may be presented, a two-dimensional gaming option may be presented, a three-dimensional gaming option may be presented, and/or the placement of gaming options may be modified based on player preference data. For example, the player may only want to play games that include treasure spin gaming options only. Therefore, only games which include treasure spin gaming options would be presented to the player. In another example, the player may only want to play games that include historical information relating to game play. Therefore, only games which include historical gaming data would be presented to the player. These examples may be combined.

Identification device 118 may utilize biometrics (e.g., thumb print, retinal scan, or other biometric). Identification device 118 may include a card entry slot into input device 112. Identification device 118 may include a keypad with an assigned pin number for verification. Identification device 118 may include multiple layers of identification for added security. For example, a player could be required to enter a player tracking card, and/or a pin number, and/or a thumb print, and/or any combination thereof. Based on information obtained by identification device 118, electronic gaming device 100 may be reconfigured. For example, the language, sound level, music, placement of video streams, placement of images, and the placement of gaming options utilized may be modified based on a player's preference data. For example, a player may have selected baseball under the sporting event preferences; electronic gaming device 100 will then automatically display the current baseball game onto side display screen 108 and/or an alternate display screen as set in the player's options.

First display screen 102 may be a liquid crystal display (“LCD”), a cathode ray tube display (“CRT”), organic light-emitting diode display (“OLED”), plasma display panel (“PDP”), electroluminescent display (“ELD”), a light-emitting diode display (“LED”), or any other display technology. First display screen 102 may be used for displaying primary games or secondary (bonus) games, to display one or more warnings relating to one or more audio devices, one or more display devices, one or more electrical wires, one or more springs, one or more motors, one or more adjustable devices, and/or one or more sensors, advertising, player attractions, electronic gaming device 100 configuration parameters and settings, game history, accounting meters, events, alarms, and/or any combination thereof. Second display screen 104, third display screen 106, side display screen 108, and any other screens may utilize the same technology as first display screen 102 and/or any combination of technologies.

First display screen 102 may also be virtually combined with second display screen 104. Likewise second display screen 104 may also be virtually combined with third display screen 106. First display screen 102 may be virtually combined with both second display screen 104 and third display screen 106. Any combination thereof may be formed.

For example, a single large image could be partially displayed on second display screen 104 and partially displayed on third display screen 106, so that when both display screens are put together they complete one image. Electronic gaming device 100 may stream or play prerecorded multi-media data, which may be displayed on any display combination.

One or more cameras 120 and/or one or more sensors 122 may be utilized as one or more depth image sensing devices, which may be located in various locations, including but not limited to, above the base display, above second display, in one or more locations on gaming cabinet front, on a side of the gaming cabinet other than gaming cabinet front, and/or any other location.

In one embodiment, electronic gaming device 100 may not include separate one or more input devices, but instead may only utilize one or more depth image sensing devices. In another embodiment, a player may utilize one or more input devices and/or may utilize gestures that electronic gaming device 100, via one or more depth image sensing devices, recognizes in order to make inputs for a play of a game. A player may interact with electronic gaming device 100 via one or more depth image sensing devices for a plurality of various player inputs.

In one embodiment, one or more depth image sensing devices may include at least two similar devices. For example, each of the at least two similar devices may independently sense depth and/or image of a scene. In another example, such similar depth image sensing devices may then communicate information to one or more processors, which may utilize the information from each of the similar depth image sensing devices to determine the relative depth of an image from a captured scene.

In another embodiment, one or more depth image sensing devices may include at least two different devices. For example, and discussed in more detail below, one of the at least two different devices may be an active device and/or one of the at least two different devices may be a passive device. In one example, such an active device may generate a wave of measurable energy (e.g., light, radio, etc.). In another example, such a passive device may be able to detect reflected waves generated by such an active device. In another example, such an active device and such a passive device may each communicate data related to their respective activity to a processor, and such processor may translate such data in order to determine the depth and/or image of a scene occurring near electronic gaming device 100.

Electronic gaming device 100 may include at least one display device. Electronic gaming device 100 may include a base display and/or a second display. In one embodiment, base display may be the primary display for a first game. In another embodiment, second display may be the primary display for a second and/or bonus game. For example, base display may display: a reel-type video slot game; and upon a bonus game triggering condition; second display may display a bonus game; and upon a treasure spin game feature triggering event; first and/or second display may display a treasure spin game feature.

In one embodiment, base display and second display may display separate portions of a common image. For example, second display may display a top portion of a wheel spinning while base display may display the bottom portion of the same wheel spinning.

Electronic gaming device 100 may also include one or more speakers. In one embodiment, one or more speakers may work in a synchronized manner to provide a surround sound effect. For example, as an object is displayed moving across base display from left to right, one or more speakers may produce sound in such a manner as to create an audible sense of similar left to right movement. In another embodiment, one or more speakers may work asynchronously. In a further embodiment, a first speaker may produce sounds associated with a first symbol appearing in a play of a game, and a second speaker may produce sounds associated with a second symbol appearing in a play of the game.

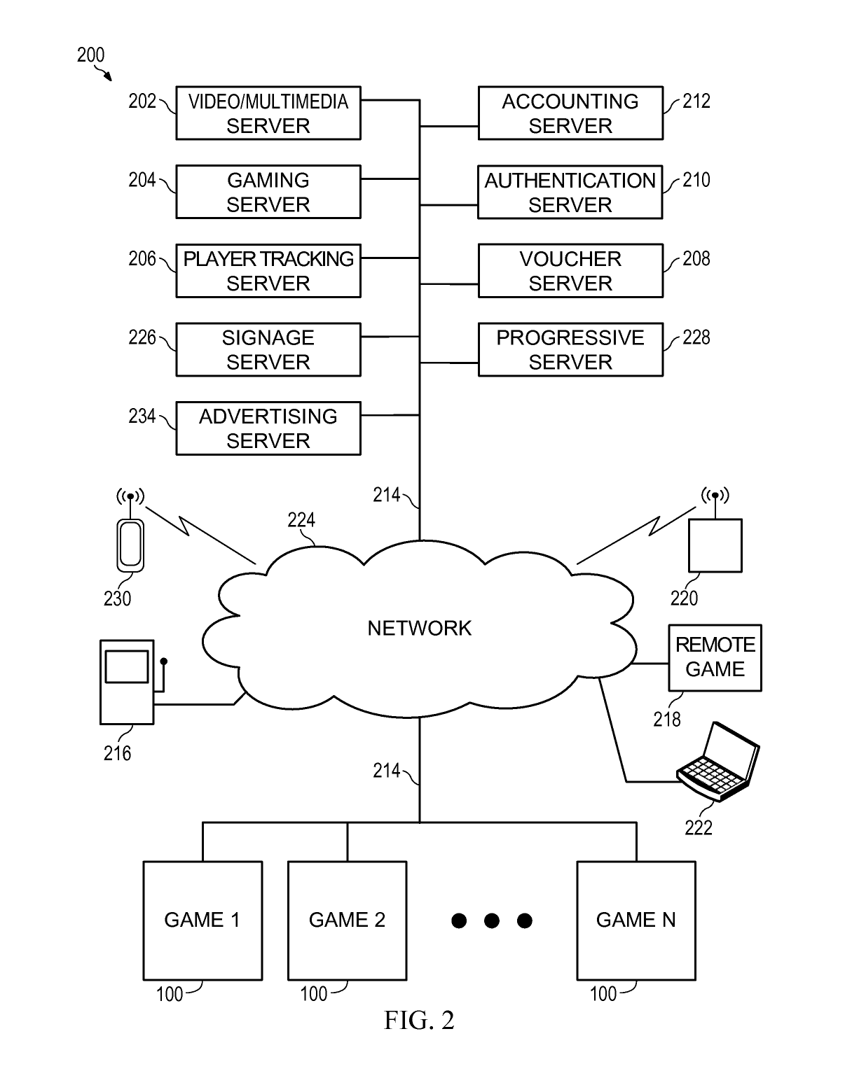

In FIG. 2, an electronic gaming system 200 is shown. Electronic gaming system 200 may include a video/multimedia server 202, a gaming server 204, a player tracking server 206, a voucher server 208, an authentication server 210, and an accounting server 212.

Electronic gaming system 200 may include video/multimedia server 202, which may be coupled to network 224 via a network link 214. Network 224 may be the Internet, a private network, and/or a network cloud. One or more video streams may be received at video/multimedia server 202 from other electronic gaming devices 100. Video/multimedia server 202 may transmit one or more of these video streams to a mobile phone 230, electronic gaming device 100, a remote electronic gaming device at a different location in the same property 216, a remote electronic gaming device at a different location 218, a laptop 222, and/or any other remote electronic device 220. Video/multimedia server 202 may transmit these video streams via network link 214 and/or network 224.

For example, a remote gaming device at the same location may be utilized at a casino with multiple casino floors, a casino that allows wagering activities to take place from the hotel room, a casino that may allow wagering activities to take place from the pool area, etc. In another example, the remote devices may be at another location via a progressive link to another casino, and/or a link within a casino corporation that owns numerous casinos (e.g., MGM, Caesars, etc.).

Gaming server 204 may generate gaming outcomes. Gaming server 204 may provide electronic gaming device 100 with game play content. Gaming server 204 may provide electronic gaming device 100 with game play math and/or outcomes. Gaming server 204 may provide one or more of: a treasure spin game feature functionality; a treasure spin game feature evaluation functionality; a payout functionality; a base and/or bonus game play functionality; a base and/or bonus game play evaluation functionality, other game functionality, and/or any other virtual game functionality.

Player tracking server 206 may track a player's betting activity, a player's preferences (e.g., language, font, sound level, drinks, etc.). Based on data obtained by player tracking server 206, a player may be eligible for gaming rewards (e.g., free play), promotions, and/or other awards (e.g., complimentary food, drinks, lodging, concerts, etc.).

Voucher server 208 may generate a voucher, which may include data relating to gaming. Further, the voucher may include payline structure option selections. In addition, the voucher may include game play data (or similar game play data), repeat payline data, pattern data, historical payout data, column data, row data, and/or symbols that were modified.

Authentication server 210 may determine the validity of vouchers, player's identity, and/or an outcome for a gaming event.

Accounting server 212 may compile, track, and/or monitor cash flows, voucher transactions, winning vouchers, losing vouchers, and/or other transaction data. Transaction data may include the number of wagers, the size of these wagers, the date and time for these wagers, the identity of the players making these wagers, and/or the frequency of the wagers. Accounting server 212 may generate tax information relating to these wagers. Accounting server 212 may generate profit/loss reports for players' tracked outcomes.

Network connection 214 may be used for communication between dedicated servers, thin clients, thick clients, back-office accounting systems, etc.

Laptop computer 222 and/or any other electronic devices (e.g., mobile phone 230, electronic gaming device 100, etc.) may be used for downloading new gaming device applications or gaming device related firmware through remote access.

Laptop computer 222 and/or any other electronic device (e.g., mobile phone 230, electronic gaming device 100, etc.) may be used for uploading accounting information (e.g., cashable credits, non-cashable credits, coin in, coin out, bill in, voucher in, voucher out, etc.).

Network 224 may be a local area network, a casino premises network, a wide area network, a virtual private network, an enterprise private network, the Internet, or any combination thereof. Hardware components, such as network interface cards, repeaters and hubs, bridges, switches, routers, firewalls, or any combination thereof may also be part of network 224.

A statistics server may be used to maintain data relating to historical game play for one or more electronic gaming devices 100. This historical data may include winning amounts, winning data (e.g., person, sex, age, time on machine, amount of spins before winning event occurred, etc.), fastest winning event reoccurrence, longest winning event reoccurrence, average frequencies of winning events, average winning amounts, highest winning amount, lowest winning amount, locations for winning events, winning event dates, winning machines, winning game themes, and/or any other data relating to game play.

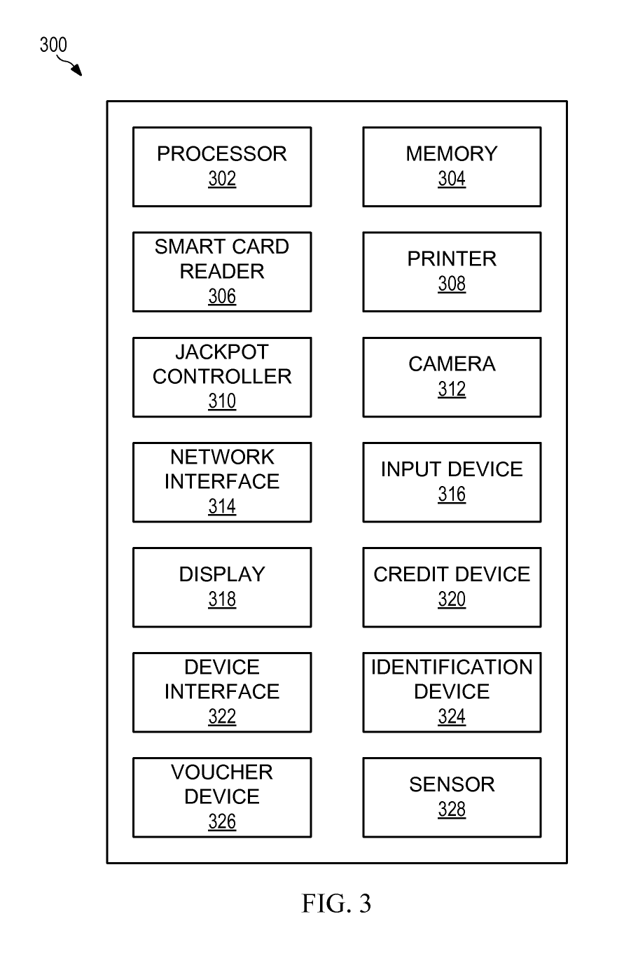

FIG. 3 shows a block diagram 300 of electronic gaming device 100. Electronic gaming device 100 may include a processor 302, a memory 304, a smart card reader 306, a printer 308, a jackpot controller 310, a camera 312, a network interface 314, an input device 316, a display 318, a credit device 320, a device interface 322, an identification device 324, and a voucher device 326.

Processor 302 may execute program instructions of memory 304 and use memory 304 for data storage. Processor 302 may also include a numeric co-processor, or a graphics processing unit (or units) for accelerated video encoding and decoding, and/or any combination thereof.

Processor 302 may include communication interfaces for communicating with electronic gaming device 100, electronic gaming system 200, and user interfaces to enable communication with all gaming elements. For example, processor 302 may interface with memory 304 to access a player's mobile device through device interface 322 to display contents onto display 318. Processor 302 may generate a voucher based on a wager confirmation, which may be received by an input device, a server, a mobile device, and/or any combination thereof. A voucher device may generate, print, transmit, or receive a voucher. Memory 304 may include communication interfaces for communicating with electronic gaming device 100, electronic gaming system 200, and user interfaces to enable communication with all gaming elements. For example, the information stored on memory 304 may be printed out onto a voucher by printer 308. Videos or pictures captured by camera 312 may be saved and stored on memory 304. Memory 304 may include a confirmation module, which may authenticate a value of a voucher and/or the validity of the voucher. Processor 302 may determine the value of the voucher based on generated voucher data and data in the confirmation module. Electronic gaming device 100 may include a player preference input device. The player preference input device may modify a game configuration. The modification may be based on data from the identification device.

Memory 304 may be non-volatile semiconductor memory, such as read-only memory (“ROM”), erasable programmable read-only memory (“EPROM”), electrically erasable programmable read-only memory (“EEPROM”), flash memory (“NVRAM”), Nano-RAM (e.g., carbon nanotube random access memory), and/or any combination thereof.

Memory 304 may also be volatile semiconductor memory such as, dynamic random access memory (“DRAM”), static random access memory (“SRAM”), and/or any combination thereof.

Memory 304 may also be a data storage device, such as a hard disk drive, an optical disk drive such as, CD, DVD, Blu-ray, a solid state drive, a memory stick, a CompactFlash card, a USB flash drive, a Multi-media Card, an xD-Picture Card, and/or any combination thereof.

Memory 304 may be used to store read-only program instructions for execution by processor 302, for the read-write storage for global variables and static variables, read-write storage for uninitialized data, read-write storage for dynamically allocated memory, for the read-write storage of the data structure known as “the stack,” and/or any combination thereof.

Memory 304 may be used to store the read-only paytable information for which symbol combinations on a given payline that result in a win (e.g., payout) which are established for games of chance, such as slot games and video poker.

Memory 304 may be used to store accounting information (e.g., cashable electronic promotion in, non-cashable electronic promotion out, coin in, coin out, bill in, voucher in, voucher out, electronic funds transfer in, etc.).

Memory 304 may be used to record error conditions on an electronic gaming device 100, such as door open, coin jam, ticket print failure, ticket (e.g., paper) jam, program error, reel tilt, etc., and/or any combination thereof.

Memory 304 may also be used to record the complete history for the most recent game played, plus some number of prior games as may be determined by the regulating authority.

Smart card reader 306 may allow electronic gaming device 100 to access and read information provided by the player or technician, which may be used for setting the player preferences and/or providing maintenance information. For example, smart card reader 306 may provide an interface between a smart card (inserted by the player) and identification device 324 to verify the identity of a player.

Printer 308 may be used for printing slot machine payout receipts, slot machine wagering vouchers, non-gaming coupons, slot machine coupons (e.g., a wagering instrument with a fixed waging value that can only be used for non-cashable credits), drink tokens, comps, and/or any combination thereof.

Electronic gaming device 100 may include a jackpot controller 310, which may allow electronic gaming device 100 to interface with other electronic gaming devices either directly or through electronic gaming system 200 to accumulate a shared jackpot.

Camera 312 may allow electronic gaming device 100 to take images of a player or a player's surroundings. For example, when a player sits down at the machine his or her picture may be taken to include his or her image into the game play. A picture of a player may be an actual image as taken by camera 312. A picture of a player may be a computerized caricature of the image taken by camera 312. The image obtained by camera 312 may be used in connection with identification device 324 using facial recognition. Camera 312 may allow electronic gaming device 100 to record video. The video may be stored on memory 304 or stored remotely via electronic gaming system 200. Videos obtained by camera 312 may then be used as part of game play, or may be used for security purposes. For example, a camera located on electronic gaming device 100 may capture videos of a potential illegal activity (e.g., tampering with the machine, crime in the vicinity, underage players, etc.).

Network interface 314 may allow electronic gaming device 100 to communicate with video/multimedia server 202, gaming server 204, player tracking server 206, voucher server 208, authentication server 210, and/or accounting server 212.

Input device 316 may be mechanical buttons, electronic buttons, a touch screen, and/or any combination thereof. Input device 316 may be utilized to make a wager, to select one or more game elements, to select one or more gaming options, to make an offer to buy or sell a voucher, to determine a voucher's worth, to cash in a voucher, to modify electronic gaming device 100 (e.g., change sound level, configuration, font, language, etc.), to modify one of one or more audio devices, one or more display devices, one or more electrical wires, one or more springs, one or more motors, one or more adjustable devices, and/or one or more sensors, to select a movie or music, to select live video streams (e.g., sporting event 1, sporting event 2, sporting event 3), to request services (e.g., drinks, manager, etc.), and/or any combination thereof.

Display 318 may show video streams from one or more content sources. Display 318 may encompass first display screen 102, second display screen 104, third display screen 106, side display screen 108, and/or another screen used for displaying video content.

Credit device 320 may be utilized to collect monies and distribute monies (e.g., cash, vouchers, etc.). Credit device 320 may interface with processor 302 to allow game play to take place. Processor 302 may determine any payouts, display configurations, animation, and/or any other functions associated with game play. Credit device 320 may interface with display 318 to display the amount of available credits for the player to use for wagering purposes. Credit device 320 may interface via device interface 322 with a mobile device to electronically transmit money and/or credits. Credit device 320 may interface with a player's pre-established account, which may be stored on electronic gaming system 200, to electronically transmit money and/or credit. For example, a player may have a credit card or other mag-stripe card on file with the location for which money and/or credits can be directly applied when the player is done. Credit device 320 may interface with a player's card to exchange player points.

Electronic gaming device 100 may include a device interface 322 that a user may employ with his or her mobile device (e.g., smart phone) to receive information from and/or transmit information to electronic gaming device 100 (e.g., watch a movie, listen to music, obtain verbal betting options, verify identification, transmit credits, etc.).

Identification device 324 may be utilized to allow electronic gaming device 100 to determine an identity of a player. Based on information obtained by identification device 324, electronic gaming device 100 may be reconfigured. For example, the language, sound level, music, placement of video streams, placement of images, placement of gaming options, and/or the tables utilized may be modified based on player preference data.

For example, a player may have selected a specific baseball team (e.g., Atlanta Braves) under the sporting event preferences, the electronic gaming device 100 will then automatically (or via player input) display the current baseball game (e.g., Atlanta Braves vs. Philadelphia Phillies) onto side display screen 108 and/or an alternate display screen as set in the player's options.

A voucher device 326 may generate, print, transmit, or receive a voucher. The voucher may represent a wagering option, a wagering structure, a wagering timeline, a value of wager, a payout potential, a payout, and/or any other wagering data. A voucher may represent an award, which may be used at other locations inside of the gaming establishment. For example, the voucher may be a coupon for the local buffet or a concert ticket.

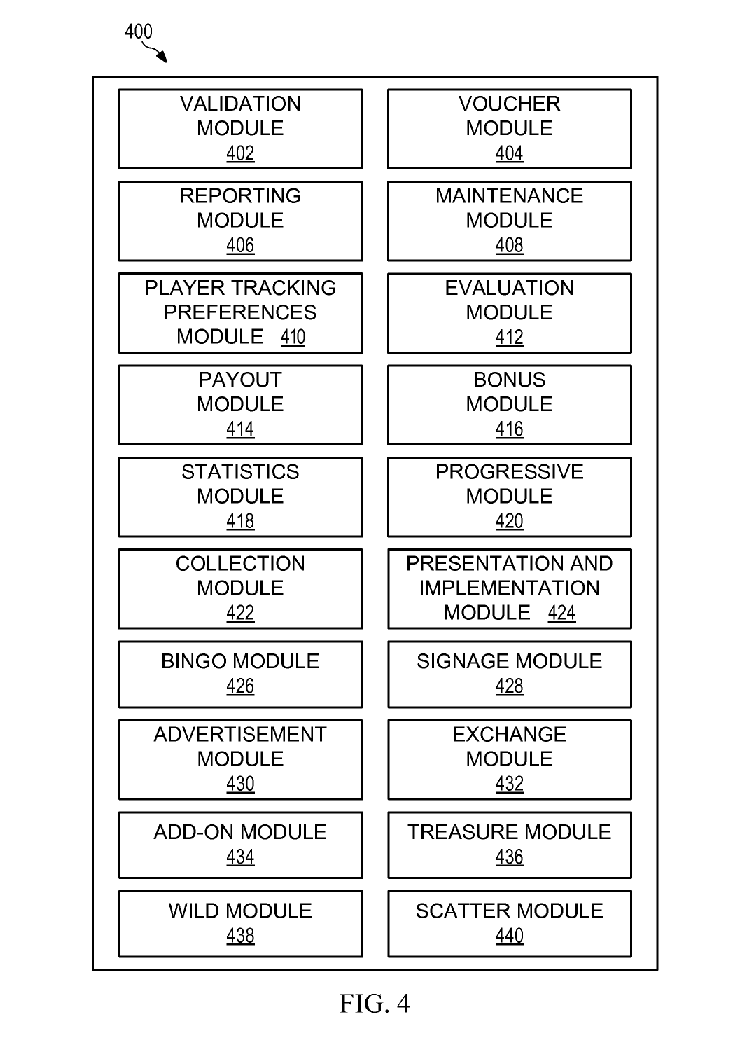

FIG. 4 shows a block diagram of memory 304, which includes various modules. Memory 304 may include a validation module 402, a voucher module 404, a reporting module 406, a maintenance module 408, a player tracking preferences module 410, an animation module, a game evaluation module 412, a payout module 414, a sensor module, a scene module, a sensor and scene evaluation module, a sensor and scene output module, a reference models module, an audio module, an audio device adjustment module, a display device adjustment module, a bonus module 416, a statistics module 418, a progressive module 420, a collection module 422, a presentation and implementation module 424, a bingo module 426, a signage module 428, an advertisement module 430, an exchange module 432, an add-on module 434, a treasure module 436, a wild module 438, and a scatter module 440.

Validation module 402 may utilize data received from voucher device 326 to confirm the validity of the voucher.

Voucher module 404 may store data relating to generated vouchers, redeemed vouchers, bought vouchers, and/or sold vouchers.

Reporting module 406 may generate reports related to a performance of electronic gaming device 100, electronic gaming system 200, video streams, gaming objects, credit device 114, and/or identification device 118.

Maintenance module 408 may track any maintenance that is implemented on electronic gaming device 100 and/or electronic gaming system 200. Maintenance module 408 may schedule preventative maintenance and/or request a service call based on a device error.

Player tracking preferences module 410 may compile and track data associated with a player's preferences.

Animation module may generate, compile, transmit, and/or store one or more animations and/or presentations based on one or more scene data, one or more scenes, one or more reference models, one or more game play data, one or more player profiles, and/or any combination thereof.

Game evaluation module 412 may evaluate one or more outcomes for one or more events relating to game play.

Payout module 414 may determine one or more payouts which may relate to one or more inputs received from the player, electronic gaming device 100, and/or electronic gaming system 200.

Sensor module may generate, compile, transmit, and/or store any data relating to one or more scene data, one or more scene, and/or any other sensor data. This data may include one or more gestures (e.g., body movement made by one or more players).

Scene module may generate, compile, transmit, and/or store on one or more scene data, one or more scenes, one or more reference models, one or more game play data, one or more player profiles, and/or any combination thereof.

Sensor and scene evaluation module may evaluate any data stored on, transmitted to, and/or transmitted from sensor module and scene module. Sensor and scene evaluation module may obtain data including one or more gestures (e.g., body movement made by one or more players) from sensor module and compare this data to one or more body reference models, body part reference models, device reference models, gaming device reference models, floor plan reference models, and/or any other reference models from reference models module to determine one or more actions.

Sensor and scene output module may evaluate the combined output of sensor module and scene module.

Reference models module may generate, compile, transmit, and/or store one or more body reference models, body part reference models, device reference models, gaming device reference models, floor plan reference models, and/or any other reference models which can be utilized by any of the other modules.

Audio module may generate, compile, transmit, and/or store one or more audio structures, sound wave configurations, and/or any other audio data.

Audio device adjustment module may adjust one or more audio devices. These devices may be adjusted physically (e.g., moved) and/or by changing one or more device characteristics.

Display device adjustment module may adjust one or more display devices. These devices may be adjusted physically (e.g., moved) and/or by changing one or more device characteristics.

Bonus module 416 may generate a bonus game, evaluate the results of the bonus game, trigger bonus game presentations, generate bonus game payouts, and/or display any data relating to the bonus game.

Statistics module 418 may be used to maintain data relating to historical game play for one or more electronic gaming devices 100. This historical data may include winning amounts, winning data (e.g., person, sex, age, time on machine, amount of spins before winning event occurred, etc.), fastest winning event reoccurrence, longest winning event reoccurrence, average frequencies of winning events, average winning amounts, highest winning amount, lowest winning amount, locations for winning events, winning event dates, winning machines, winning game themes, and/or any other data relating to game play.

Progressive module 420 may generate, transmit, compile, and/or store one or more data points relating to one or more progressives and/or subscription progressives (e.g., a progressive a player selects and pays to enter).

Collection module 422 may generate, transmit, compile, and/or store one or more data points relating to the collection of one or more collectable symbols (e.g., wild, scatter, symbol 1, symbol 2, treasure symbols, transformed symbol, etc.).

Presentation and implementation module 424 may generate, transmit, compile, implement, and/or store one or more presentations.

Bingo module 426 may generate, transmit, compile, and/or store one or more data points relating to one or more bingo games.

Signage module 428 may generate, transmit, compile, initiate, and/or store one or more presentations for one or more signs.

Advertisement module 430 may generate, transmit, compile, present, implement, initiate, and/or store one or more advertisements.

Exchange module 432 may generate, transmit, compile, implement, initiate, and/or store one or more data points and/or one or more presentations relating to one or more trade-in transactions.

Add-on module 434 may generate, transmit, compile, implement, initiate, and/or store one or more data points relating to one or more add-on options and/or one or more add-on transactions and/or one or more add-on presentations.

Treasure module 436 may generate a treasure spin game, evaluate the results of the treasure spin game, trigger treasure spin game presentations, generate treasure spin game payouts, and/or display any data relating to the treasure spin game. Further, treasure spin module 436 may determine one or more outcomes of one or more interactions (e.g., collisions of one or more symbols).

Wild module 438 may generate a wild game, evaluate the results of the wild game, trigger wild game presentations, generate wild game payouts, and/or display any data relating to the wild game. Further, wild module 438 may determine one or more outcomes of one or more interactions (e.g., collisions of one or more symbols).

Scatter module 440 may generate a scatter game, evaluate the results of the scatter game, trigger scatter game presentations, generate scatter game payouts, and/or display any data relating to the scatter game.

Super treasure spin module may generate a super treasure spin game, evaluate the results of the super treasure spin game, trigger super treasure spin game presentations, generate super treasure spin game payouts, and/or display any data relating to the super treasure spin game. Further, super treasure spin module may determine one or more outcomes of one or more interactions (e.g., collisions of one or more symbols). Super treasure spin may be where one or more symbols are moved from one or more collection areas and moved around the active reels for multiple spins. For example, a wild is dropped from the collection area to a first symbol area for a first spin and then the same wild is moved to a second symbol area for a second spin and then the same wild is moved to a third symbol area for an Nth spin.

Treasure spin evaluation module, treasure module 436, and/or game evaluation module 412 may evaluate one or more outcomes for one or more events relating to treasure spin game play. Further, treasure spin evaluation module may determine one or more outcomes of one or more interactions (e.g., collisions of one or more symbols).

Collection area module may work with treasure spin counter module to transfer one or more collected symbols to one or more collection locations and/or one or more active areas (e.g., symbol areas on one or more reels).

Installation verification module may verify the installation parameters on one or more of audio devices, one or more display devices, one or more electrical wires, one or more springs, one or more motors, one or more adjustable devices, and/or one or more sensors to one or more reference data points. Installation verification module may generate a warning when the data points are outside of a specific parameter range. One or more warnings may be transmitted to an external device, a server, a mobile device, and/or a warning display on electronic gaming device 100 based on the verification data.

Locking module may control the locking mechanism for one or more audio devices, one or more display devices, one or more electrical wires, one or more springs, one or more motors, one or more adjustable devices, and/or one or more sensors. Locking module may control any locking mechanism for electronic gaming device 100. Locking module may generate a warning when a locking data point is outside of a specific parameter. These warnings may be transmitted to an external device, a server, a mobile device, and/or a warning display on electronic gaming device 100.

It should be noted that one or more modules may be combined into one module. Further, there may be one evaluation module where the determined payout does not depend on whether there were any wild symbols, scatter symbols, treasure based game play, and/or any other specific symbols. Further, any module, device, and/or logic function in electronic gaming device 100 may be present in electronic gaming system 200. In addition, any module, device, and/or logic function in electronic gaming system 200 may be present in electronic gaming device 100.

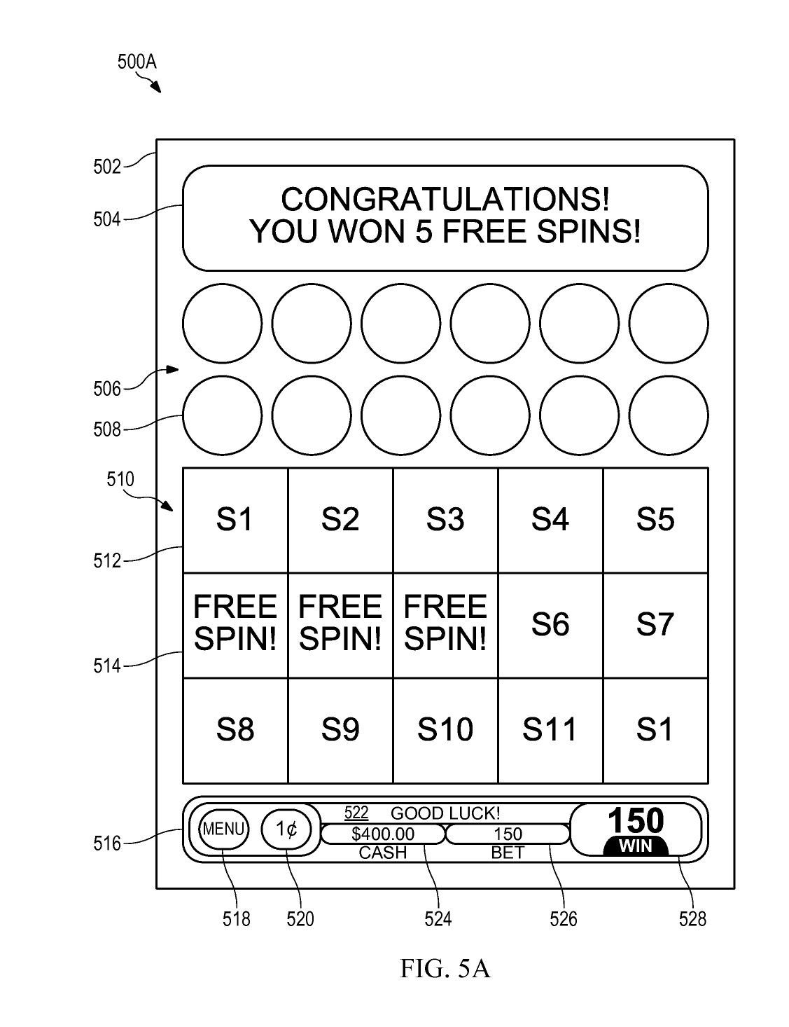

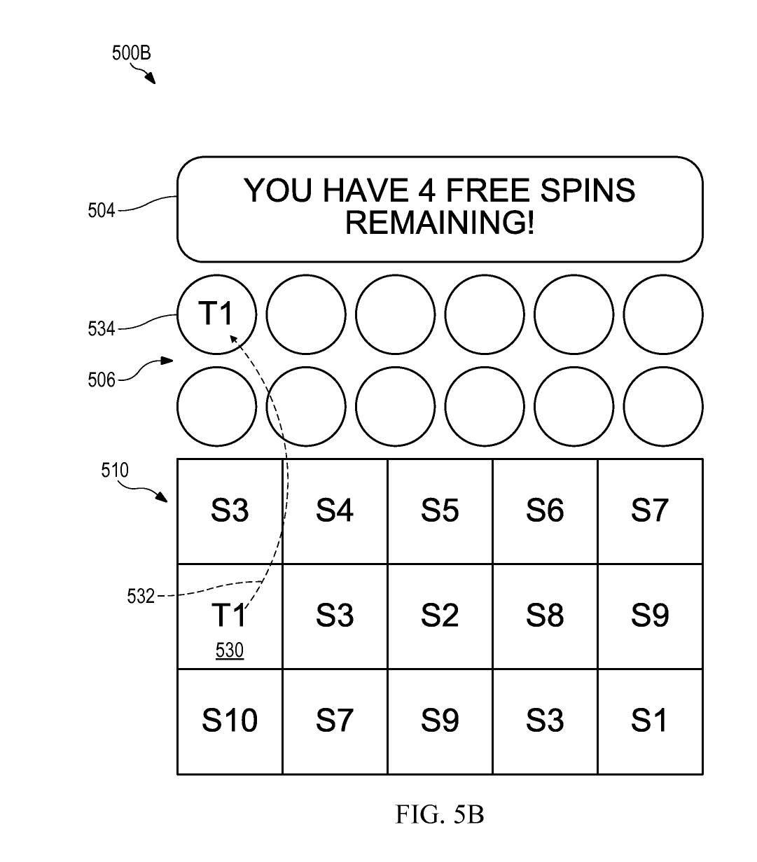

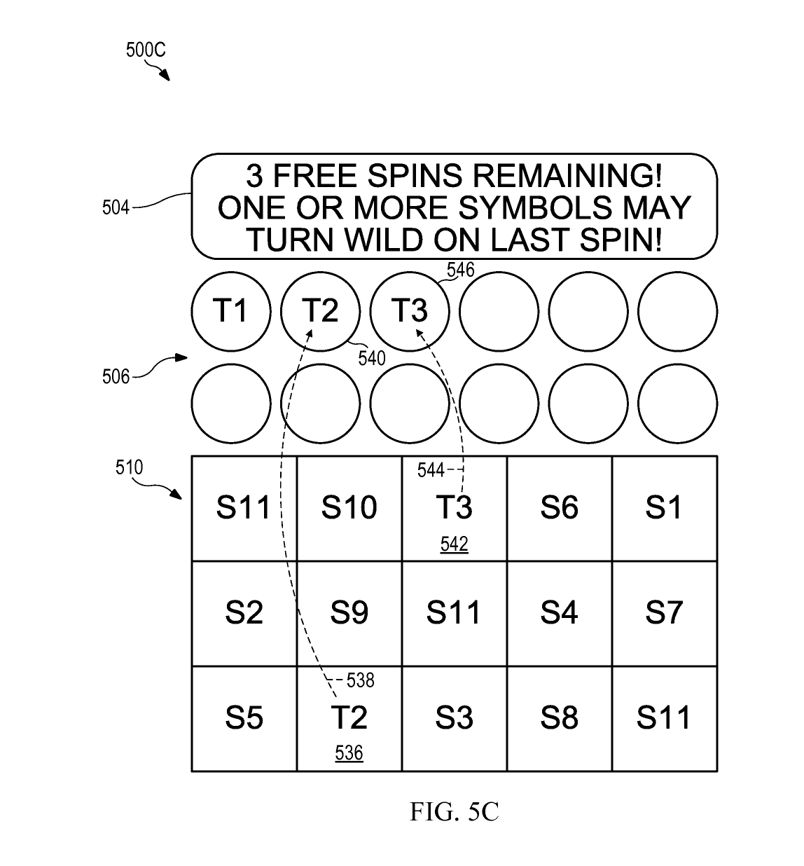

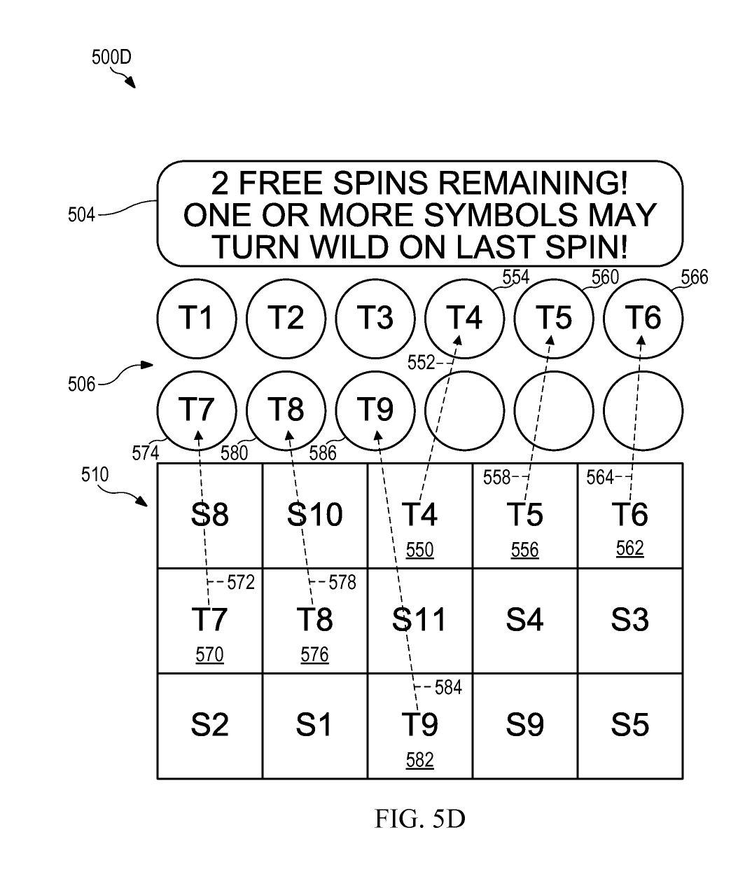

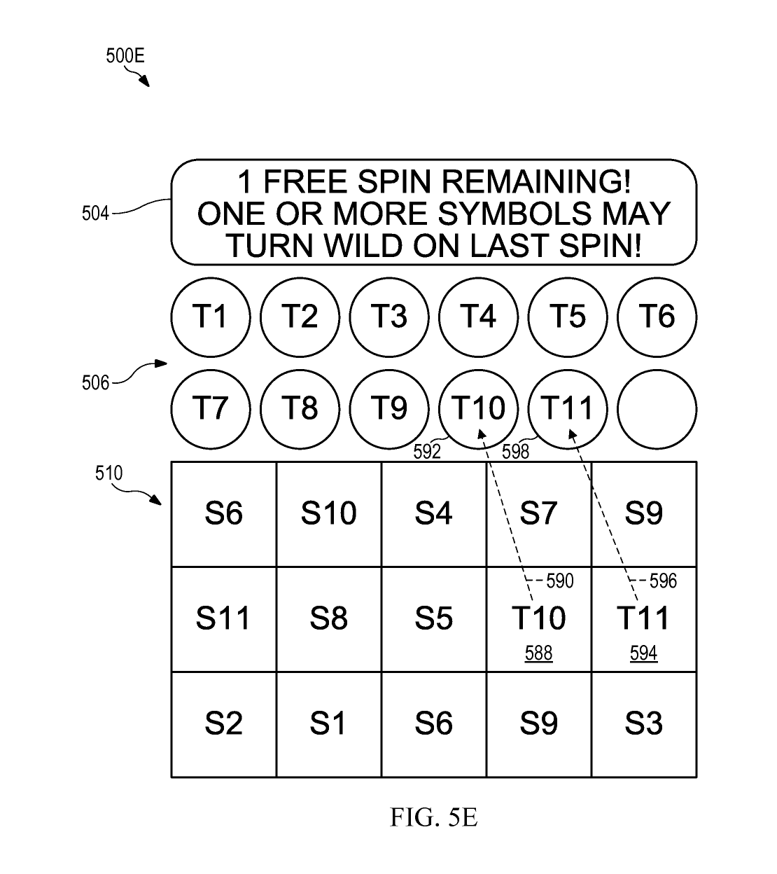

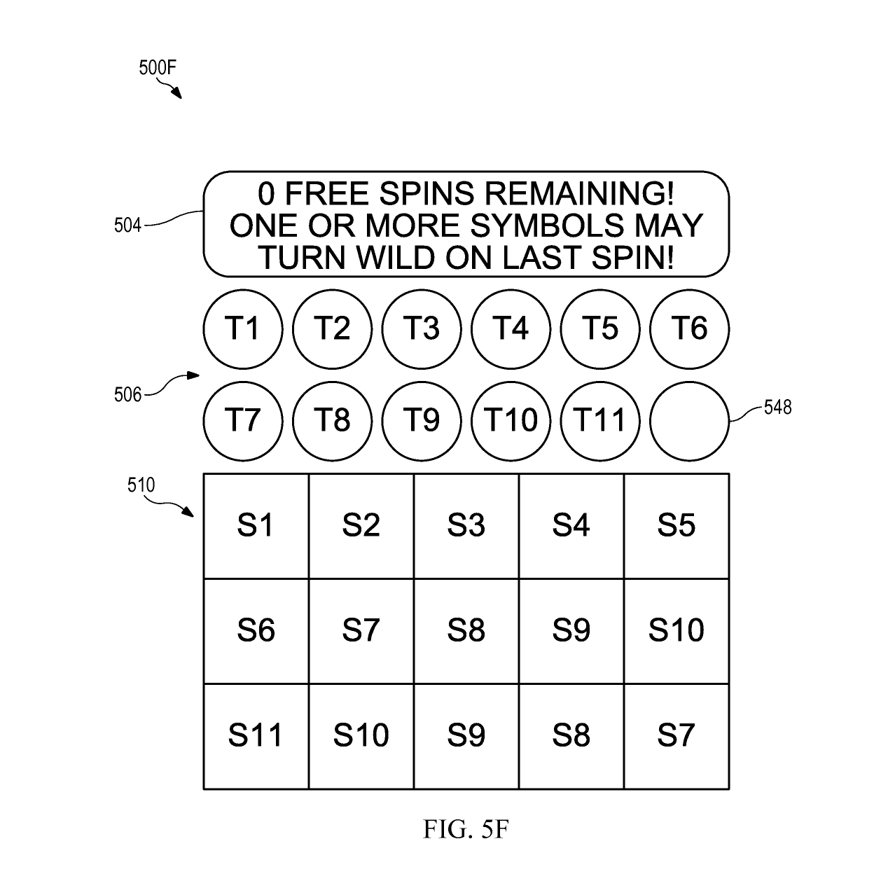

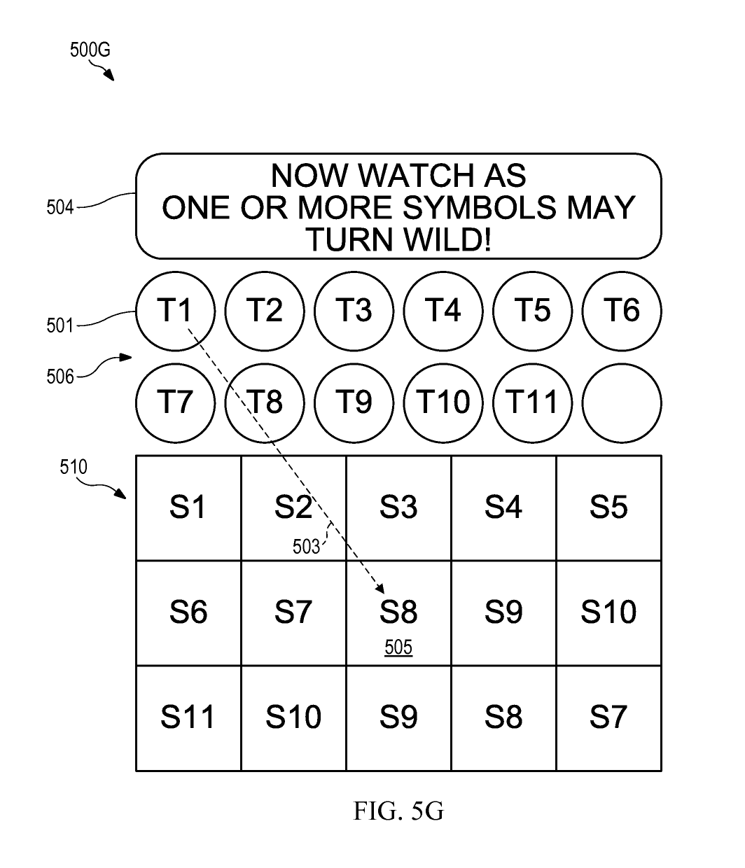

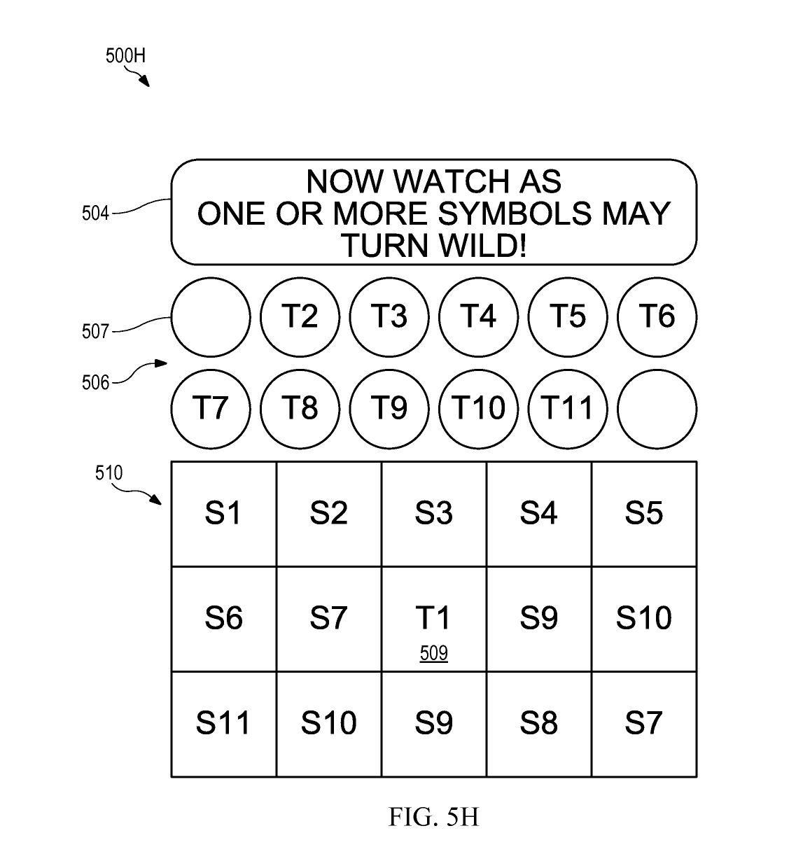

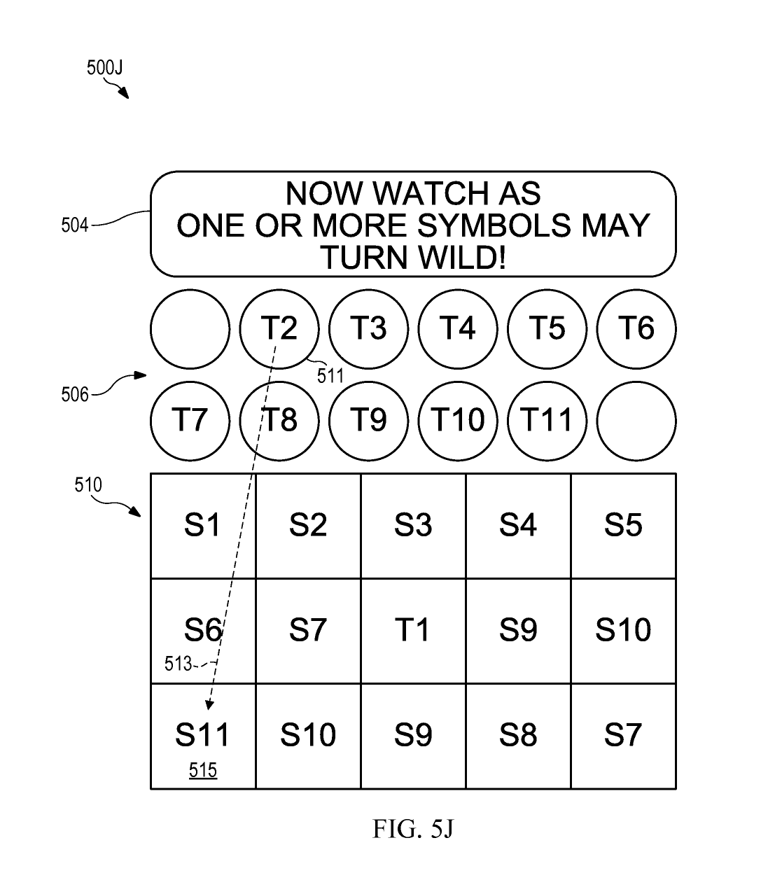

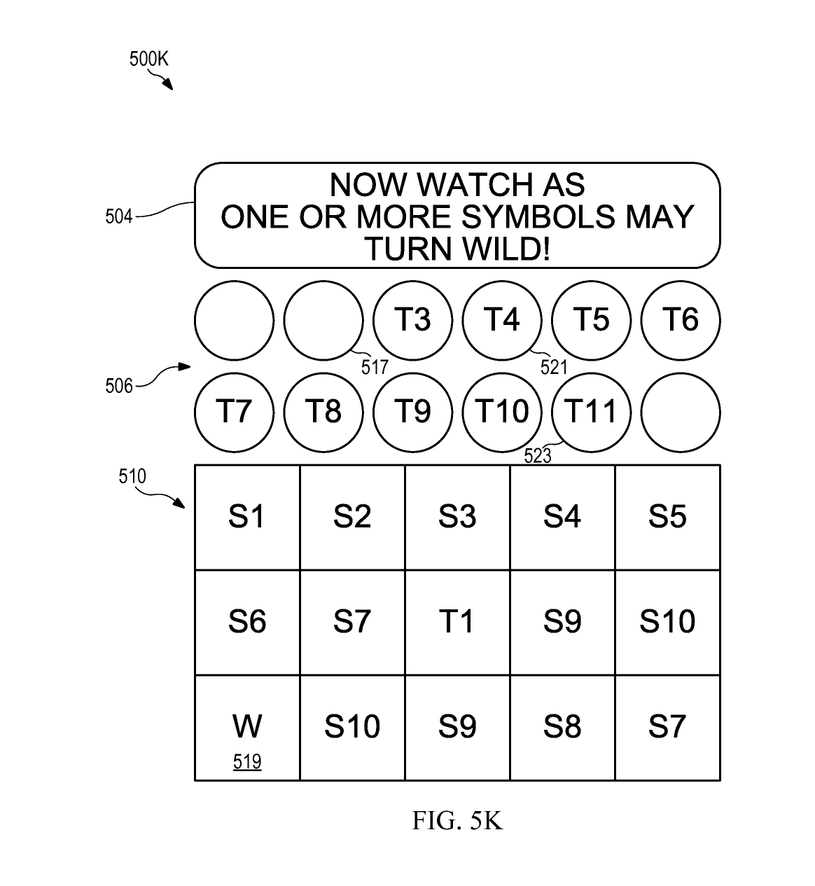

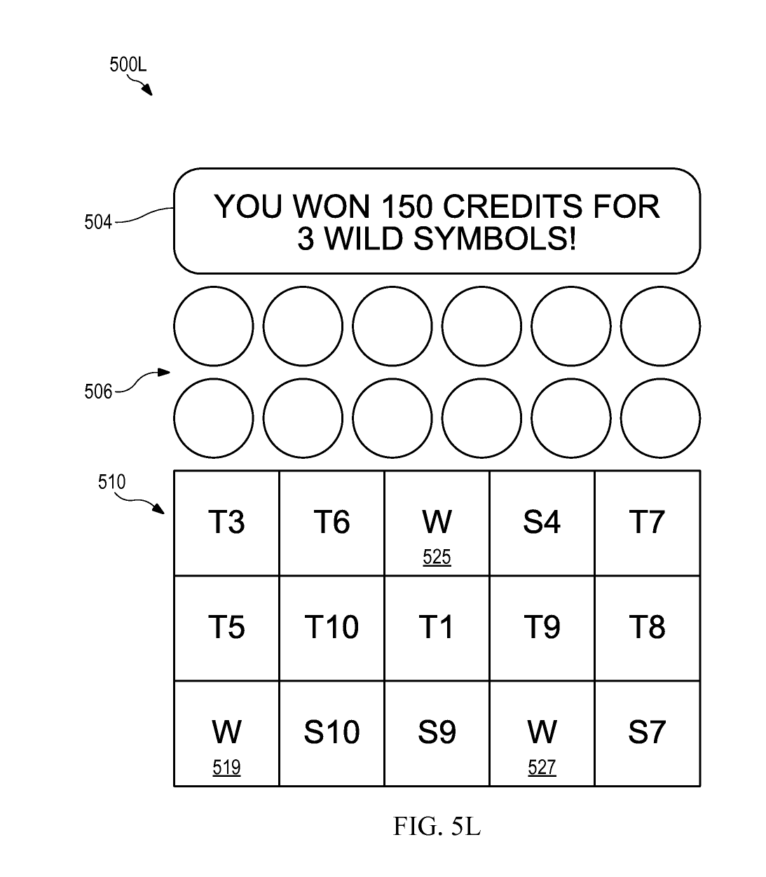

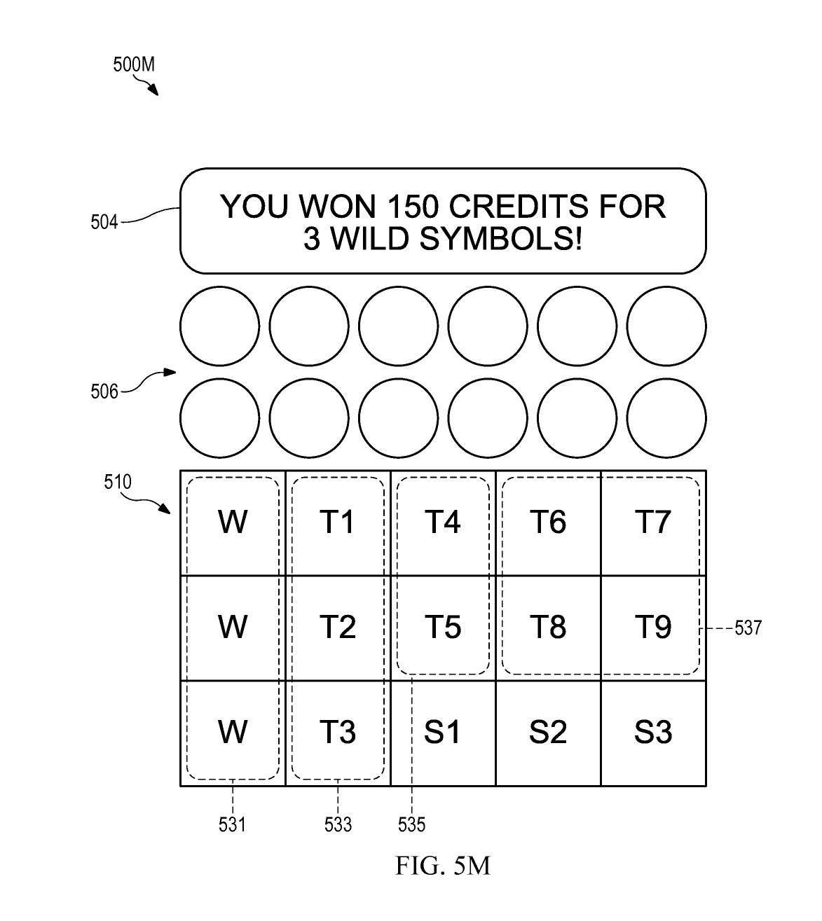

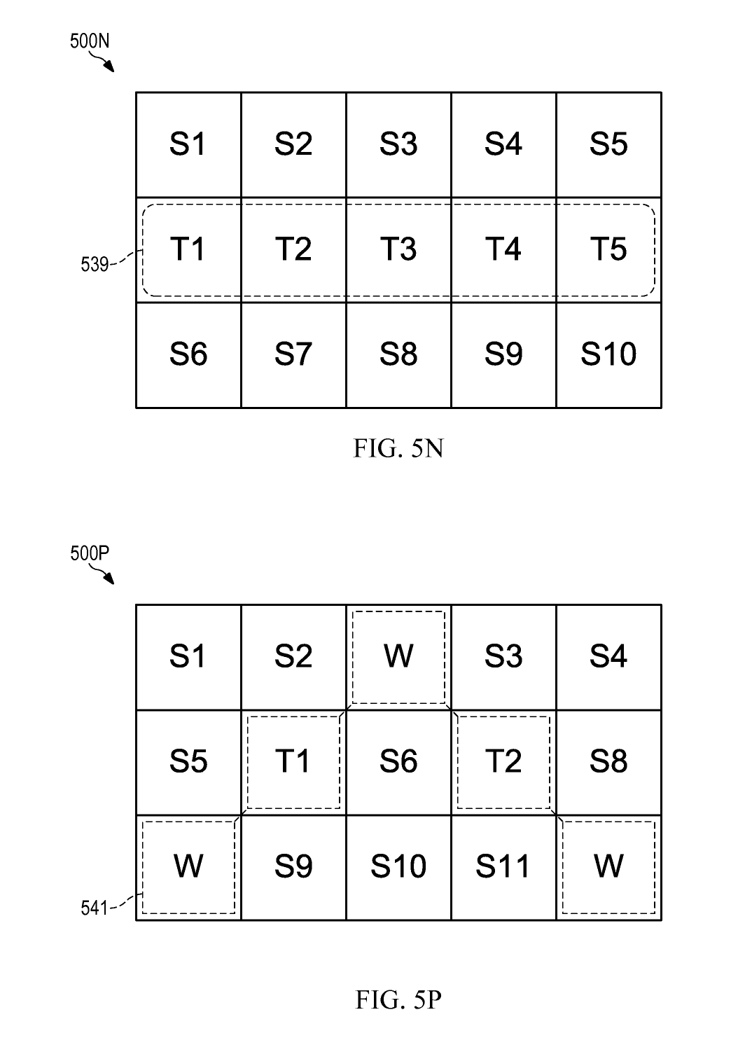

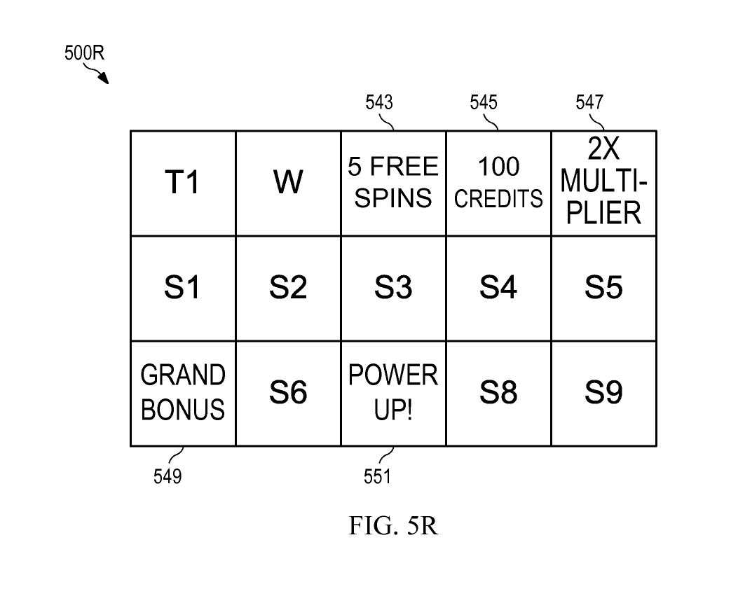

In FIG. 5A, an illustration of treasure spin game play on a gaming device 500A is shown, according to one embodiment. In one example, the gaming device may include a display screen 502, a message area 504, a collection area 506, one or more collection spots 508, one or more reels 510, one or more symbol areas 512, a winning combination 514, a game data area 516, a menu button 518, a bet increment button 520, a second message area 522, a balance area 524, a bet area 526, and a winning amount area 528. In this example, the player has won 5 free spins because winning combination (e.g., 3 free spins) generated 5 free spins. Message area 504 may state “CONGRATULATIONS! YOU WON 5 FREE SPINS!” In one example, collection area 506 is visible during the base game and the bonus game (e.g., free spins, etc.). In another example, collection area 506 may only be displayed during the bonus game (e.g., free spins, etc.). In another example, collection area 506 may only be displayed during the base game and/or the primary game play mode. Further, in another example, collection area 506 may only be displayed during a tournament game play mode and/or any other game play mode. In another example, collection area 506 may be displayed during one, a few, a plurality, and/or all game play modes.

In FIG. 5B, another illustration of treasure spin game play on a gaming device is shown, according to one embodiment. A first image 500B may show a first free spin being completed. In this example, a plurality of symbols are placed and displayed into one or more reels 510. The plurality of symbols may include a first treasure symbol 530. First treasure symbol 530 may be moved (e.g., relocated, etc.) via a first path 532 into a first collection spot 534 in collection area 506. Message area 504 may state “YOU HAVE 4 FREE SPINS REMAINING! YOU COLLECTED ONE TREASTURE SYMBOL!”

Treasure symbols may be a wild symbol, a specific treasure symbol, a scatter symbol, and/or any other symbol. A specific treasure symbol may be based on the game theme (e.g., roman warrior, a pirate, a movie star, a roman god, etc.). Further, two or more symbol may interact to form a treasure symbol. In one example, an Ace would not be a treasure symbol but two Aces next to each other may generate one or more treasure symbols. Further, an Ace may not be a treasure symbol and a King may not be a treasure symbol but when the Ace interacts with the King, one or more treasure symbols may be generated. In various examples, the two or more symbols which interact with each other can be in any relative position to each other. For example, a first interactive symbol may be four spots over and one spot up for a second interactive symbol. In another example, the first interactive symbol may be two spots below the second interactive symbol. Any number of interactive symbols (e.g., 1−N) may be utilized and any number (e.g., 1−N) of interactions may occur.

In various examples, the player may elect to cash in and/or exchange any treasure symbol at any time (e.g., after the first free spin, after the second free spin, etc.). In another example, the player may only have the option to cash in and/or exchange any treasure symbol at the end of the free spin bonus game (e.g., all free spins must be utilized.). In another example, the player may elect to cash in and/or exchange special treasure symbols at any time (e.g., after the first free spin, after the second free spin, etc.). In another example, the player may only have the option to cash in and/or exchange one or more special treasure symbols at the end of the free spin bonus game (e.g., all free spins must be utilized.).

In FIG. 5C, another illustration of treasure spin game play on a gaming device is shown, according to one embodiment. A second image 500C may show a second free spin being completed. In this example, a plurality of symbols are placed and displayed into one or more reels 510. The plurality of symbols may include a second treasure symbol 536 and a third treasure symbol 542. Second treasure symbol 536 may be moved (e.g., relocated, etc.) via a second path 538 into a second collection spot 540 in collection area 506. Third treasure symbol 542 may be moved (e.g., relocated, etc.) via a third path 544 into a third collection spot 546 in collection area 506. Message area 504 may state “YOU HAVE 3 FREE SPINS REMAINING! YOU COLLECTED TWO MORE TREASTURE SYMBOLS! ONE OR MORE SYMBOLS MAY TURN WILD ON THE LAST SPIN!”

In FIG. 5D, another illustration of treasure spin game play on a gaming device is shown, according to one embodiment. A third image 500D may show a third free spin being completed. In this example, a plurality of symbols are placed and displayed into one or more reels 510. The plurality of symbols may include a fourth treasure symbol 550, a fifth treasure symbol 556, a sixth treasure symbol 562, a seventh treasure symbol 570, an eighth treasure symbol 576, and a ninth treasure symbol 582. Fourth treasure symbol 550 may be moved (e.g., relocated, etc.) via a fourth path 552 into a fourth collection spot 554 in collection area 506. Fifth treasure symbol 556 may be moved (e.g., relocated, etc.) via a fifth path 558 into a fifth collection spot 560 in collection area 506. Sixth treasure symbol 562 may be moved (e.g., relocated, etc.) via a sixth path 564 into a sixth collection spot 566 in collection area 506. Seventh treasure symbol 570 may be moved (e.g., relocated, etc.) via a seventh path 572 into a seventh collection spot 574 in collection area 506. Eighth treasure symbol 576 may be moved (e.g., relocated, etc.) via an eighth path 578 into an eighth collection spot 580 in collection area 506. Ninth treasure symbol 582 may be moved (e.g., relocated, etc.) via a ninth path 584 into a ninth collection spot 586 in collection area 506. Message area 504 may state “YOU HAVE 2 FREE SPINS REMAINING! YOU COLLECTED SIX MORE TREASTURE SYMBOLS! ONE OR MORE SYMBOLS MAY TURN WILD ON THE LAST SPIN!”

In FIG. 5E, another illustration of treasure spin game play on a gaming device is shown, according to one embodiment. A fourth image 500E may show a fourth free spin being completed. In this example, a plurality of symbols are placed and displayed into one or more reels 510. The plurality of symbols may include a tenth treasure symbol 588 and an eleventh treasure symbol 594. Tenth treasure symbol 588 may be moved (e.g., relocated, etc.) via a tenth path 590 into a tenth collection spot 592 in collection area 506. Eleventh treasure symbol 594 may be moved (e.g., relocated, etc.) via an eleventh path 596 into an eleventh collection spot 598 in collection area 506. Message area 504 may state “YOU HAVE 1 FREE SPIN REMAINING! YOU COLLECTED TWO MORE TREASTURE SYMBOLS! ONE OR MORE SYMBOLS MAY TURN WILD ON THE LAST SPIN!”

In various examples, one or more of the collected treasure symbols may be relocated to the active gaming area on the last spin and/or during any spin in the bonus game, any spin in the base game, any spin in a tournament game and/or any combination thereof. Further, the treasure symbols may transform into any symbol while still in the collection area and/or during placement of the treasure symbols in the active gaming area. It should be noted that the triggering point may be the last spin, the first spin, a five spin, an Nth spin, and/or any other spin count. Further, the triggering event may be dynamic and/or based on the symbol in the collection area. For example, a first symbol may be triggered after a second free spin. Whereas, a second symbol may be triggered after the final free spin. Further, the combination of the first symbol and the second symbol in the collection are may modify the triggering event to be the fourth free spin.

In FIG. 5F, another illustration of treasure spin game play on a gaming device is shown, according to one embodiment. A fifth image 500F may show a fifth (and final) free spin being completed. In this example, a plurality of symbols are placed and displayed into one or more reels 510. The plurality of symbols may not include any additional treasure symbols. Message area 504 may state “YOU HAVE 0 FREE SPINS REMAINING! YOU DID NOT COLLECT ANY ADDITIONAL TREASTURE SYMBOLS! ONE OR MORE SYMBOLS MAY TURN WILD ON THE LAST SPIN!”

In FIG. 5G, another illustration of treasure spin game play on a gaming device is shown, according to one embodiment. A sixth image 500G may show a first collected symbol 501 moving from first collection spot 534 to a first replacement location 505 via a first replacement path 503. In this example, a first treasure replacement symbol 509 has replaced the symbol S8 (see FIG. 5H) and first collection spot 524 is now a first empty spot 507. Message area 504 may state “NOW WATCH AS ONE OR MORE SYMBOLS MAY TURN WILD AND/OR CREATE ONE OR MORE TREASURES!”

In FIG. 5J, another illustration of treasure spin game play on a gaming device is shown, according to one embodiment. A seventh image 500J may show a second collected symbol 511 moving from second collection spot 540 to a second replacement location 515 via a second replacement path 513. In this example, a first wild replacement symbol 519 has replaced the symbol S11 (see FIG. 5K) and second collection spot 540 is now a second empty spot 517. Message area 504 may state “NOW WATCH AS ONE OR MORE SYMBOLS MAY TURN WILD AND/OR CREATE ONE OR MORE TREASURES!”

In FIG. 5L, another illustration of treasure spin game play on a gaming device is shown, according to one embodiment. An eighth image 500L may show all of the collected symbols having already been transferred onto the active gaming area (e.g., active reel areas, etc.). In this example, there are three replacement wilds (e.g., first replacement wild 519, a second replacement wild 525, and a third replacement wild 527). Message area 504 may indicate that the player has won 150 credits for 3 wild symbols. Further, eight replacement treasure symbols (e.g., T1, T3, T5, T6, T7, T8, T9, and T10) have replaced various symbols on the display which may generate one or more prizes based on the individual symbols, the individual symbol locations, one or more interactions between the symbols, and/or any combination thereof.

Super treasure spin may be where one or more symbols are moved from one or more collection areas and moved around the active reels for multiple spins. For example, a wild is dropped from the collection area to a first symbol area for a first spin and then the same wild is moved to a second symbol area for a second spin and then the same wild is moved to a third symbol area for an Nth spin.

In FIG. 5M, another illustration of treasure spin game play on a gaming device is shown, according to one embodiment. Once the collected treasure symbols are utilized to replace one or more symbols on the reels, then one or more winning combinations may occur. In various examples, a first winning combination 531 may occur when three wilds are adjacent to each other. Further, a winning combination may occur when there are a specific number (e.g., 1 to N) of wilds located in any position. For example, a first wild located in row 1 column 1 and a second wild located in row 3 column 5 may generate a winning combination. In addition, a first wild located in row 1 column 1, a second wild located in row 1 column 4, a third wild located in row 2 column 5, and a fourth wild located in row 3 column 1 may generate another winning combination. In another example, a second winning combination 533 may occur when three treasure symbols are located adjacent to each other. Further, a winning combination may occur when there are a specific number (e.g., 1 to N) of treasure symbols located in any position. For example, a first treasure symbol located in row 1 column 2 and a second treasure symbol located in row 3 column 4 may generate a winning combination. In addition, a first treasure symbol located in row 2 column 1, a second treasure symbol located in row 3 column 4, a third treasure symbol located in row 2 column 1, and a fourth treasure symbol located in row 3 column 3 may generate another winning combination. Further, a third winning combination 535 may occur when two treasure symbols are located adjacent to each other. In addition, a fourth winning combination 537 may occur when four treasure symbols are located to form a shape (e.g., a box, an L, a T, an S, a Z, a V, etc.).

In FIG. 5N, another illustration of treasure spin game play on a gaming device is shown, according to one embodiment. In one example, five treasure symbols located adjacent to each other in the same row may generate a winning combination. Further, treasure symbols and wilds symbols (and/or scatters and/or any other symbol) may interact together to form a winning combination. In one example, a fifth winning combination 541 may be generated by a combination of three wilds and two treasure symbols (see FIG. 5P).

In FIG. 5R, another illustration of treasure spin game play on a gaming device is shown, according to one embodiment. In this example, one or more treasure symbols may transform into free spins, credits, multipliers, a grand bonus, a power up, any other item, and/or any combination thereof. In various examples, a treasure symbol may transform into a free spin image 543, a credit image 545, a multiplier image 547, a grand bonus image 549, a power-up image 551, and/or any other image. Further, it may be an interaction between two or more symbols (e.g., two treasure symbols, one treasure symbol and one wild symbol, two wild symbols, one treasure symbol and one scatter symbol, one treasure symbols and another symbol, etc.) which generates the transformation into one or more of free spin image 543, credit image 545, multiplier image 547, grand bonus image 549, power-up image 551, and/or any other image.

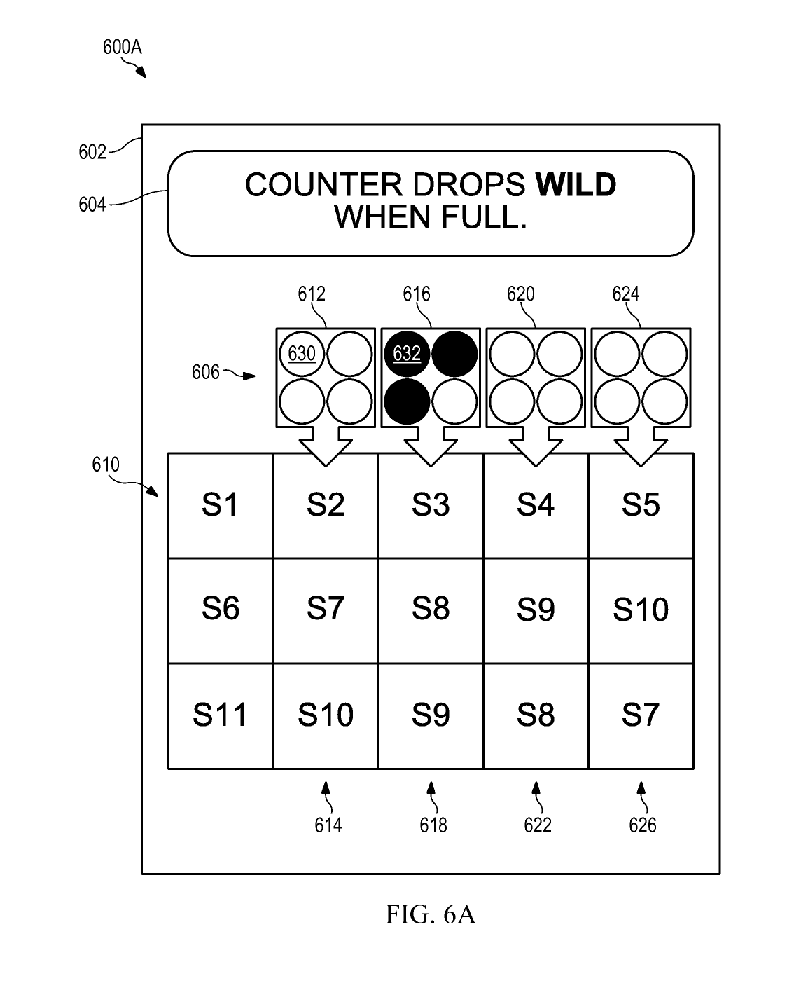

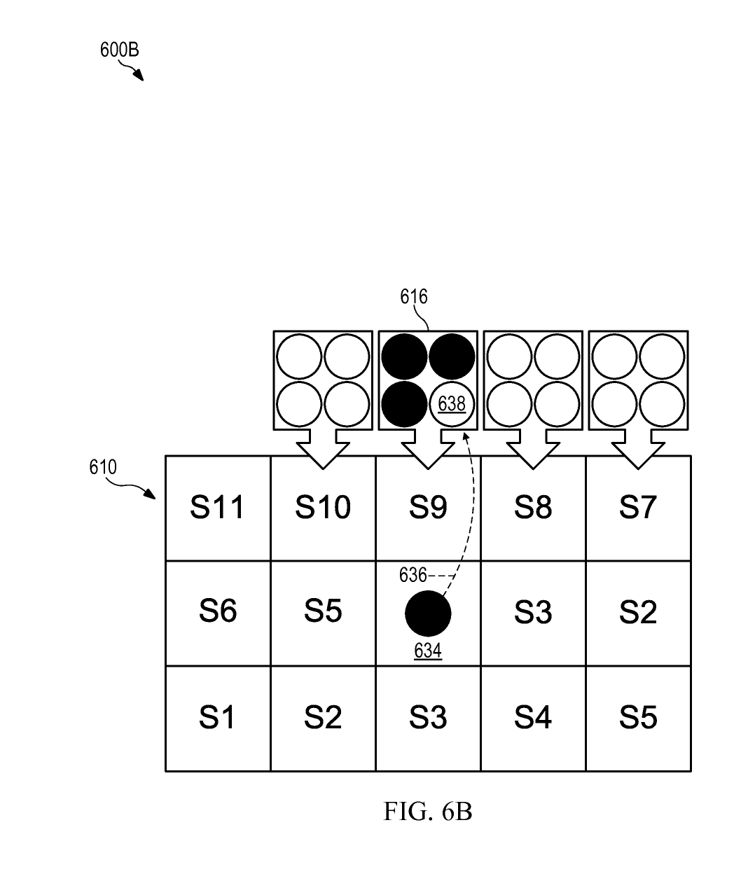

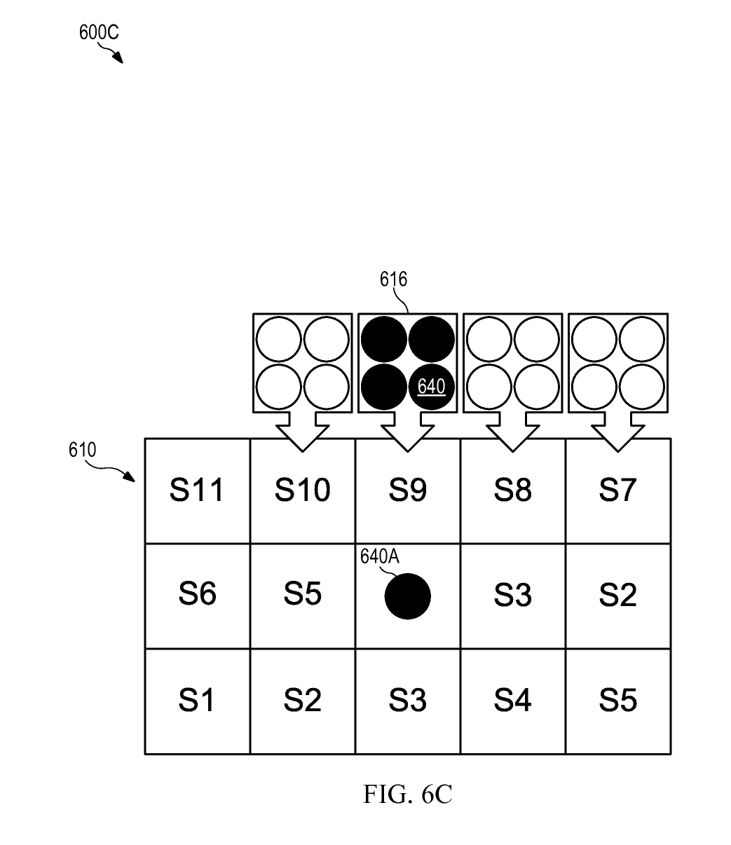

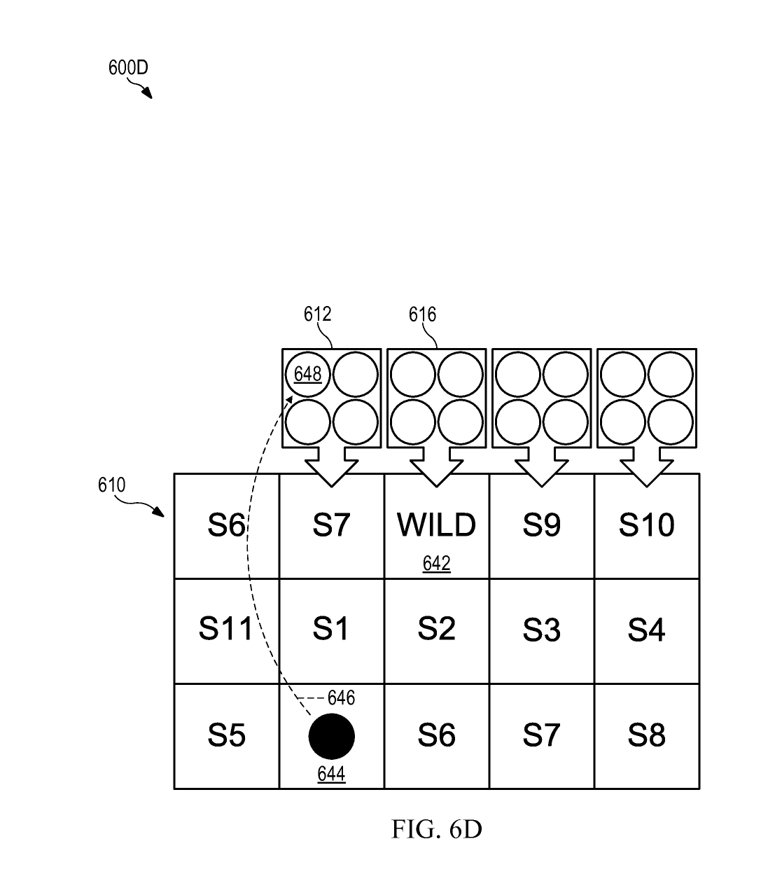

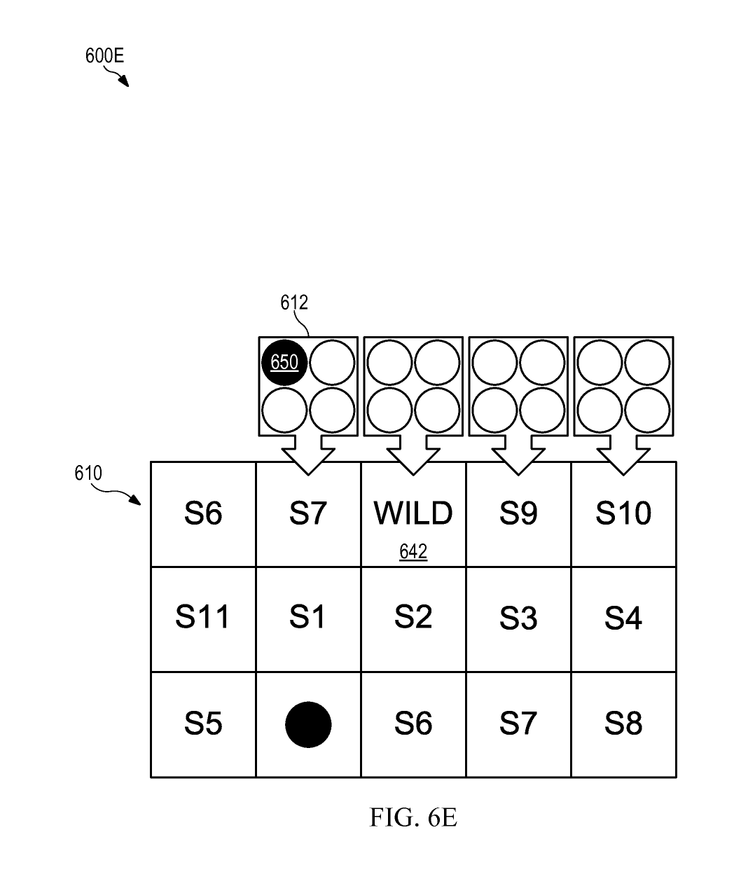

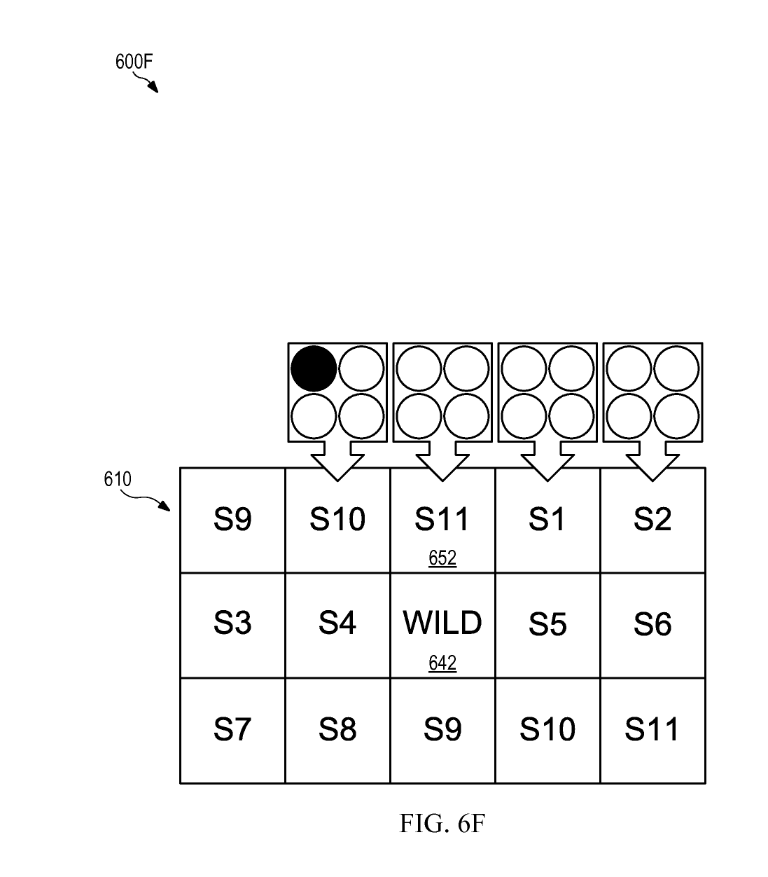

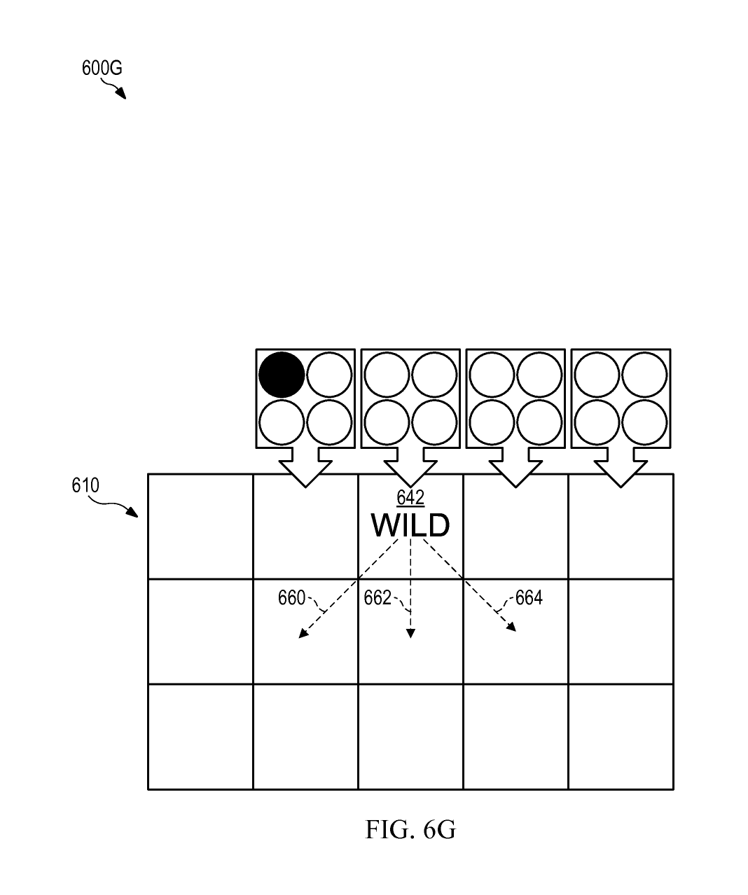

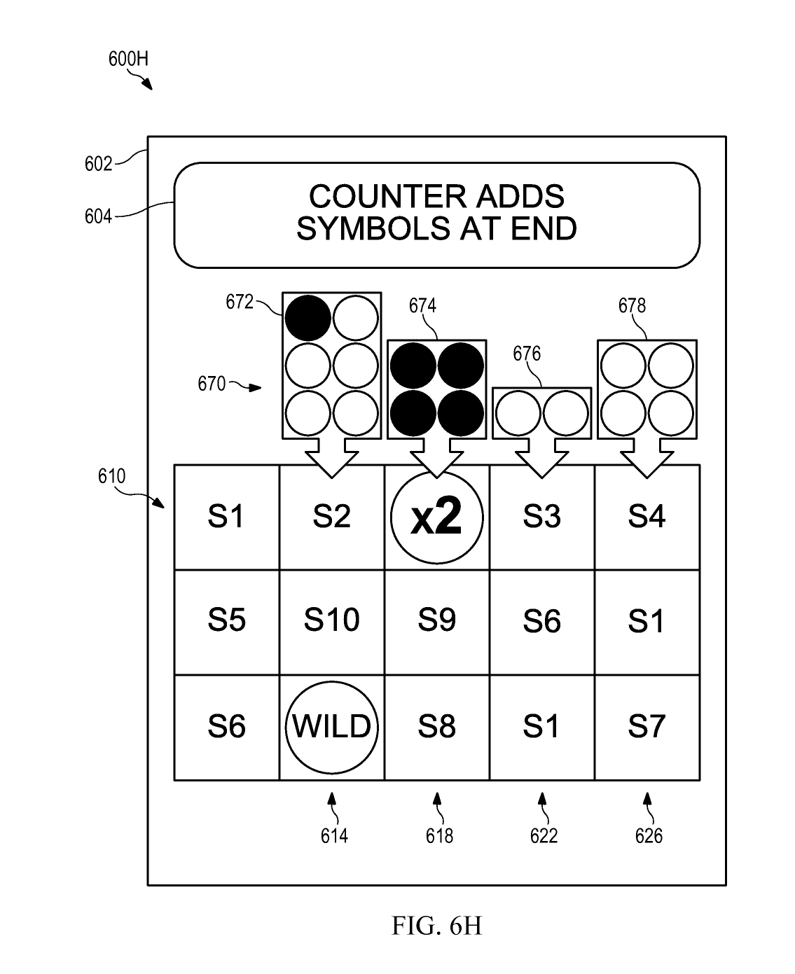

In FIG. 6A, another illustration of treasure spin game play on a gaming device is shown, according to one embodiment. A first image 600A may include a display screen 602, a message area 604, a collection area 606, a first collection zone 612, a second collection zone 616, a third collection zone 620, a fourth collection zone 624, one or more collection spots (e.g., 630) located in one or more collection zones, a first active reel area 610, a second active reel area 614, a third active reel area 618, a fourth active reel area 622, and a fifth active reel area 626.

In one example, first collection zone 612 has not collected any symbols and is empty. Further, second collection zone 616 has three collected symbols and only has one empty spot remaining. Further, third collection zone 620 and fourth collection zone 624 are also empty and have not collected any symbols. Message area 604 may state “COUNTER DROPS WILD WHEN FULL.”

In one example, an additional spin generates a new collectable symbol which is a fourth collectable symbol 634 which moves via a collection path 636 into second collection zone 616 (see FIG. 6B). By collecting fourth collectable symbol 634 and placing it in fourth collection slot 638 in second collection zone 616, second collection zone 616 is now full. Therefore, second collection zone 616 now generates a drop symbol 640A to drop onto active reel. In this example, drop symbol 640A is placed on the third reel (e.g., row 2 column 3) (see FIG. 6C). Drop symbol 640A may be a wild symbol, a scatter symbol, a stack wild symbol, an expanding wild symbol, a stacked symbol, a symbol, a treasure symbol, any other symbol, and/or any combination thereof.

In FIG. 6D, another illustration of treasure spin game play on a gaming device is shown, according to one embodiment. In this example, a first collectable symbol 644 is transferred into first collection zone 612 (e.g., located at first slot 648) via a first path 646 and becomes a first collected symbol 650 (see FIG. 6E). At the same time, a first wild symbol 642 may be dropped into third reel.

In another example, the next spin may not generate any new collectable symbols but first wild symbol 642 may move down one or more spaces. Further, first wild symbol 642 may move to the right, left, and/or up one or more spaces. In addition, first wild symbol 642 may continue to move in subsequent spins until first wild symbol 642 is no longer on the active gaming area and/or a certain number of subsequent spins has occurred (see FIG. 6F).

In various examples shown in FIG. 6G, first wild symbol 642 may move in a first direction 660, a second direction 662, a third direction 664, a left direction (not shown), a right direction (not shown), an up direction (not shown), and/or any combination thereof. Further, the length of the direction may be any length.

In FIG. 6H, another illustration of treasure spin game play on a gaming device is shown, according to one embodiment. In this example, a first collection area 670 may be a first size (e.g., 3×2), a second collection area 674 may be a second size (e.g., 2×2), a third collection area 676 may be a third size (1×2), and a fourth collection area 678 may be a fourth size (e.g., 2×2). In this example, second size and fourth size are the same, however, it should be noted that one or more sizes may be the same and/or no sizes may be the same. In addition, any size (e.g., 1×1, 1×2, 2×1, 2×2, etc.) may be utilized.

In one example, a drop down symbol may be a wild symbol (e.g., row 3 column 2), a multiplier (e.g., row 1, column 3), a stacked wild, a stacked symbol, a scatter, any symbol, a treasure symbol, a stacked treasure symbol, and/or any combination thereof. Further, as discussed above, the drop down symbols may move all over the board on subsequent spins (e.g., super treasure).

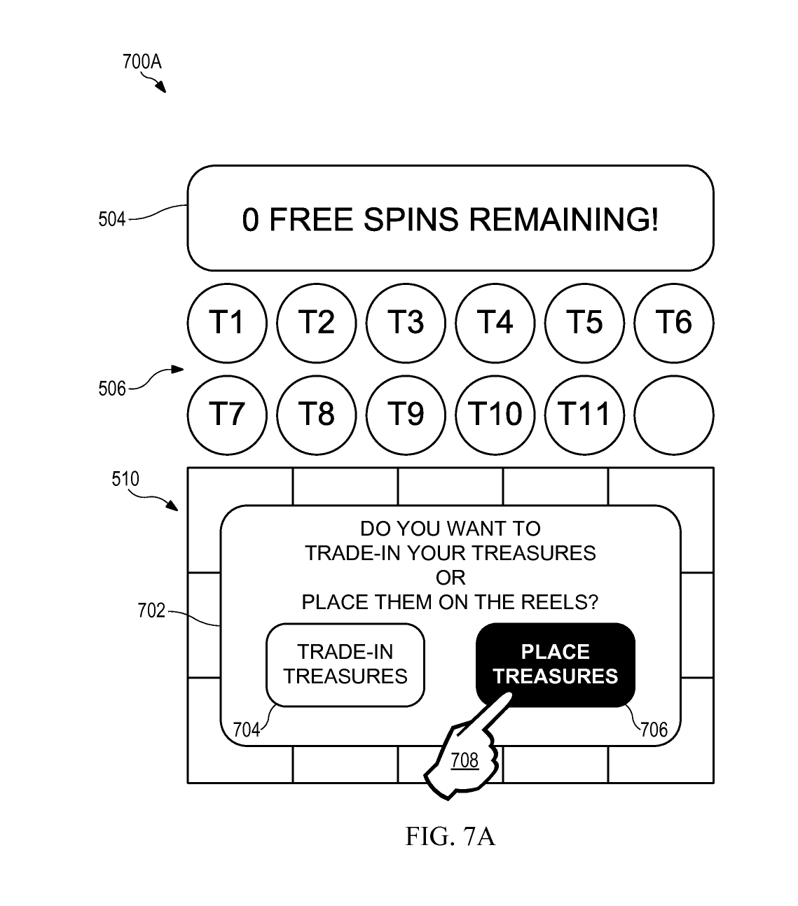

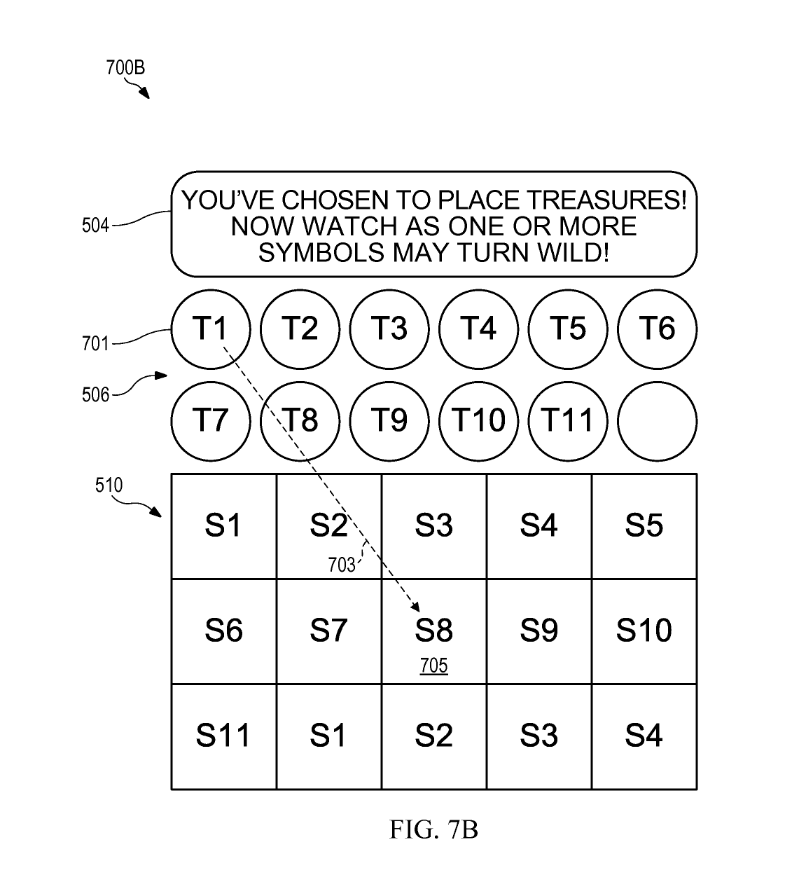

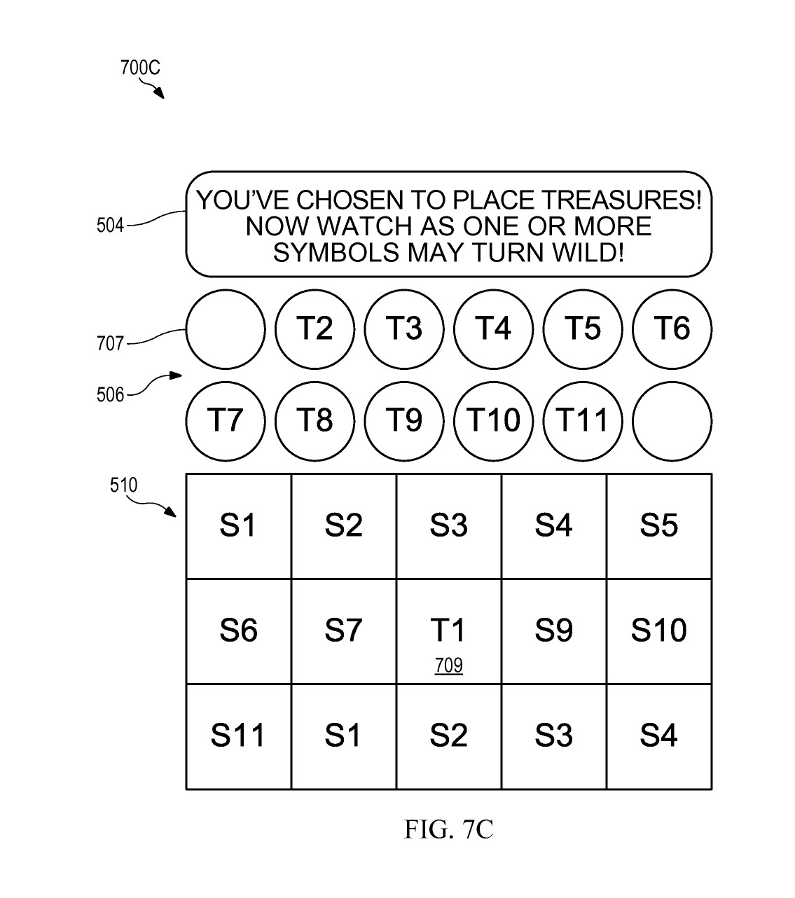

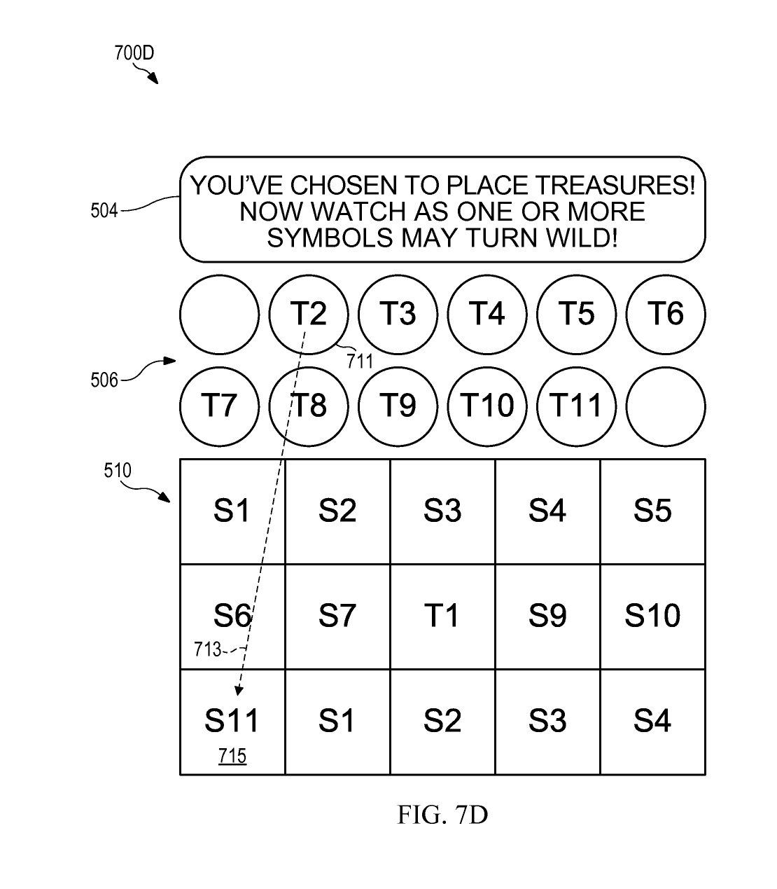

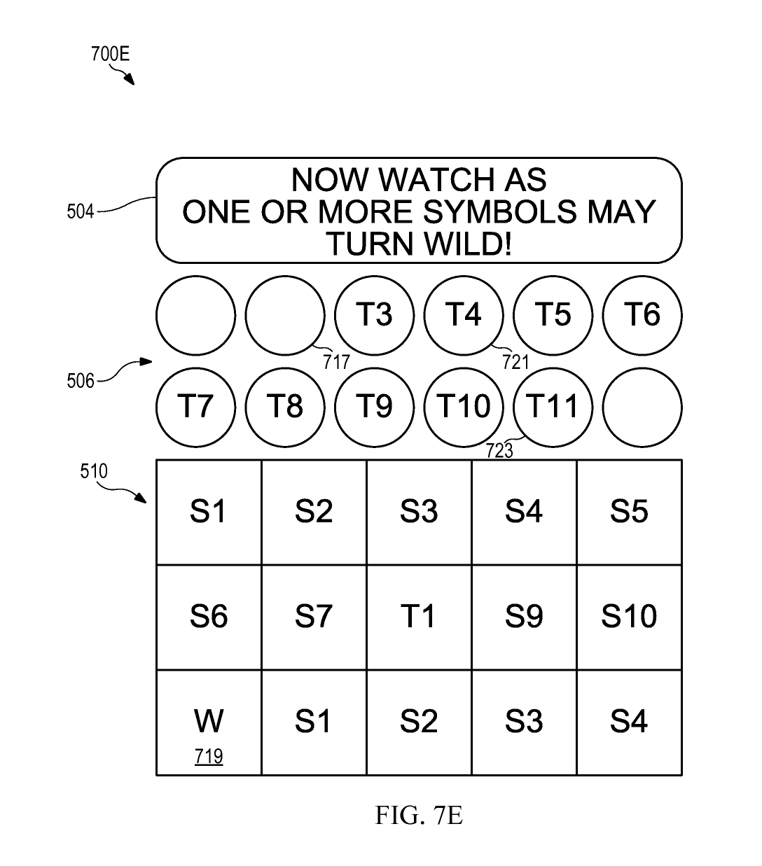

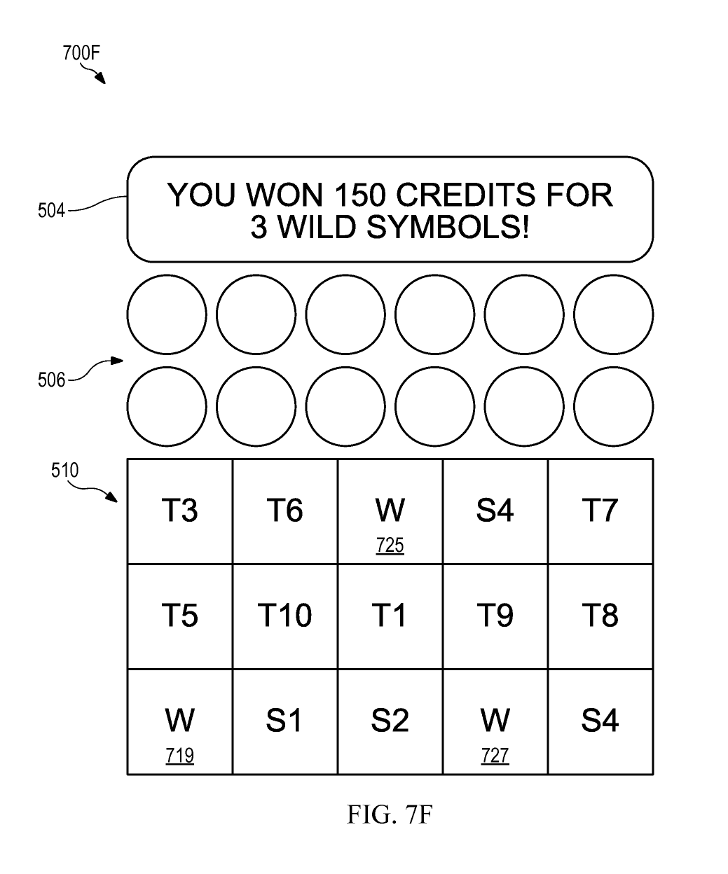

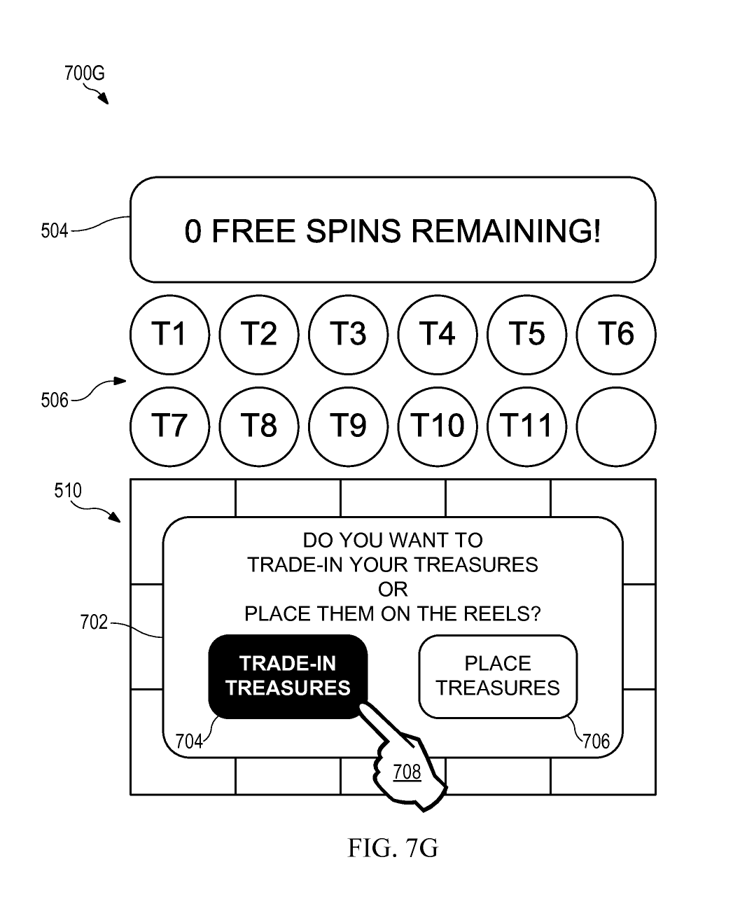

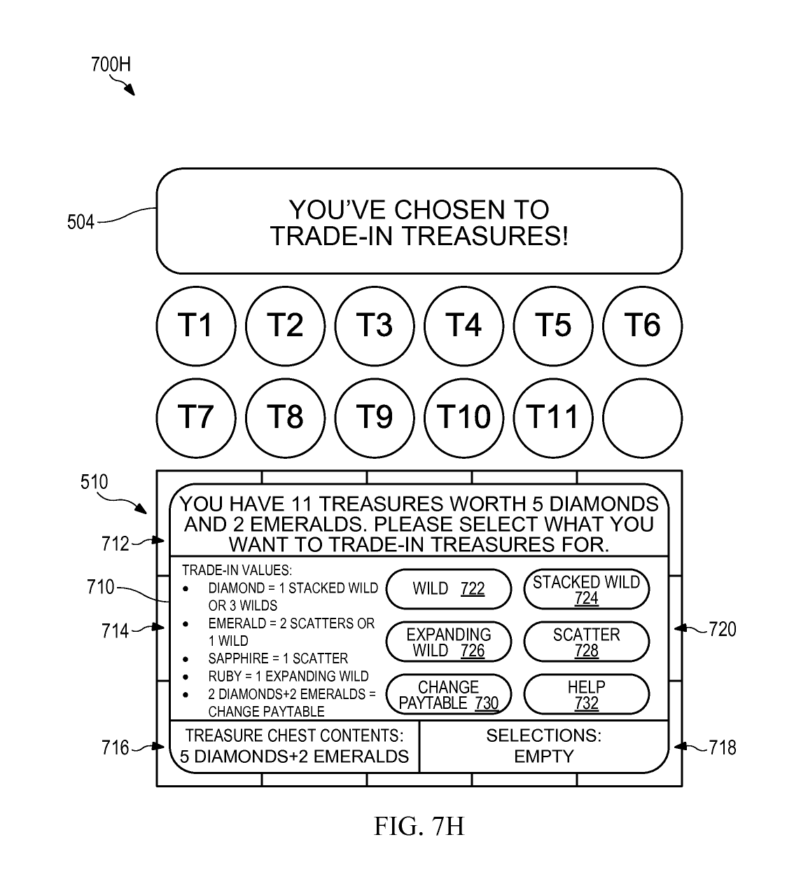

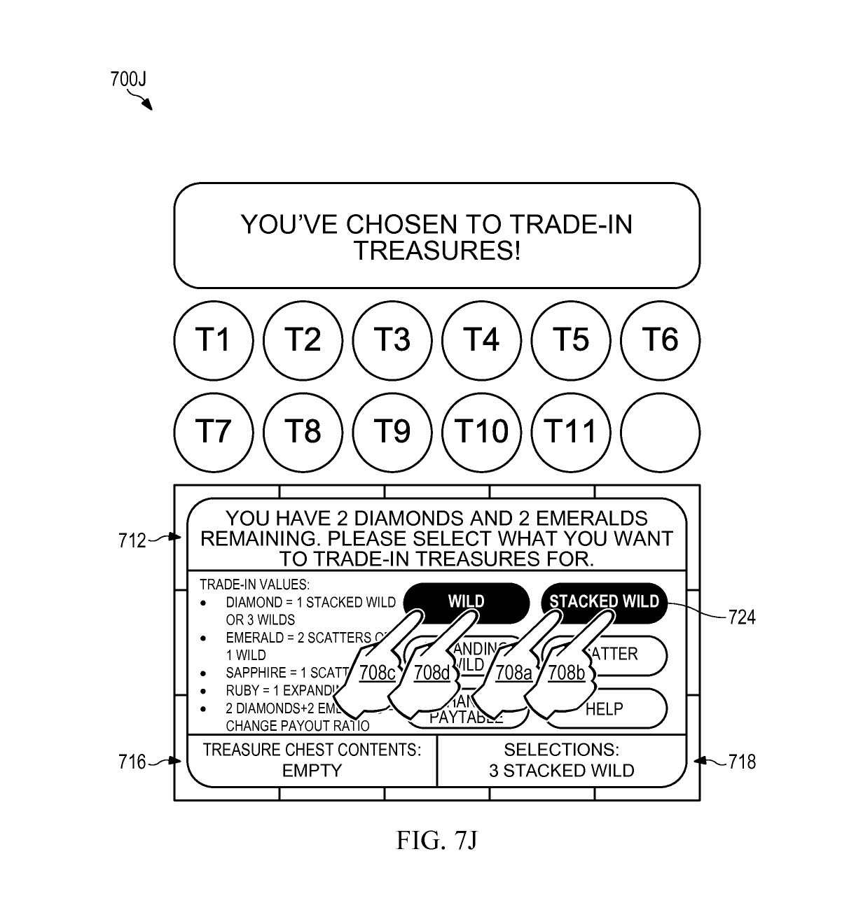

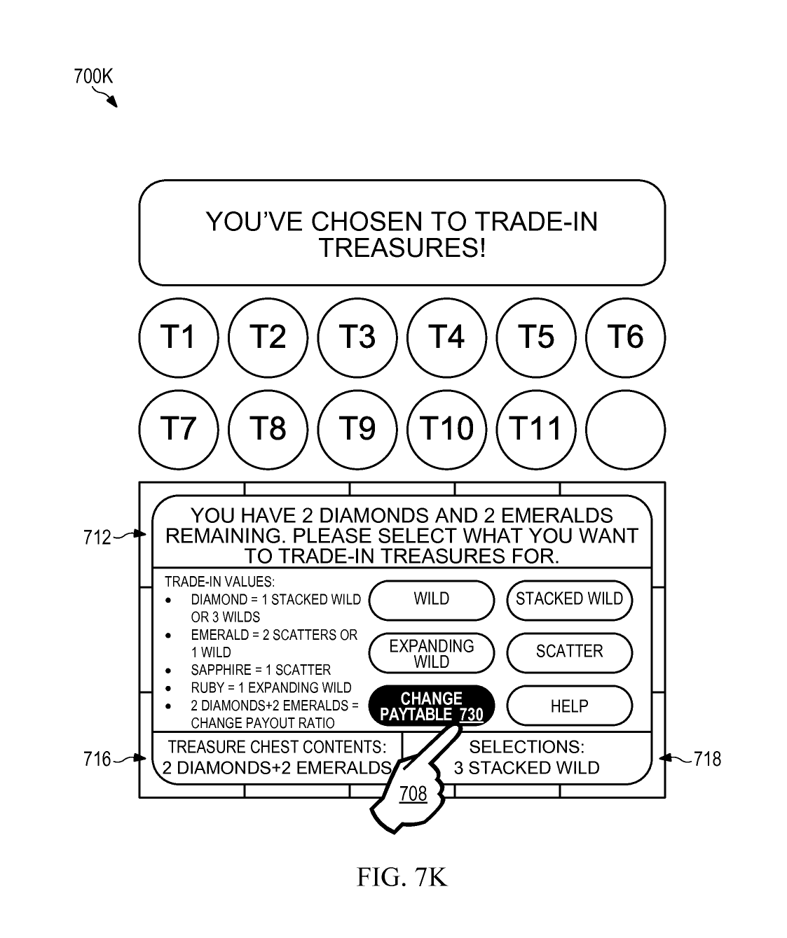

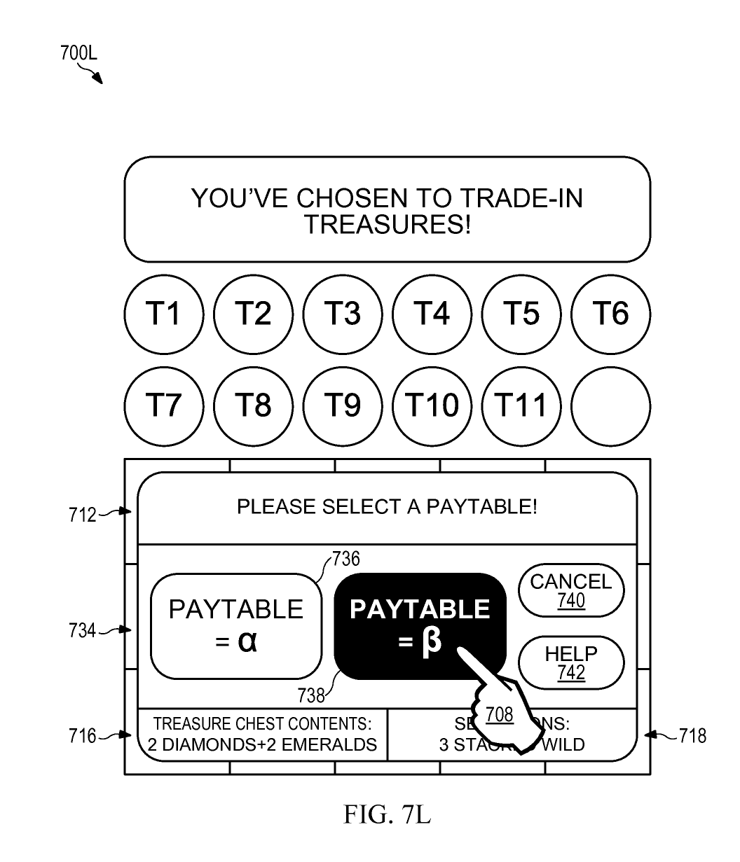

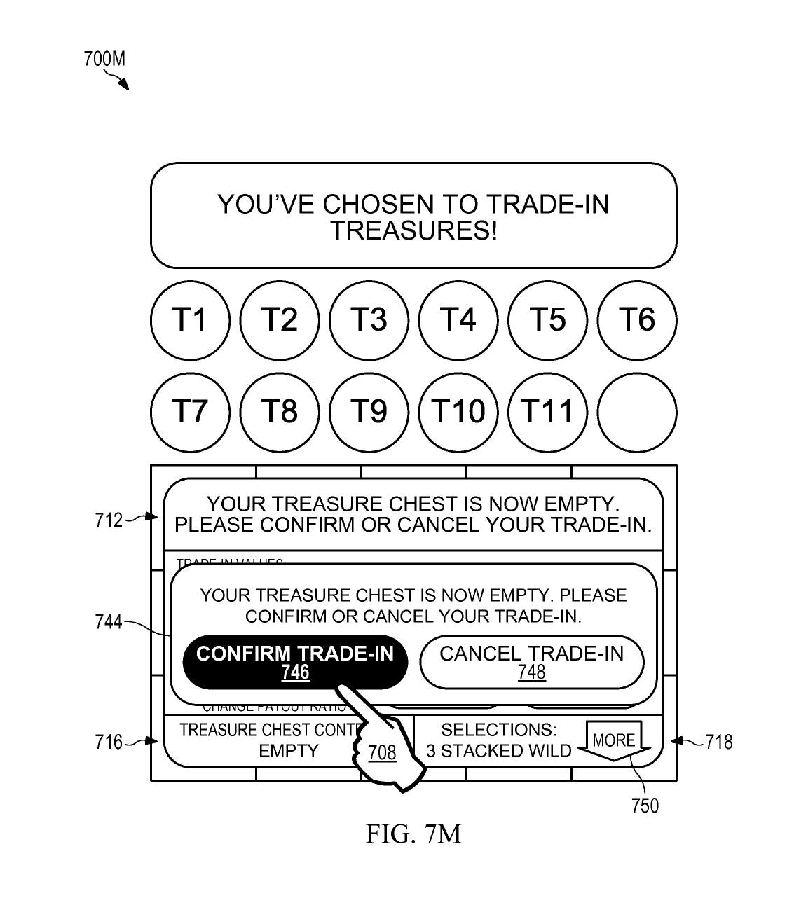

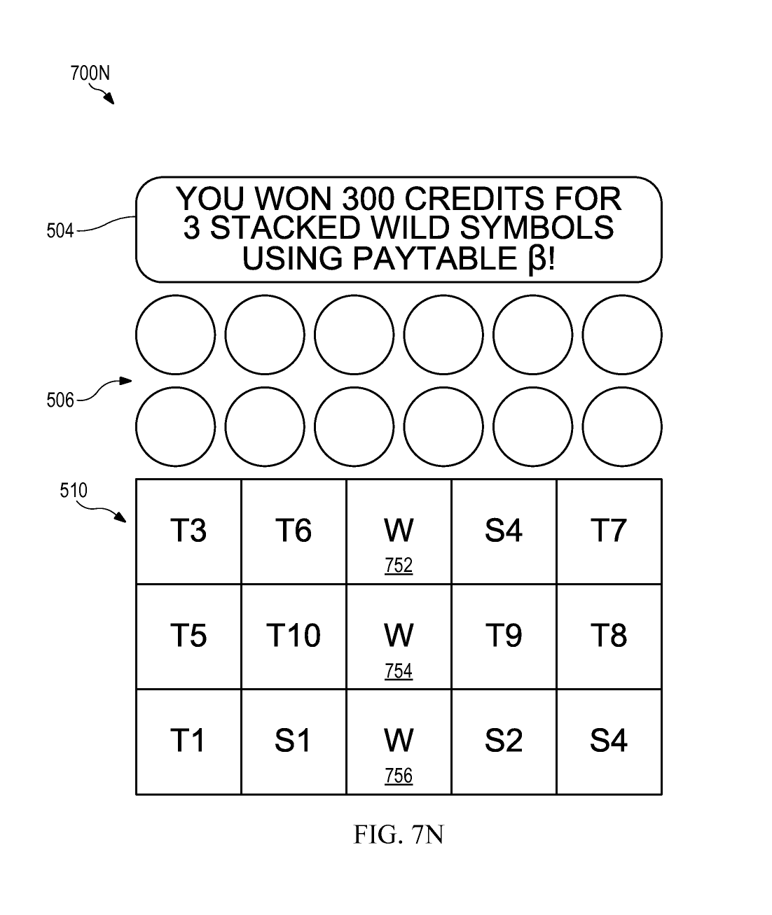

In FIG. 7A, another illustration of treasure spin game play on a gaming device is shown, according to one embodiment. In this example, a trade-in option message area 702 may include a trade-in treasures button 704 and a place treasures button 706. Trade-in option message area 702 may state “DO YOU WANT TO TRADE-IN YOUR TREASURES OR PLACE THEM ON THE REELS?” In this example, the player has elected via hand 708 to select the place treasures option (e.g., selected place treasures button 706).

In FIG. 7B, a first image 700B may show a first collected symbol 701 moving from first collection spot 534 to a first replacement location 705 via a first replacement path 703. In this example, a first treasure replacement symbol 709 has replaced the symbol S8 (see FIG. 7C) and first collection spot 524 is now a first empty spot 707. Message area 504 may state “NOW WATCH AS ONE OR MORE SYMBOLS MAY TURN WILD AND/OR CREATE ONE OR MORE TREASURES!”

In FIG. 7D, another illustration of treasure spin game play on a gaming device is shown, according to one embodiment. A second image 700D may show a second collected symbol 711 moving from second collection spot 540 to a second replacement location 715 via a second replacement path 713. In this example, a first wild replacement symbol 719 has replaced the symbol S11 (see FIG. 7E) and second collection spot 540 is now a second empty spot 717. Message area 504 may state “NOW WATCH AS ONE OR MORE SYMBOLS MAY TURN WILD AND/OR CREATE ONE OR MORE TREASURES!”

In FIG. 7F, another illustration of treasure spin game play on a gaming device is shown, according to one embodiment. A third image 700F may show all of the collected symbols having already been transferred onto the active gaming area (e.g., active reel areas, etc.). In this example, there are three replacement wilds (e.g., first replacement wild 719, a second replacement wild 725, and a third replacement wild 727). Message area 504 may indicate that the player has won 150 credits for 3 wild symbols. Further, eight replacement treasure symbols (e.g., T1, T3, T5, T6, T7, T8, T9, and T10) have replaced various symbols on the display which may generate one or more prizes based on the individual symbols, the individual symbol locations, one or more interactions between the symbols, and/or any combination thereof.

In FIG. 7G, another illustration of treasure spin game play on a gaming device is shown, according to one embodiment. In one example, a fourth image 700G shows trade-in option message area 702 which may include trade-in treasures button 704 and place treasures button 706. Trade-in option message area 702 may state “DO YOU WANT TO TRADE-IN YOUR TREASURES OR PLACE THEM ON THE REELS?” In this example, the player has elected via hand 708 to select the trade-in treasures option (e.g., selected trade-in treasures button 704).

In FIG. 7H, a fifth image 700H includes message area 504, a trade-in message area 710, a trade-in message area heading 712, a trade-in selection area 714, a trade-in balance area 716, and a cart-out area 718. In one example, message are 504 may confirm that the player has selected the trade-in option by stating “YOU'VE CHOSEN TO TRADE-IN YOUR TREASURES!” Further, trade-in message area heading 712 may communicate to the player what the player's balance is by stating “YOU HAVE 11 TREASURES WORTH 5 DIAMONDS AND 2 EMERALDS. PLEASE SELECT WHAT YOU WANT TO TRADE-IN THE TREASURES FOR.” The player's balance is shown in trade-in balance area 716. In one example, as the player's selects one or more trade-in items, the player's balance is automatically updated to reflect this trade-in item and to show the current player's balance. In addition, trade-in selection area 714 may show the trade-in conversion rate. This may be a static conversion rate and/or a dynamic conversion rate. For example, one diamond may equal one stacked wild and/or three wilds which does not change in a static conversion rate mode. However, one diamond may equal two stacked wilds and/or five wilds depending on one or more factors (e.g., player level, length of playing session, a special promotion, an average bet size, a bet size, a bet size over the last X spins, the time of the day, etc.) in a dynamic rate mode. In another example, one emerald may equal two scatters and/or one wild which may not change in a static conversion rate mode. However, in a dynamic mode based on the number of players playing this type of game the conversion rate may be increased to one emerald equals two scatters and one wild and/or four wilds and/or one stacked wild and one stacked symbol. In another example, one sapphire may equal one scatter in a static mode. Whereas, one sapphire may equal one scatter and one wild based on the frequency of gaming entity visits by the player. In another example, one ruby may equal one expanding wild. In a further example, two diamonds and two emeralds may allow the player to change the paytable and/or payout algorithm (see FIG. 7K). In addition, cart-out area 718 may show the trade-in items that the player has selected before confirming and finalizing one or more trade-in transactions. It should be noted that any other items and/or theme may be utilized instead of diamonds, emeralds, sapphires, rubies, etc. For example, a battle type game may include different forms of armor, food, medicine, shelter, and/or weapons. In addition, the player may not utilize all of the trade-in value. Instead, the player may bank one or more treasures for later placement on the active reel area and/or for later trade-in options. In addition, the trade-in options may change as the level of the game increases. For example, during a first trade-in option the player may not be able to access various items (e.g., change the paytable and/or change the algorithm). However, during a subsequent trade-in option, this trade-in selection option may be unlocked to allow the player to select it if the player has enough of a balance.

In FIG. 7J, another illustration of treasure spin game play on a gaming device is shown, according to one embodiment. A fifth image 700J shows the player making four selections and utilizing the player's entire treasure balance of two diamonds and two emeralds. In a first selection 708a, the player selected a first stacked wild. In a second selection 708b, the player selected a second stacked wild. In a third selection 708c, the player selected a first wild. In a fourth selection 708e, the player selected a second wild. In this example, trade-in balance area 716 is zero and/or empty after these four selections. However, after each individual selection, the balance would have been modified. For example, after the first selection 708a, the balance may have been shown as 1 diamond and 2 emeralds. After the second selection 708b, the balance may have been shown as 2 emeralds.

In another example shown in FIG. 7K, a change paytable option 730 is unlocked and the player has a high enough treasure balance to utilize this change paytable option 730. In this example, the player elects to utilize change paytable option 730. In one example (see FIG. 7L), once the player elects to utilize change paytable option 730 a change paytable screen 734 is displayed. The player may elect a first paytable option 736, a second paytable option 738, and/or an Nth paytable option (not shown). In this example, a first paytable option 736 may indicate that it has a 85% payout rate and/or a high volatility rate. Whereas, second paytable option 738 may indicate that it has a 95% payout rate and/or a low volatility rate. Any payout rate (e.g., 1−N %) and/or any volatility rate (e.g., low, below average, average, above average, high, extreme, etc.) may be utilized either as a standalone and/or in combination with any other gaming factor. In this example, the player has elected to utilize the second paytable. Further, when this selection process is being utilized the base paytable ratio may be indicated to the player. In addition, a cancel button 740 and a help button 742 may be displayed for the player's utilization. In one example, the player has won 300 credits for 3 stacked wild symbols using paytable beta (see FIG. 7N).

When the player has completed all of their selections, a confirmation step may be initiated. For example, a confirm trade-in button 746 and a cancel trade-in button 748 may be displayed. If the player selects confirm trade-in button 746, then the trade-in selections are completed and implemented. If the player selects cancel trade-in button, then the transaction is not completed and the gaming device and/or method may return to one of the previous steps (FIG. 7A, etc.). In addition, this step may be automated so that no confirmation is required. Further, the system and/or method may determine the optimal trade-in selections and complete this automatically for the player.

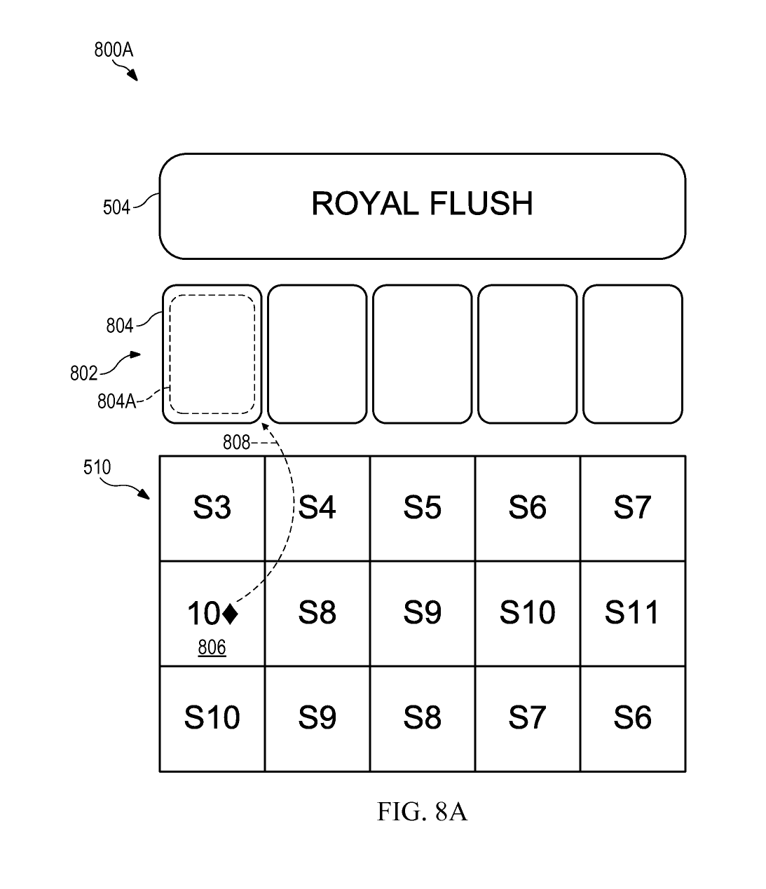

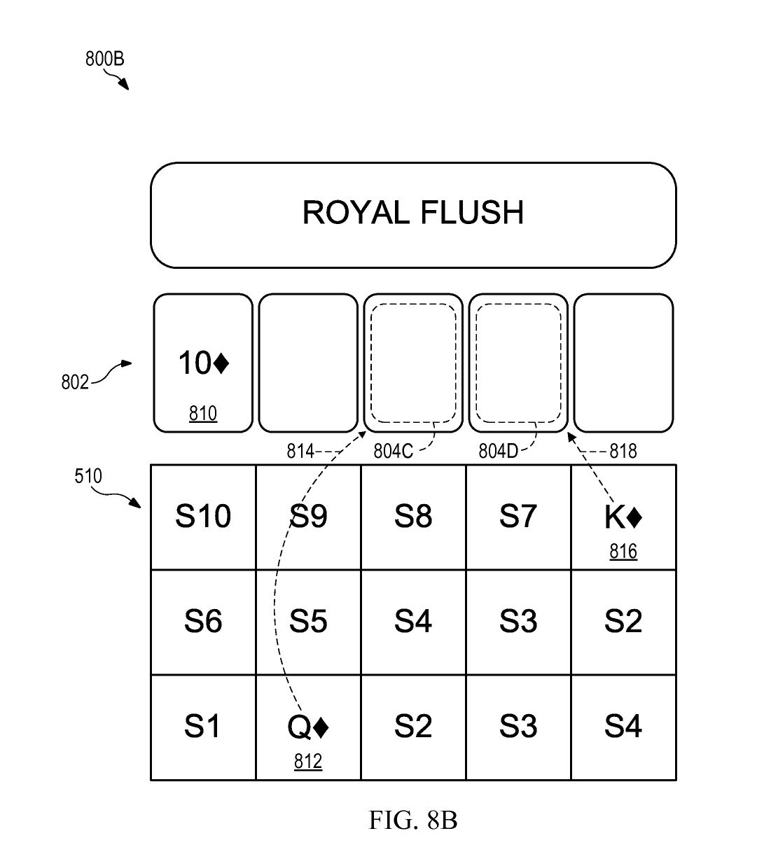

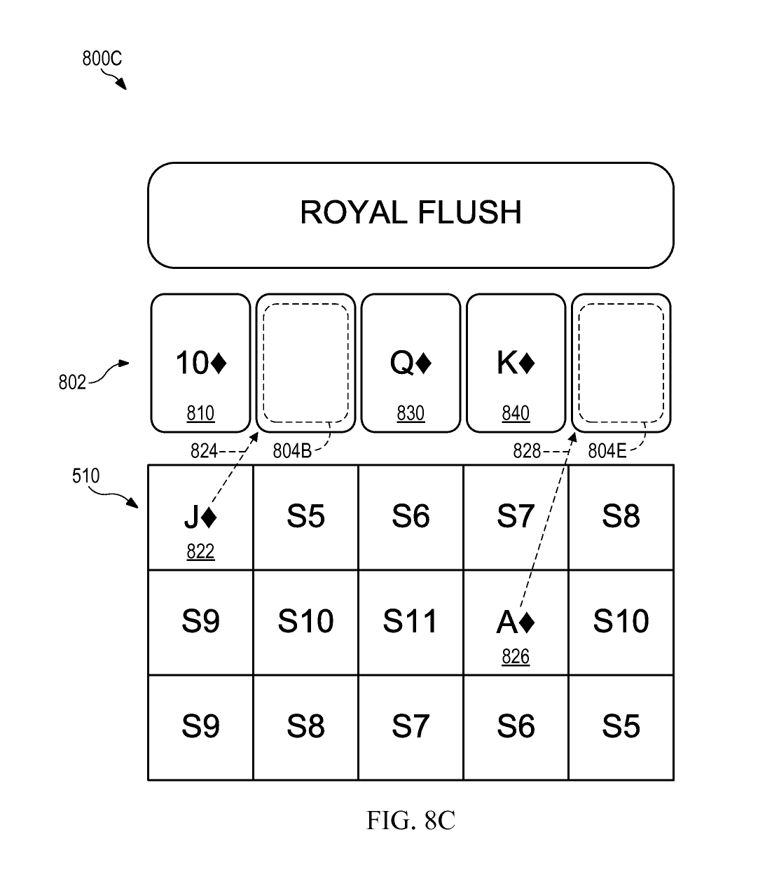

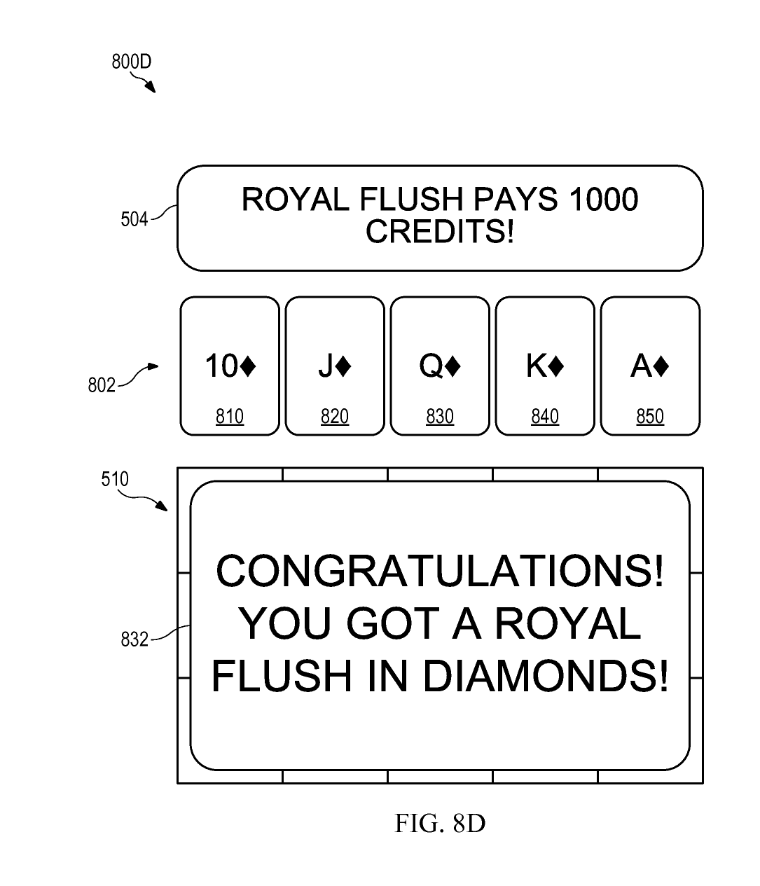

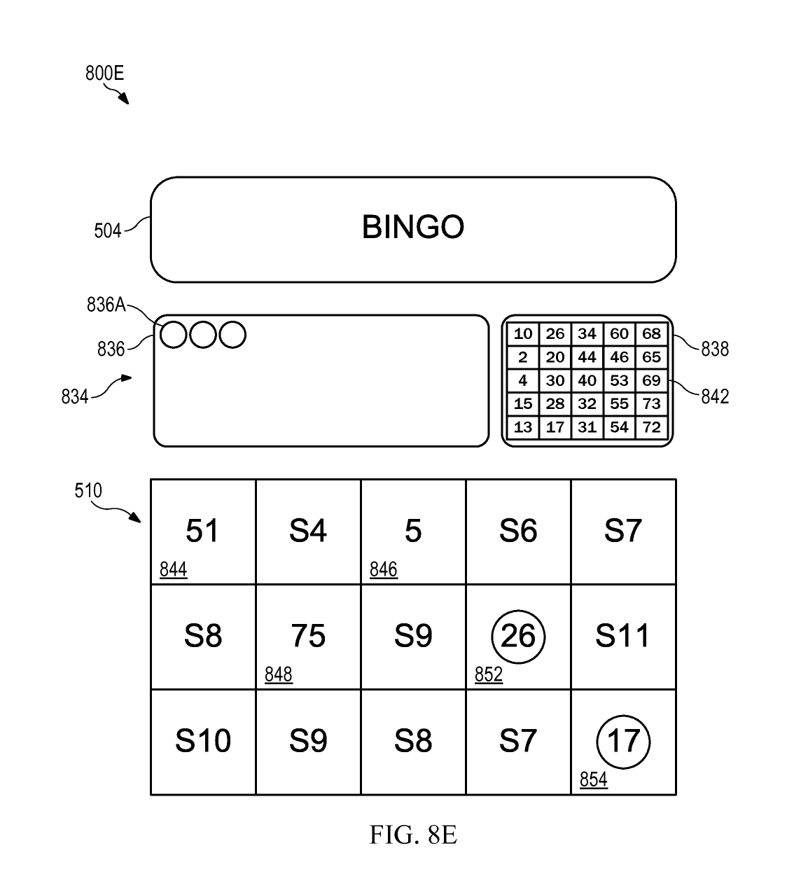

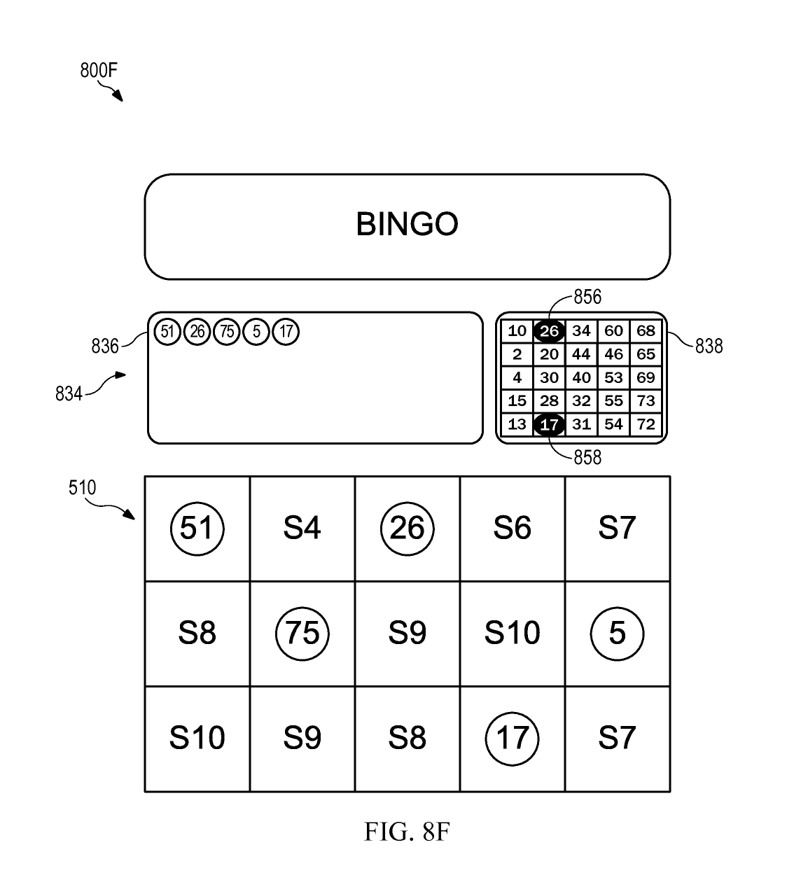

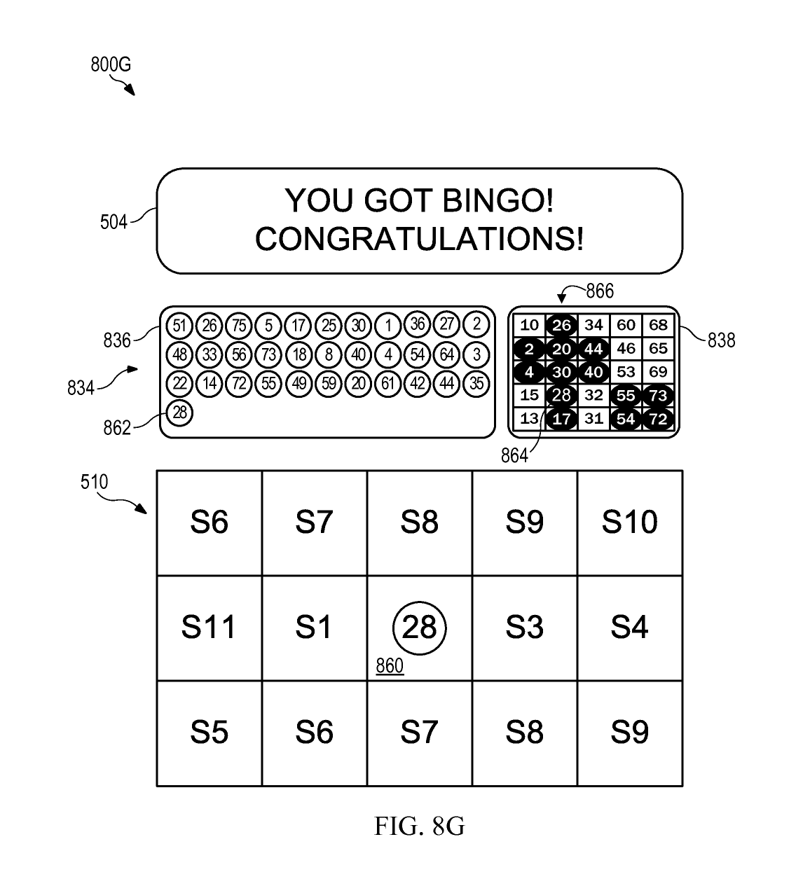

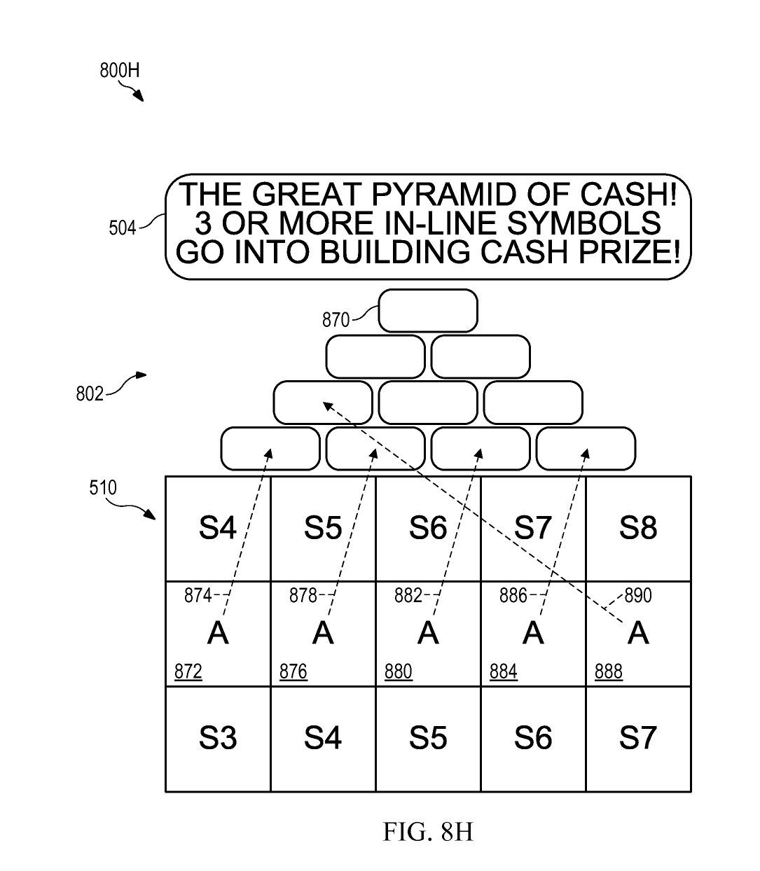

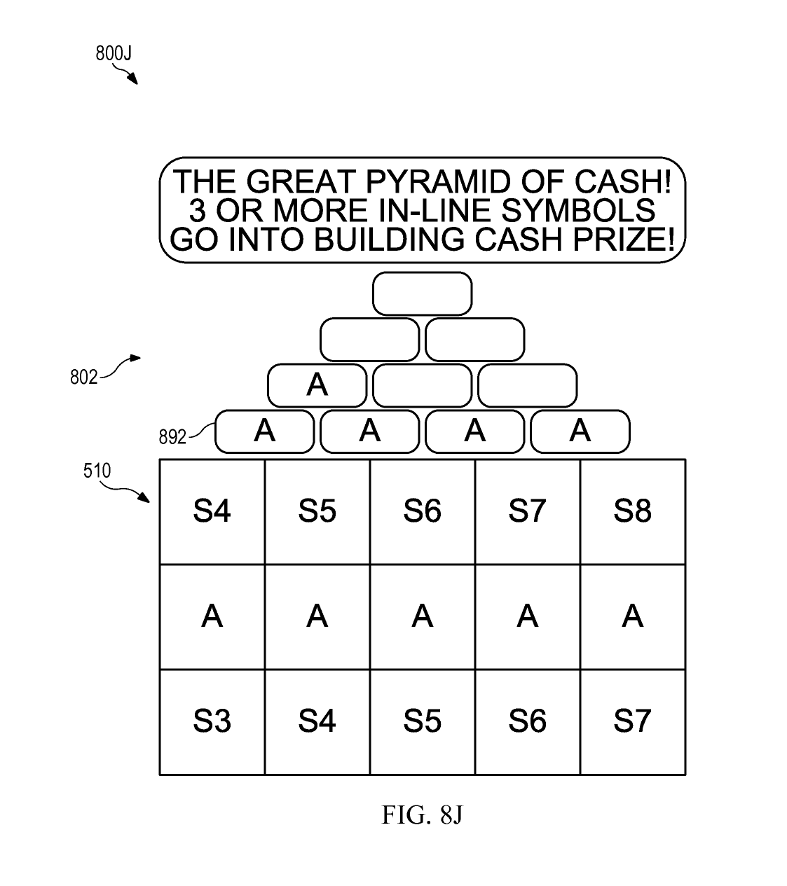

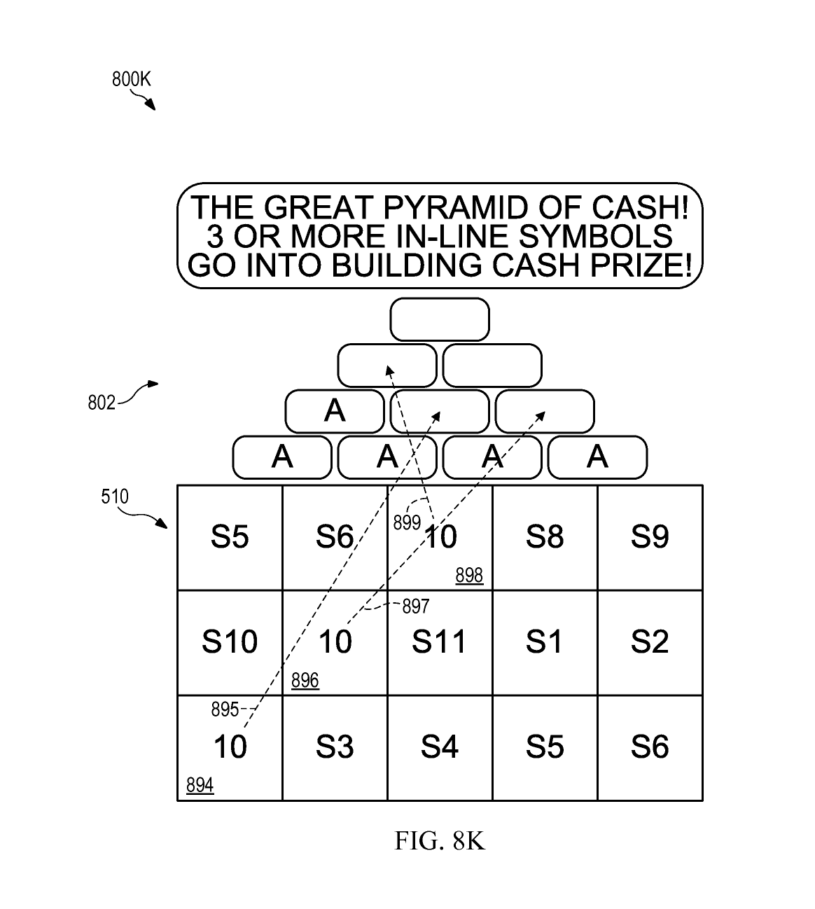

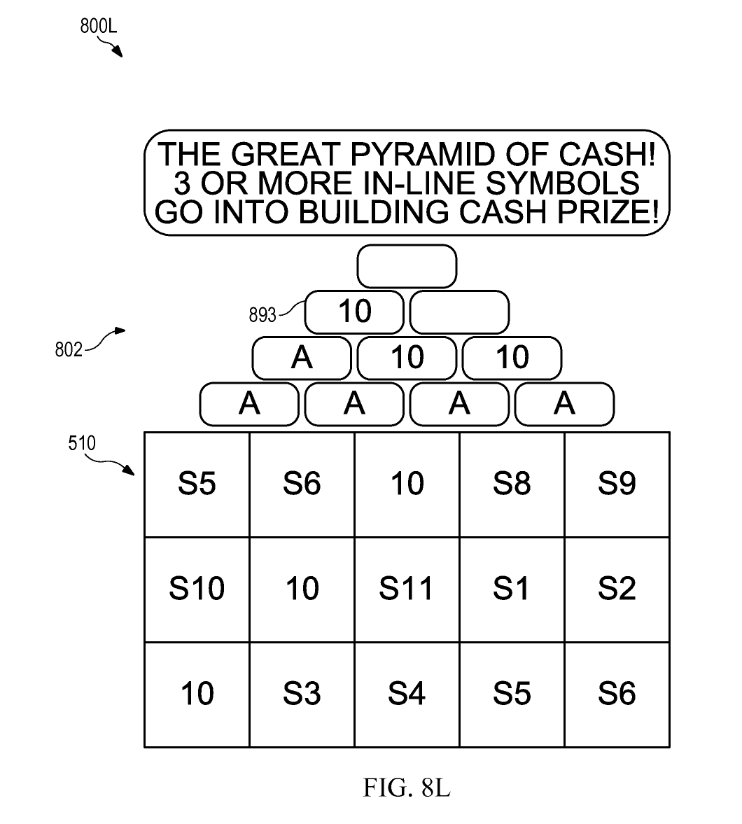

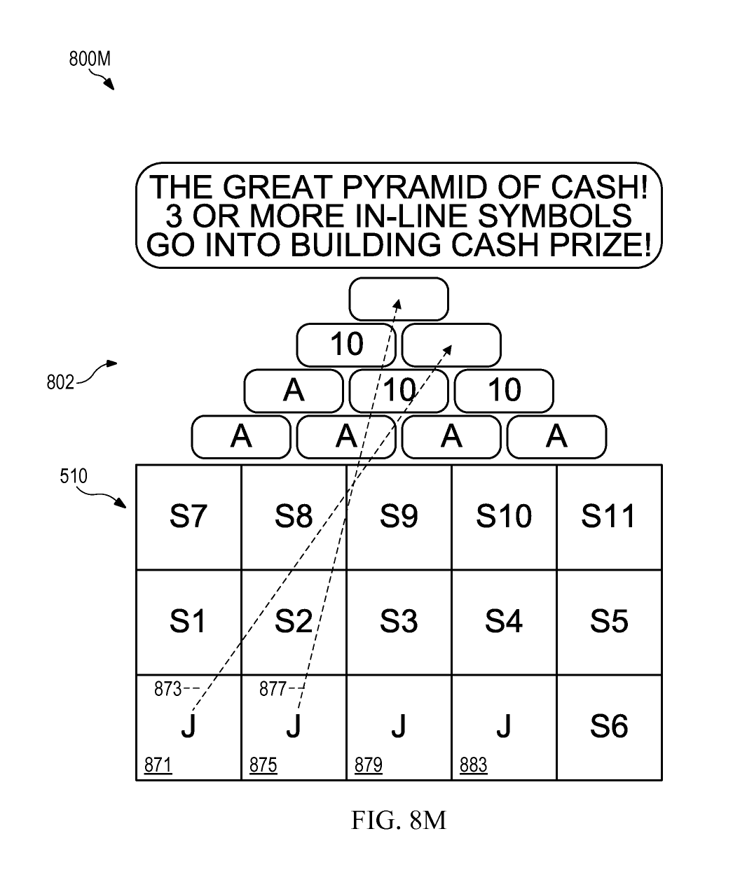

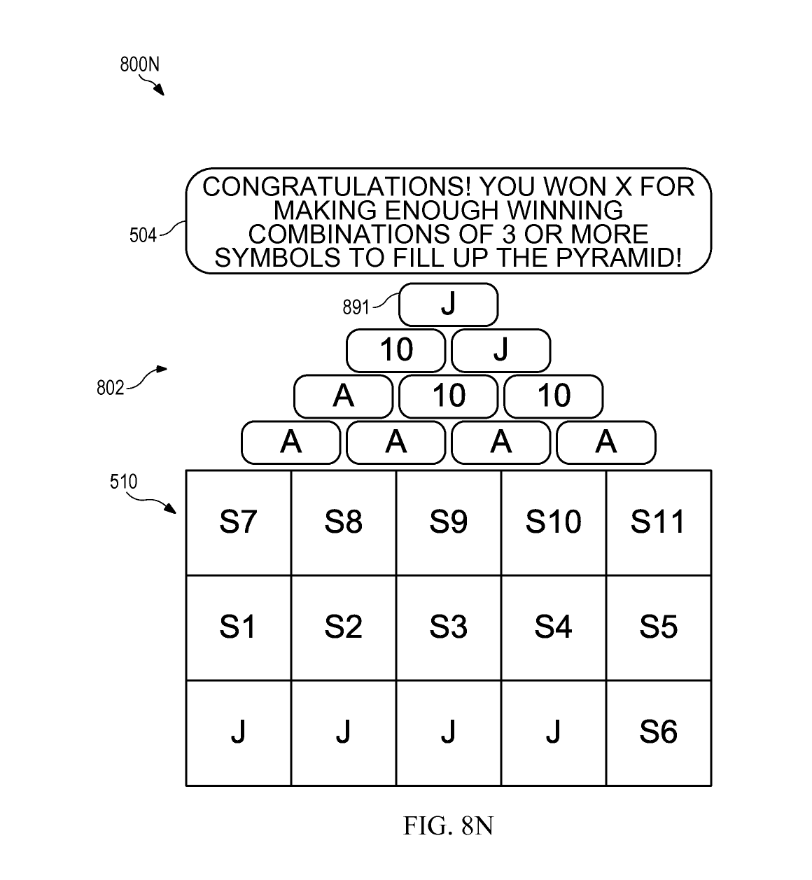

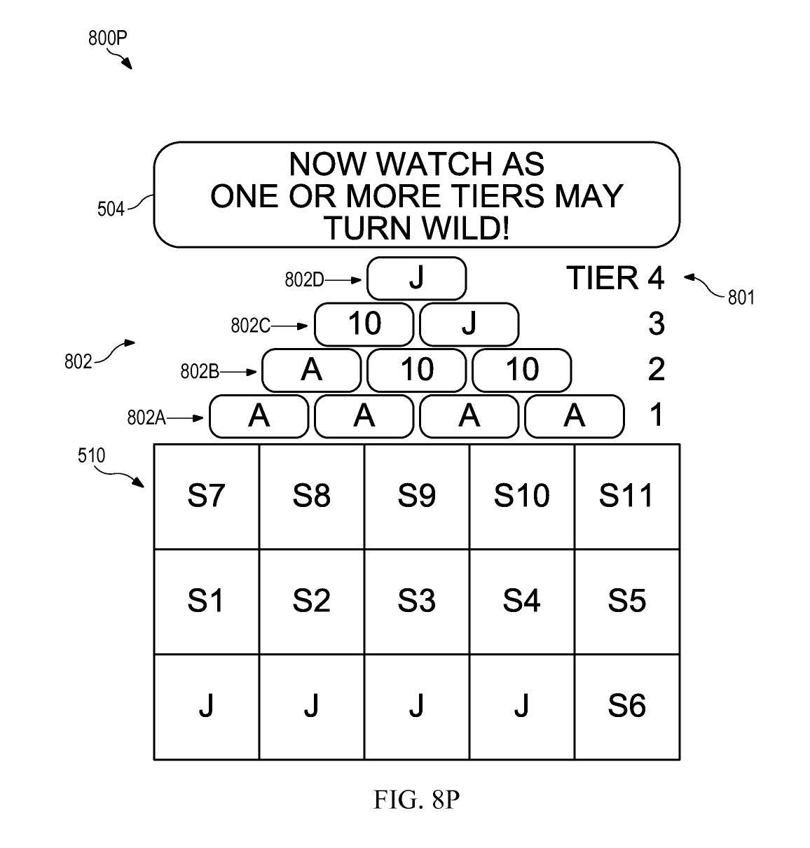

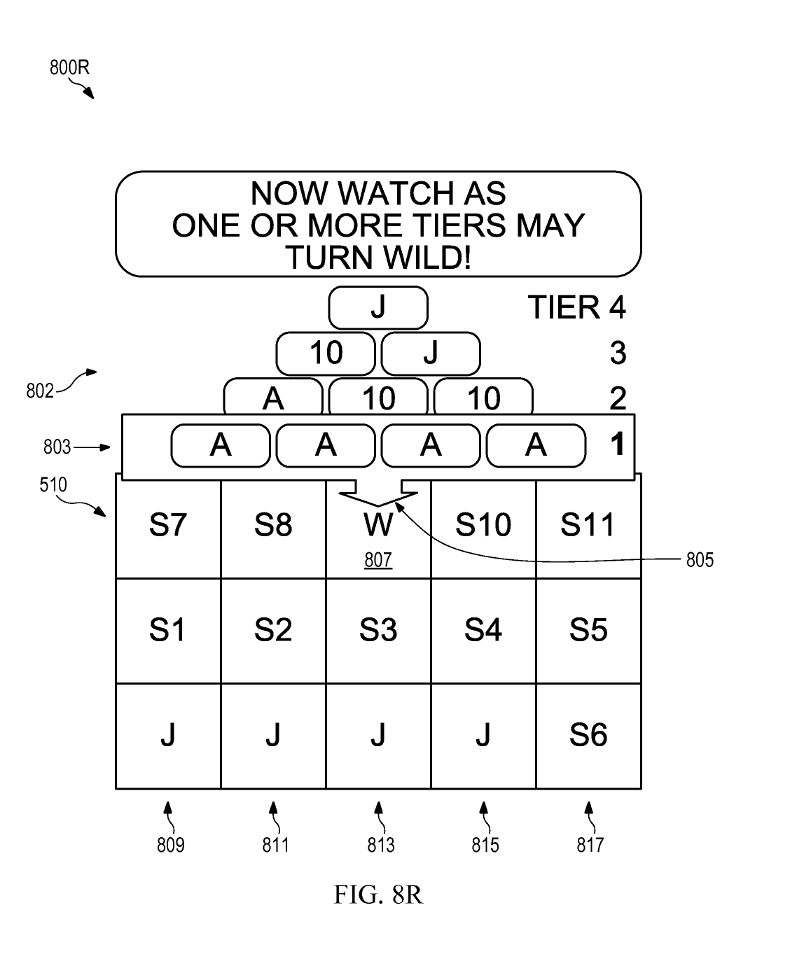

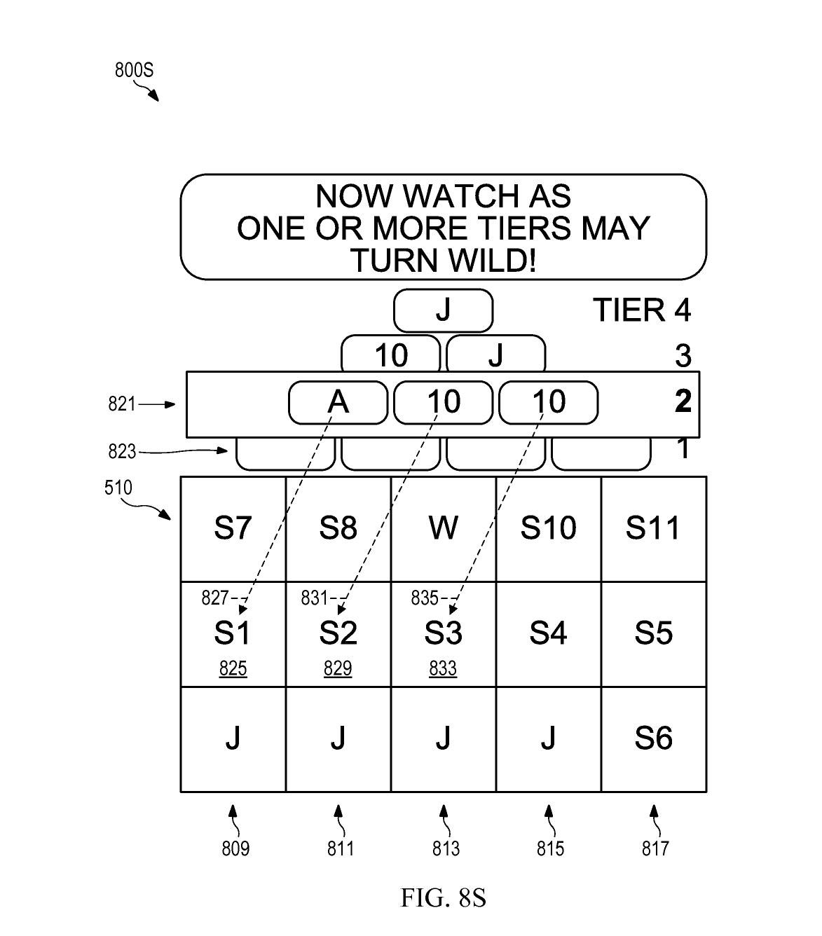

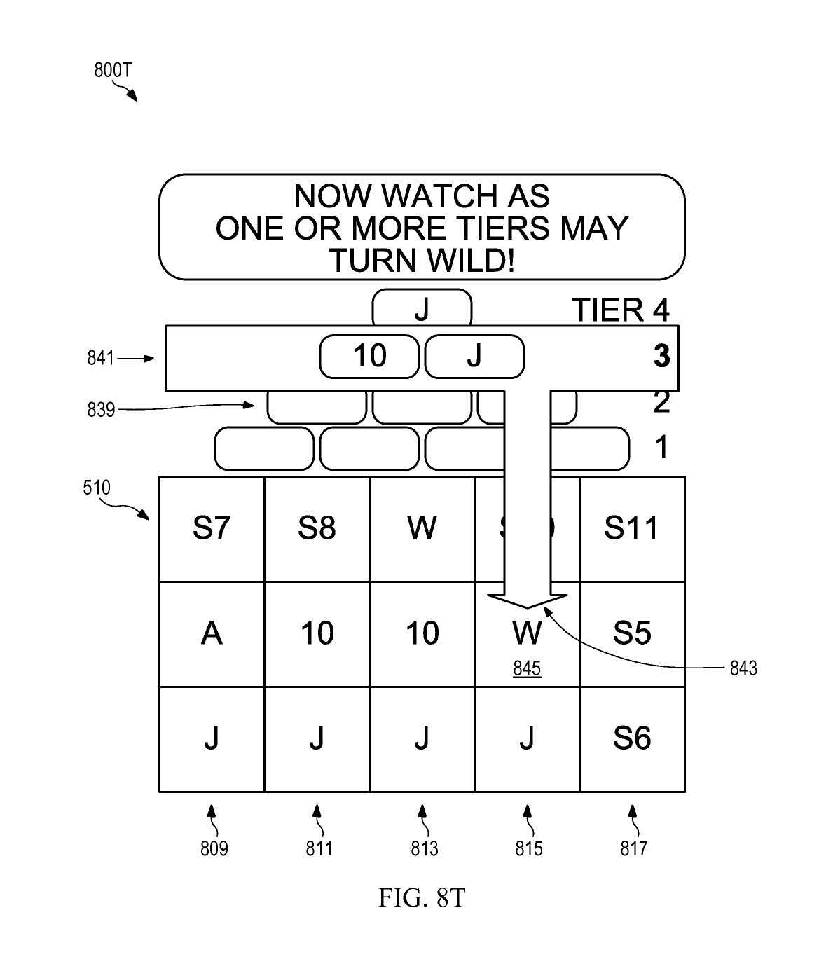

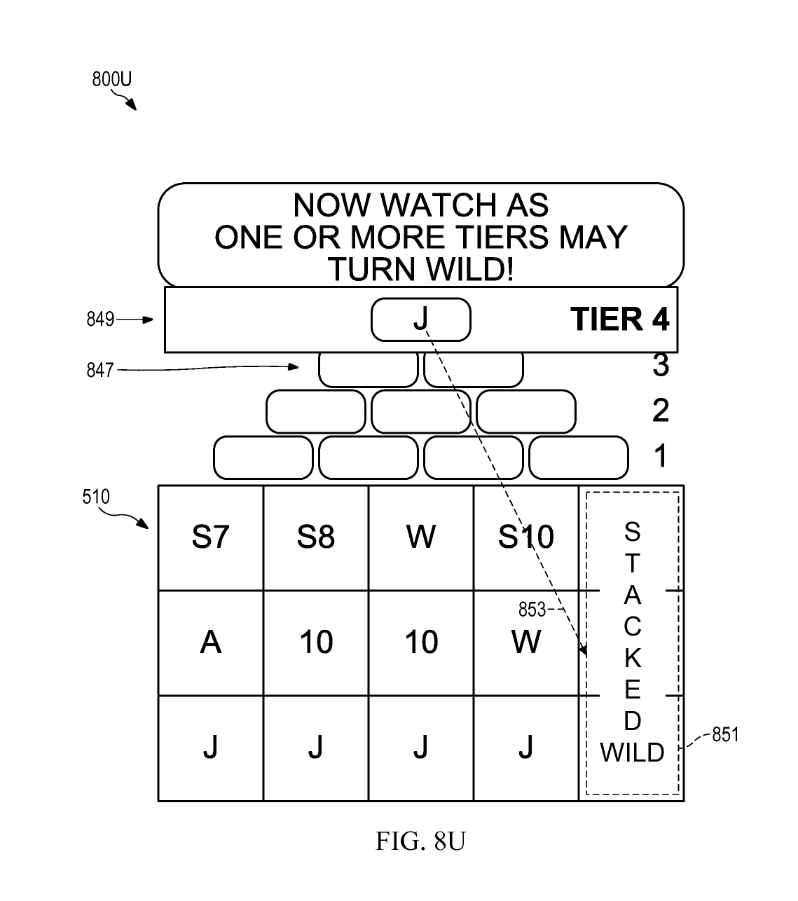

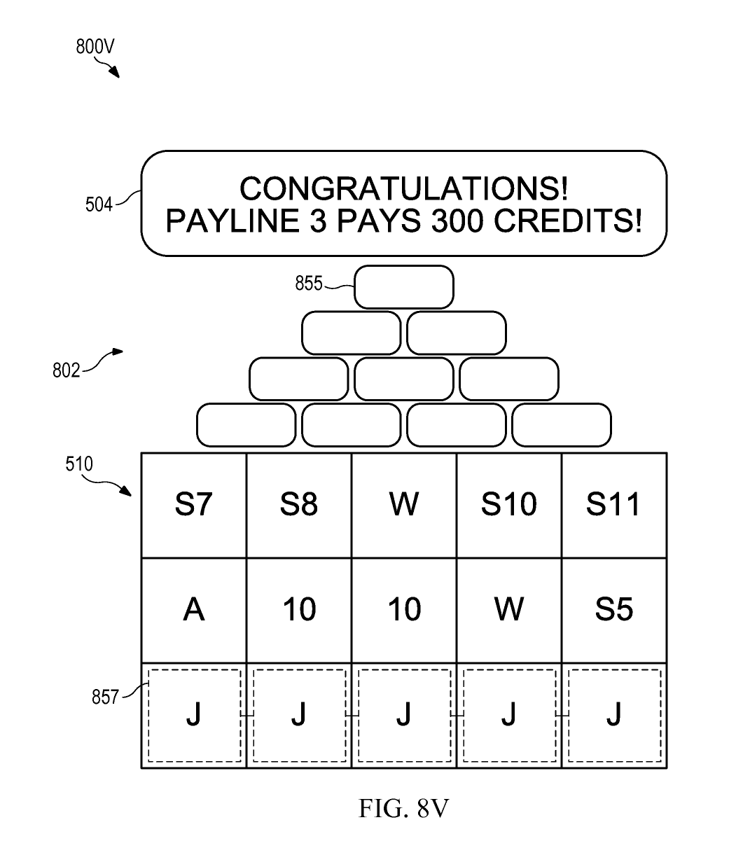

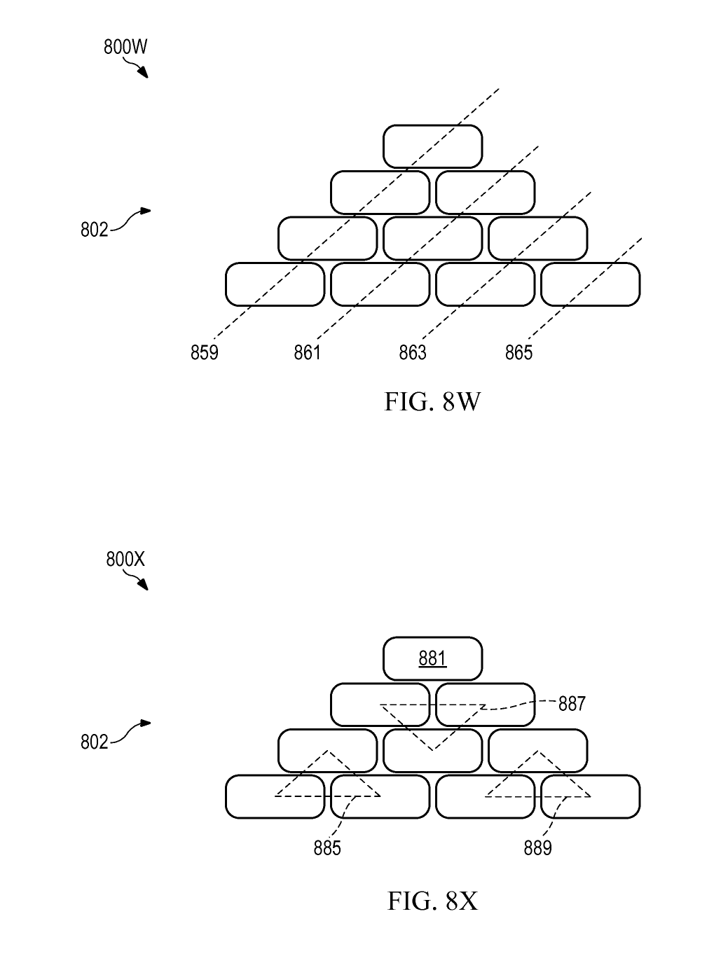

In FIG. 8A, another illustration of treasure spin game play on a gaming device is shown, according to one embodiment. A first image 800A may include message area 504, a collection zone 802, one or more collection holders 804, and one or more reels 510. In this example, to trigger the release and/or complete the collection gaming option five specific items (e.g., a royal flush) is required. In this example, the spin has generated a 10 of diamonds symbol 806 which has been moved via a first path 808 to a first collection holder 804A. In another spin shown in FIG. 8B, a Q (Queen) of diamonds symbol 812, and a K (King) of diamonds symbol 816 have been generated and moved via a second path 814 and a third path 818 to a third collection holder 804C and a fourth collection holder 804D, respectively. In an additional spin shown in FIG. 8C, a J (Jack) of diamonds symbol 822 and an A (Ace) of diamonds symbol 826 have been generated and moved via a fourth path 824 and a fifth path 828 to a second collection holder 804B and a fifth collection holder 804E, respectively. Since the player has completed the entire collection gaming option, the player has won a prize and/or trigger an event and/or generated one or more drop down symbols. In this example, the player has won 1000 credits for the royal flush (see FIG. 8D). A winning message 832 may state “CONGRATULATIONS! YOU GOT A ROYAL FLUSH IN DIAMONDS!”

In FIG. 8E, another illustration of treasure spin game play on a gaming device is shown, according to one embodiment. A second image 800E includes message area 504, a bingo ball draw area 834, one or more bingo ball draw placement areas 836, a bingo card 838, one or more bingo number areas 842, and one or more reels 510. In this example, various symbols (e.g., S4, S6, etc.) are displayed along with various bingo numbers (e.g., 51 reference number 844, 75 reference number 848, 5 reference number 846, 26 reference number 852, and 17 reference number 854). In various examples, the bingo numbers may be independent of the symbols and/or the bingo numbers may be related to the various symbols. Further, the symbols and bingo numbers may be in the same square. In other words, the bingo number 51 may be in the same square as symbol S4. In this example, five bingo numbers (e.g., 51 reference number 844, 75 reference number 848, 5 reference number 846, 26 reference number 852, and 17 reference number 854) were drawn. During a spin, any number (e.g., 0 to N) of bingo numbers and/or symbols may be displayed on the one or more reels 510. As seen in FIG. 8F, the bingo number 26 (e.g., reference number 852) and the bingo number 17 (e.g., reference number 854) are numbers on bingo card 838. Therefore, these bingo numbers (e.g., 26 and 17) are marked on bingo card 838. All of the drawn bingo number (e.g., 51 reference number 844, 75 reference number 848, 5 reference number 846, 26 reference number 852, and 17 reference number 854) may be displayed in one or more bingo ball draw placement areas 836.

During subsequent spins as seen in FIG. 8G, various bingo numbers (e.g., 25, 30, 1, 36, 27, 2, 48, 33, 56, 73, 18, 8, 40, 4, 54, 64, 3, 22, 14, 72, 55, 49, 59, 20, 61, 42, 44, and 35) were drawn. In this example, the player only needs either the bingo number 10 or 28 to complete 5 in a row which in this case is a BINGO. During the spin seen in FIG. 8G, the bingo number 28 (reference number 860) is drawn and the player achieves a BINGO. Message area 504 may state “YOU GOT BINGO! CONGRATULATIONS!”.

In FIG. 8H, another illustration of treasure spin game play on a gaming device is shown, according to one embodiment. A third image 800H may include message area 504, collection area 802, one or more collection spots 870 and one or more reels 510. In this example, the pyramid collection area is filled by obtaining winning combination that require at least three symbols were each winning symbol in a winning combination of 3 of more symbols (and/or any predetermined number of winning symbols (1−N)) is collected in one or more collection spots 870. In this example, the completed spin has generated a 5 aces winning combination. Therefore, a first collected symbol 872, a second collected symbol 876, a third collected symbol 880, a fourth collected symbol 884, and a fifth collected symbol 888 are moved to collection area 802 via a first path 874, a second path 878, a third path 882, a fourth path 886, and a fifth path 890 respectively. The 5 aces, collection symbols, and/or transformed symbols are located in collected spots 892 (see FIG. 8J).

In a subsequent spin seen in FIG. 8K, a 3 tens winning combination is generated. The 3 tens winning combination includes a sixth collected symbol 894, a seventh collected symbol 896, and an eighth collected symbol 898 which are moved into collection area 802 via a sixth path 895, a seventh path 897, and an eighth path 899, respectively. These 3 tens, collection symbols, and/or transformed symbols are located in collected spots 893 (see FIG. 8L)

In a subsequent spin seen in FIG. 8M, a 4 jacks winning combination is generated. The 4 jacks winning combination includes four symbols. However, only two symbols are required to fill the pyramid collection area. Therefore, in one example only two jacks are utilized. In another example, two jacks are utilized to complete the pyramid collection area and the remaining two jacks are banked for later utilization. In this example, a ninth collected symbol 871 and a tenth collected symbol 875 are moved into collection area 802 via a ninth path 873 and a tenth path 877. These 2 jacks, collection symbols, and/or transformed symbols are located in collected spots 891 (see FIG. 8N). Message area 504 may state “CONGRATULATIONS! YOU WON X FOR MAKING ENOUGH WINNING COMBINATIONS OF 3 OR MORE SYMBOLS TO FILL UP THE PYRAMID!”

In FIG. 8P, another illustration of treasure spin game play on a gaming device is shown, according to one embodiment. In this example, collection area 802 has one or more power tiers (e.g., a first power tier 802A, a second power tier 802B, a third power tier 802C, a fourth power tier 802D, an Nth power tier (not shown)). Further, a power tier level indicator 801 may be displayed. Message area 504 may indicate that one or more actions by the power tiers. Message area 504 may state “NOW WATCH AS ONE OR MORE TIERS MAY TURN WILD!”

In one example shown in FIG. 8R, first power tier 802A may transform the 4 collected symbols (e.g., 4 aces) into one or more wilds, scatters, and/or any other symbol. In this example, the 4 collected symbols has been transformed into a first wild 807. The gaming device may highlight a first transforming section 803.

In another example shown in FIG. 8S, second power tier 802B may transform the one collected ace and the two collected tens into a first symbol 825, a second symbol 829, and a third symbol 833. These symbols may be placed randomly and/or in optimal positions, and/or in a pattern (e.g., adjacent to each other, in a T shape, an L shape, etc.). Further, these symbols may be the actual collected symbols (e.g., one ace and two tens). The gaming device may highlight a second transforming section 821

In another example seen in FIG. 8T, the two collected symbols (e.g., a ten and a jack) may be transformed into a second wild 845. In one example, it only takes two collected symbols to generate a wild (as opposed to the four collected symbols in FIG. 8R) because a third power tier is higher than a first power tier.

In another example seen in FIG. 8U, the one collected symbol (e.g. a jack) may be transformed into a stacked wild 851 because of the four power tier ranking and/or the symbol that is in the power tier ranking. For example, an Ace in the four power tier may generate three stacked wilds. Whereas, a Queen and/or a King may generate two stacked wilds. Further, a Jack may only generate one stacked wild. In addition, a Ten may generate only two scatters. In another example shown in FIG. 8V, a jack in the four power tier may generate a five jack winning combination. Whereas, an Ace in the four power tier may generate a five Aces winning combination, etc.

In FIG. 8W, another illustration of treasure spin game play on a gaming device is shown, according to one embodiment. In various examples, the symbols collected in collection area 802 may be utilized to create a first winning combination 859, a second winning combination 861, a third winning combination 863, a fourth winning combination 865, and an Nth winning combination within collection area 802.

In FIG. 8X, another illustration of treasure spin game play on a gaming device is shown, according to one embodiment. In various examples, the symbols collected in collection area 802 may be utilized to create a fifth winning combination 885, a sixth winning combination 887, a seventh winning combination 889, and an Nth winning combination.

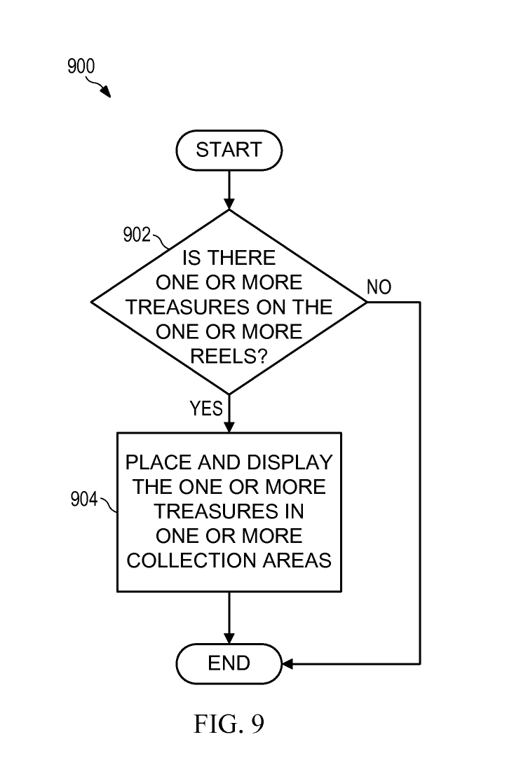

In FIG. 9, a game play flow diagram 900 is shown, according to one embodiment. The method may include one or more processors (e.g., via electronic gaming device 100 and/or electronic gaming system 200) determining whether there are one or more treasures on the one or more reels (step 902). If there are no treasures on the one or more reels, then the method may end. If there are treasures on the one or more reels, then the method may include placing and displaying the one or more treasures in the one or more collection areas (step 904).

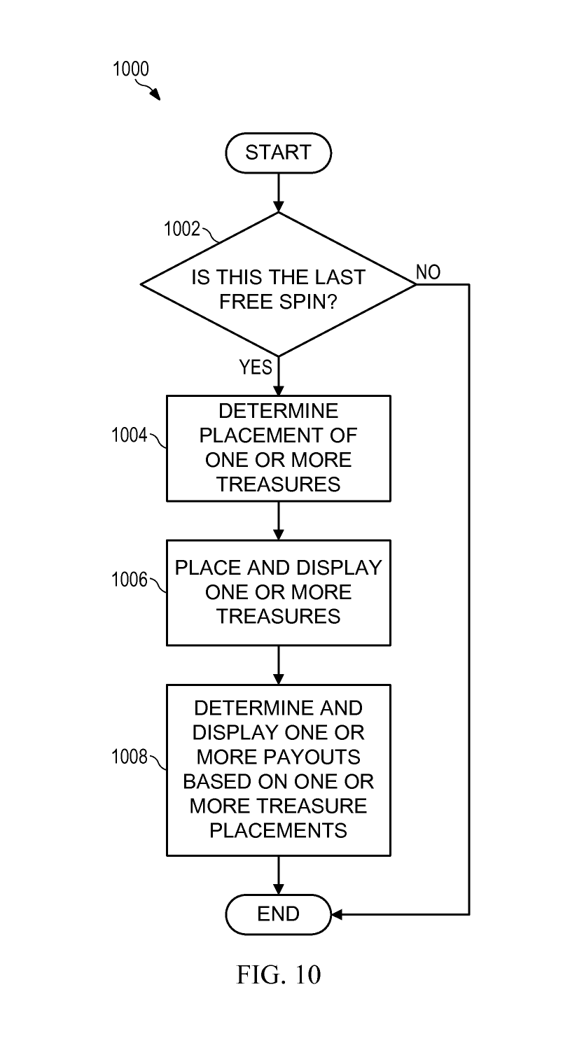

In FIG. 10, a flow diagram for game play 1000 is shown, according to one embodiment. The method may include one or more processors (e.g., via electronic gaming device 100 and/or electronic gaming system 200) determining whether the spin (e.g., current spin, last spin, etc.) is the last free spin (step 1002). If the spin was not the last free spin, then the method may end and/or go back to step 1002. If the spin was the last free spin, then the method may determine one or more placements for the one or more collected treasures (step 1004). The method may include placing and displaying one or more treasures (step 1006). The method may include determining and displaying one or more payouts based on one or more treasure placements (step 1008). In various examples discussed above, the triggering event may occur at any time (e.g., first spin, second spin, when a combination of symbols is achieved, the last spin, etc.).

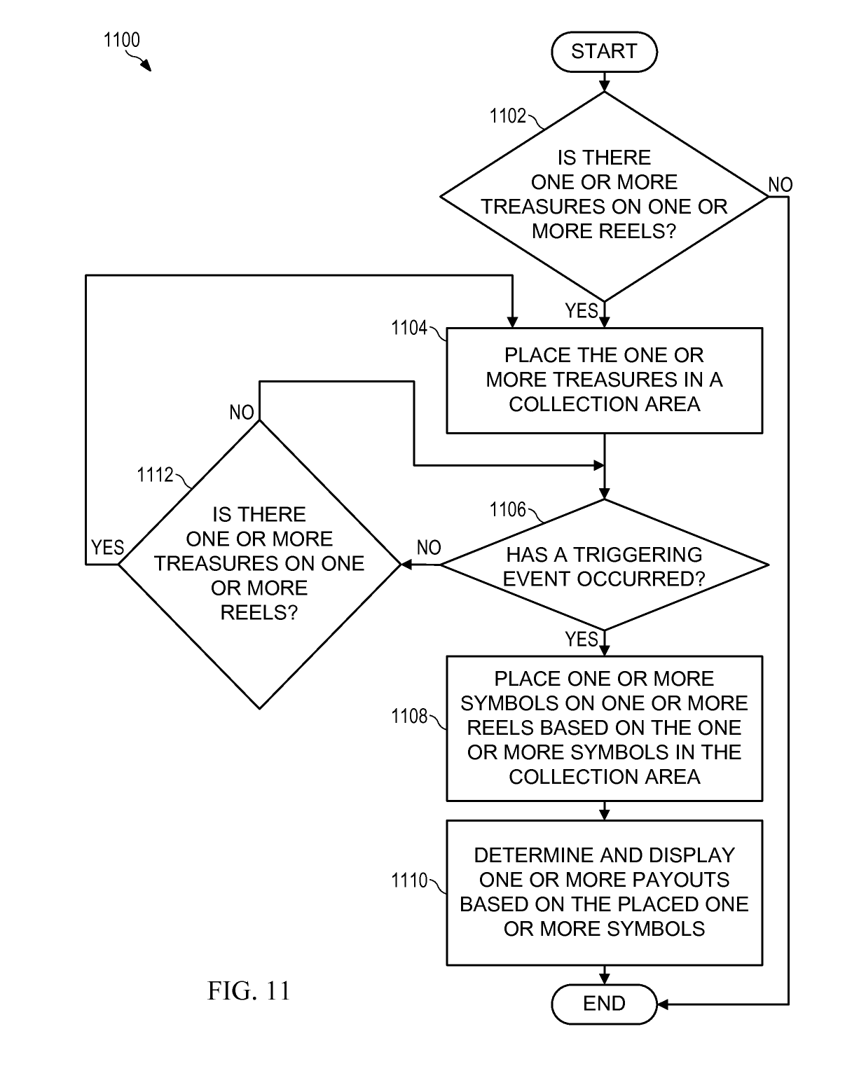

In FIG. 11, a flow diagram for game play 1100 is shown, according to one embodiment. The method may include one or more processors (e.g., via electronic gaming device 100 and/or electronic gaming system 200) determining whether there are one or more treasures on one or more reels (step 1102). If there are no treasures on one or more reels, then the method may end. If there are one or more treasures on one or more reels, then the method may place one or more treasures in a collection area (step 1104). The method may include one or more processors (e.g., via electronic gaming device 100 and/or electronic gaming system 200) determining whether one or more triggering events (e.g., first spin, Nth spin, a combination of symbols is achieved, a special symbol is obtained, the last free spin, etc.) have occurred (step 1106). If no triggering events have occurred, then the method may include one or more processors (e.g., via electronic gaming device 100 and/or electronic gaming system 200) determining whether there are one or more treasures on the one or more reels (step 1112). If there are no treasures on the one or more reels, then the method may return to step 1106. If there are one or more treasures on the one or more reels, then the method may return to step 1104. If one or more triggering events have occurred, then the method may place one or more symbols on one or more reels based on the one or more symbols in the collection area (step 1108). The method may include determining and displaying one or more payouts based on the placements of one or more symbols (step 1110).

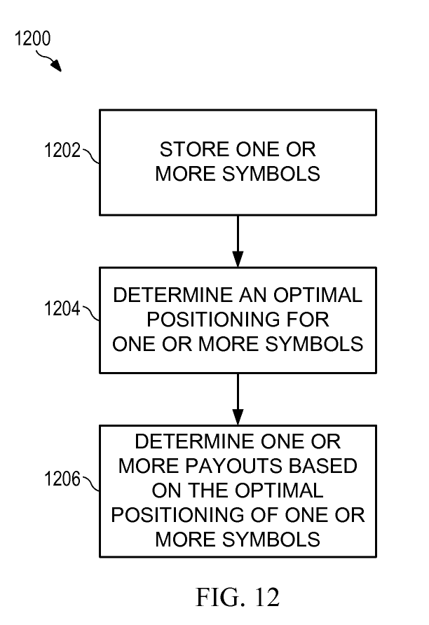

In FIG. 12, a flow diagram for game play 1200 is shown, according to one embodiment. The method may include storing one or more symbols (step 1202). The method may include determining an optimal positioning for one or more symbols (step 1204). The method may include determining one or more payouts based on the optimal positioning of one or more symbols (step 1206).

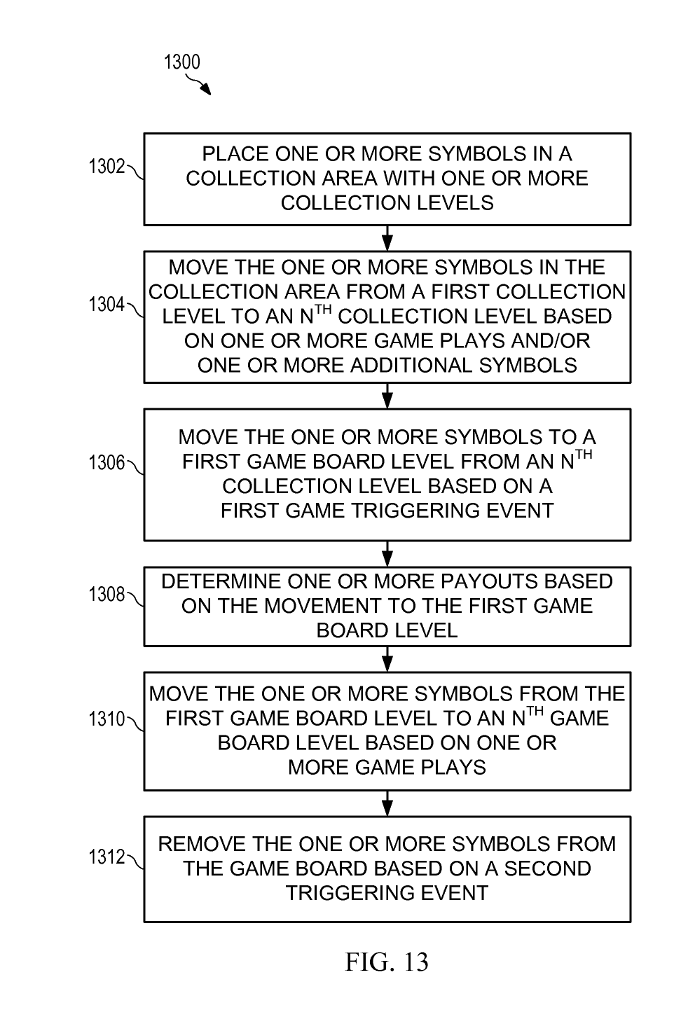

In FIG. 13, a flow diagram for game play 1300 is shown, according to one embodiment. The method may include placing one or more symbols in a collection area with one or more collection levels (step 1302). The method may include moving the one or more symbols in the collection area from a first collection level to an Nth collection level based on one or more game plays and/or one or more additional symbols (step 1304). The method may include moving the one or more symbols to a first game board level from an Nth collection level based on a first game triggering event (step 1306). The method may include determining one or more payouts based on the movement to the first game board level (step 1308). The method may include moving the one or more symbols from the first game board level to an Nth game board level based on one or more game plays (step 1310). The method may include removing the one or more symbols from the game board based on a second triggering event (step 1312).

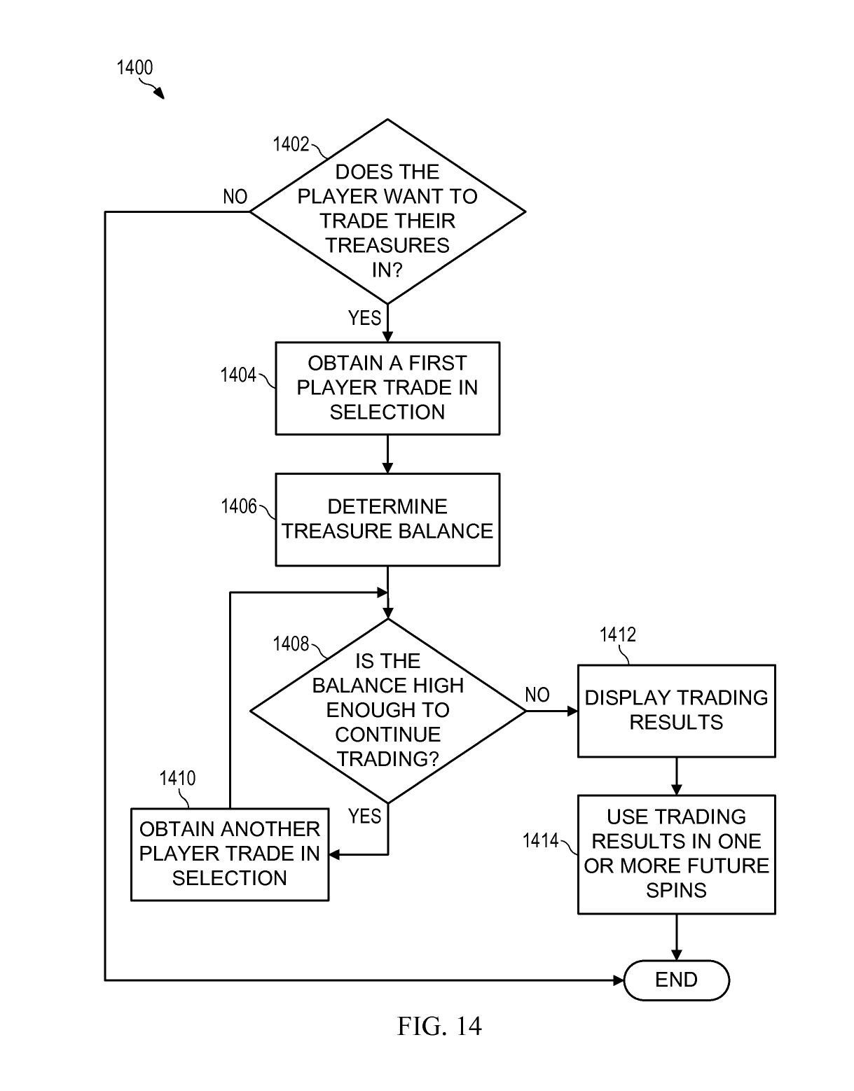

In FIG. 14, a flow diagram for game play 1400 is shown, according to one embodiment. The method may include one or more processors (e.g., via electronic gaming device 100 and/or electronic gaming system 200) determining whether the player wants to trade in their treasures (step 1402). If the player does not want to trade in their treasures, then the method may end. If the player wants to trade in their treasures, then the method may obtain a first player trade in selection (step 1404). The method may determine one or more treasure balances (step 1406). The method may one or more processors (e.g., via electronic gaming device 100 and/or electronic gaming system 200) determining whether the balance is high enough to continue trading (step 1408). If the balance is not high enough to continue trading, then the method may display the trading results (step 1412). The method may continue by using the trading results in one or more future spins (step 1414). If the balance is high enough to continue trading, then the method may obtain one or more additional player trade in selections (step 1410).

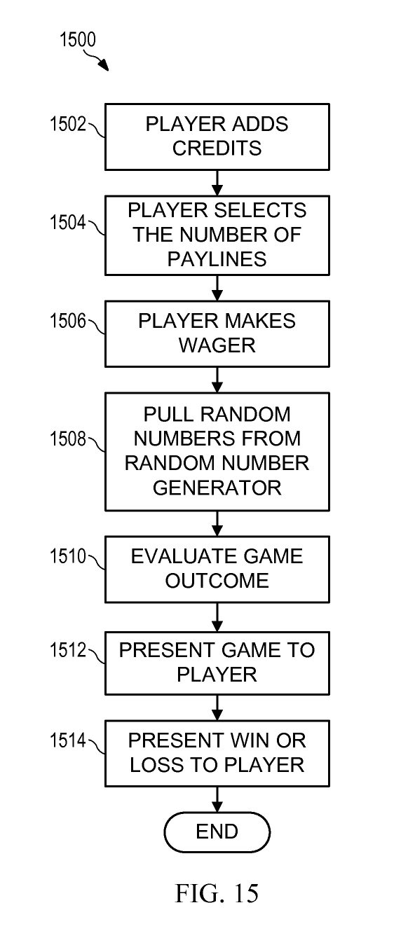

In FIG. 15, a process flowchart of one example of a primary game play 1500 on an electronic gaming system is shown, according to one embodiment. The method may include the step of a player adding credit to the electronic gaming system (step 1502). It is contemplated that a player can do this by inserting cash, coins, a ticket representative of a cash value, a credit card, a player card, requesting an electronic funds transfer (“EFT”), otherwise requesting access to an account having monetary funds, and/or any combination thereof.

At step 1504, the player selects the number of paylines to play. In one embodiment, the player can select from a plurality of different paylines to play. In a further embodiment, the player can only play a predetermined number of paylines. An example of this embodiment may be the instance where the gaming system only allows a player to play forty paylines, and cannot select to play more or less paylines. In another embodiment, the gaming system does not offer paylines, but rather offers a different way to evaluate the game play. One example of a different way may be sometime referred to as a 243-ways evaluation, where symbols may be evaluated based on the existence of like-symbol clusters on adjacent reels, starting with the left-most reel and continuing right, instead of how many paylines run through the like-symbol clusters.

At step 1506, the player makes a wager on the game. In one embodiment, the wager may be a multiple of the number of paylines selected at step 1504. In another embodiment, the wager may not be a multiple of the number of paylines selected at step 1504. In a further embodiment, the wager may include a side-wager (e.g., ante bet), which may, in one example of such an embodiment, be used to make the player eligible to be awarded the extra functionality discussed above. It should be appreciated that in some embodiments, the order of steps 1504 and 1506 may be not critical, and so for example, a player can select the wager they wish to place, and then select the number of paylines they want it applied to, and that these embodiments are expressly contemplated as being within the scope of the present disclosure.

Continuing to step 1508, the gaming system pulls random numbers from a random number generator (“RNG”). In one embodiment, the system pulls one random number for each reel. In another embodiment, the system pulls one random number which may be utilized to determine the stop positions for each reel. In another embodiment, the random numbers determined by the RNG may be based on the time that the numbers may be pulled. In another embodiment, the random numbers determined by the RNG may be based on the prior numbers pulled.

At steps 1510 and 1512, the gaming system utilizes the random numbers pulled at step 1508 to determine the primary game symbols to display in the play of the primary game, which in turn both determines the presentation of the game to the player and evaluates the game outcome. In one embodiment, the random numbers pulled determine the stopping positions for the reels, which may be then caused to stop at those associated positions, and then the gaming system evaluates the displayed primary game symbols to determine the game outcome. In another embodiment, the gaming system determines the game outcome based on the pulled random numbers, and then causes the game to present an associated outcome to the player.

At step 1514, the win or loss outcome may be identified for the player. In one embodiment, this step can include additional messaging, which provides information related to the win or loss, such as why the player won or lost. In another embodiment, this step can include identification of the amount of any award earned by the player.

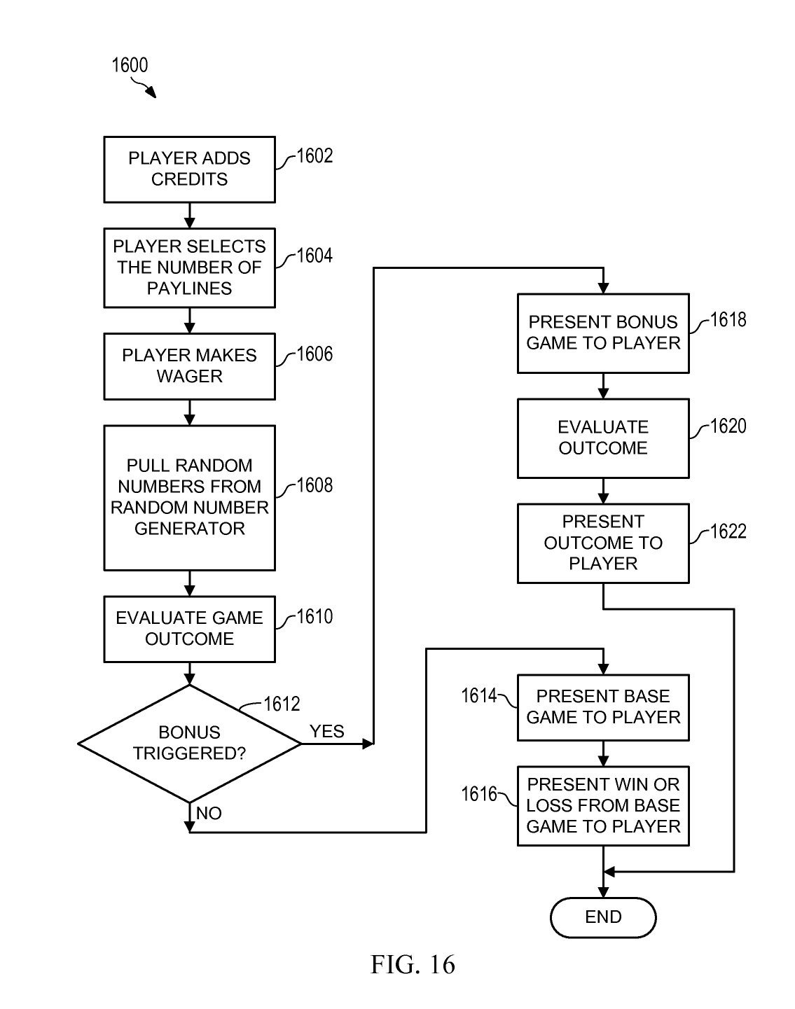

FIG. 16 is a process flowchart of one example of a combined primary and secondary game play 1600 on an electronic gaming system, according to one embodiment. The method may include the step of a player adding credit to the electronic gaming system (step 1602). It is contemplated that a player can do this by inserting cash, coins, a ticket representative of a cash value, a credit card, a player card, requesting an electronic funds transfer (“EFT”), otherwise requesting access to an account having monetary funds, and/or any combination thereof.

At step 1604, the player selects the number of paylines to play. In one embodiment, the player can select from a plurality of different paylines to play. In a further embodiment, the player can only play a predetermined number of paylines. An example of this embodiment may be the instance where the gaming system only allows a player to play forty paylines, and cannot select to play more or less paylines. In another embodiment, the gaming system does not offer paylines, but rather offers a different way to evaluate the game play. One example of a different way may be sometime referred to as a 243-ways evaluation, where symbols may be evaluated based on the existence of like-symbol clusters on adjacent reels, starting with the left-most reel and continuing right, instead of how many paylines run through the like-symbol clusters.

At step 1606, the player makes a wager on the game. In one embodiment, the wager may be a multiple of the number of paylines selected at step 1604. In another embodiment, the wager may not be a multiple of the number of paylines selected at step 1604. In a further embodiment, the wager may include a side-wager, which may, in one example of such an embodiment, be used to make the player eligible to be awarded the extra functionality discussed above. It should be appreciated that in some embodiments, the order of steps 1604 and 1606 may be not critical, and so for example, a player can select the wager they wish to place, and then select the number of paylines they want it applied to, and that these embodiments may be expressly contemplated as being within the scope of the present disclosure.

Continuing to step 1608, the gaming system pulls random numbers from a random number generator “RNG”. In one embodiment, the system pulls one random number for each reel. In another embodiment, the system pulls one random number which may be utilized to determine the stop positions for each reel. In another embodiment, the random numbers determined by the RNG may be based on the time that the numbers may be pulled. In another embodiment, the random numbers determined by the RNG may be based on the prior numbers pulled.

At step 1610, the gaming system utilizes the random numbers pulled at step 1608 to evaluate the game outcome. In one embodiment, the random numbers pulled determine the stopping positions for the reels, which may be then caused to stop at those associated positions, and then the gaming system evaluates the displayed primary game symbols to determine the game outcome. In another embodiment, the gaming system determines the game outcome based on the pulled random numbers, and then causes the game to present an associated outcome to the player.

At step 1612, the gaming system determines if a secondary or bonus game may be triggered. In one embodiment, the bonus game is triggered by the display of a plurality of matching symbols at a plurality of predetermined symbol positions within a play of the primary game. In one example, the bonus game may be triggered if a plurality of matching symbols is displayed on the 2^{nd}, 3^{rd} and 4^{th} reel. In another example, the bonus game may be triggered if matching symbols are displayed on the 1^{st}, 2^{nd} and 3^{rd} reels. In a further example, the bonus game may be triggered if matching symbols occur at predetermined symbol positions that include consecutive and non-consecutive reels. In another example, a bonus game (e.g., secondary game) may be triggered in any way (e.g., one special symbols in any locations, one special symbol in one or more predetermined locations, two special symbols in any locations, two special symbols in one or more predetermined locations, three special symbols in any locations, three special symbols in one or more predetermined locations, etc.).

If it is determined that a bonus or secondary game was not triggered, the process continues to step 1614, where the base game may be fully presented to the player. As discussed above, the orders of step 1610, 1612, and 1614 can be changed without affecting the novel concepts disclosed herein.

At step 1616, the win or loss outcome of the primary game may be identified for the player. In one embodiment, this step can include additional messaging, which provides information related to the win or loss, such as why the player won or lost. In another embodiment, this step can include identification of the amount of any award earned by the player

If it is determined at step 1612 that a bonus or secondary game was triggered, then process 1600 continues to step 1618, where the secondary game may be presented to the player. As discussed above, there are numerous ways to present the secondary or bonus game to the player.

At steps 1620 and 1622, the outcome of the secondary game may be evaluated and presented to the player. In one embodiment, the outcome of the bonus game will always be a winning outcome. In another embodiment, the outcome of the secondary game will cause a significant award to be provided to the player. In one example of such an embodiment, the award may not be provided by the gaming system, as a casino operator may need to verify tax information before allowing such an award to be provided to the player. In one embodiment, instead of the process 1600 ending after step 1622, the process continues to step 1614 so as to finalize the primary game outcome presentation to the player.

One or more sensors may obtain and/or transmit one or more data points (e.g., positional data, temperature data, etc.) relating to one or more audio devices, one or more display devices, audio interface area, audio support area, audio locking device, one or more electrical attachment devices, one or more attachment areas, electronic gaming device 100, electronic gaming system 200, first audio device, wall of the audio installation area, back of the audio installation area, one or more audio interfaces, one or more electrical attachment points, an input area, one or more input devices, second audio device, front-mounted audio device, audio interface locked area, one or more electrical interconnection points, one or more electrical wires, one or more springs, one or more motors, one or more adjustable devices, and/or one or more sensors to one or more processors.

One or more sensors may obtain and/or transmit one or more data points (e.g., positional data, temperature data, etc.) relating to one or more audio devices, one or more display devices, one or more electrical wires, one or more springs, one or more motors, one or more adjustable devices, and/or one or more sensors to one or more processors.

In one embodiment, the electronic gaming device may include a plurality of reels. The one or more paylines may be formed on at least a portion of the plurality of reels. The electronic gaming device may include a memory.

In one embodiment, the electronic gaming device may include a plurality of reels. The plurality of reels may include one or more areas. The electronic gaming device may include a processor and a memory. The memory may include one or more treasure spin feature structures. The processor may generate one or more symbols to be located in the one or more areas. The processor may move a first treasure spin to a first replacement location based on the first replacement location having a top award amount.

In another example, the processor may initiate a base game, a bonus game, and a treasure spin game. In another example, the processor may store one or more collectable symbols in a collection area. The processor may display a collected symbol in the collection area based on the one or more stored collectable symbols, according to one embodiment. In another example, the processor may move the collected symbol to a second location in the collection area based on a first spin event. In one example, the processor may move the collected symbol to a third location in the collection area based on a second spin event. In an example, the processor may move the collected symbol to an active area and modify the collected symbol into an active symbol based on one or more triggering events. In another example, the one or more triggering events may be based at least on the collection area being full. In one example, the one or more triggering events may be based on a generation of a random number.

In another embodiment, the method of providing game play via an electronic gaming device may include: initiating via one or more processors a base game; initiating via the one or more processors a treasure spin game; and/or moving via the one or more processors one or more treasure spins to one or more replacement locations.

In another example, the method may include storing one or more collectable symbols in a collection area. In one example, the method may include displaying a collected symbol in the collection area based on the one or more stored collectable symbols. In another example, the method may include moving the collected symbol to a second location in the collection area based on a first spin event. The method may include moving the collected symbol to a third location in the collection area based on a second spin event, according to one embodiment. In another example, the method may include moving the collected symbol to an active area and modify the collected symbol into an active symbol based on one or more triggering events. The one or more triggering events may be based at least on the collection area being full.

In another embodiment, the electronic gaming system may include a server which includes a server processor and a server memory. The electronic gaming system may include a display device including a plurality of reels, where the plurality of reels includes one or more areas. The server memory may include one or more treasure spin feature structures. The server processor may move a first treasure spin to a first replacement location based on the first replacement location having a top award amount.

In another example, the server processor may initiate a base game, a bonus game, and a treasure spin game. In another example, the server processor may store one or more collectable symbols in a collection area. In one example, the server processor may display a collected symbol in the collection area based on the one or more stored collectable symbols.

In one embodiment, the electronic gaming device may include a plurality of reels. The plurality of reels includes one or more areas. The electronic gaming device includes a memory where the memory includes one or more treasure spin feature structures. The electronic gaming device includes a processor which may generate one or more symbols to be located in the one or more areas. The processor may generate a first treasure symbol and move the first treasure symbol to a collection area, where the first treasure symbol has an equity value.

In another example, the equity value may be redeemable by a player. Further, the processor may initiate a treasure spin gaming type in a base game mode, a bonus game mode, and/or a tournament game mode. In addition, the processor may allow a player to trade in a first treasure symbol for one or more gaming features. In another example, the one or more gaming features may include a stacked wild, a wild, a scatter, a stacked symbol, a treasure symbol, a stacked treasure symbol, a payout modification, a replacement symbol, and/or any other gaming feature and/or any combination thereof. In another example, the processor may move one or more collected treasure symbols to one or more active reel areas. Further, the processor may move one or more placed symbols to one or more active reel areas based on a subsequent spin. In another example, the processor may transform the one or more collected treasure symbols into one or more transformed symbols based on moving the one or more collected treasure symbols to one or more active reel areas, where the one or more transformed symbols are different than the one or more collected treasure symbols.

In another embodiment, a method of providing game play via an electronic gaming device may include: initiating via one or more processors a base game; initiating via the one or more processors a treasure spin game; and/or moving via the one or more processors one or more treasure symbols to one or more replacement locations.

Further, the method may include: storing one or more collectable symbols in a collection area; displaying a collected symbol in the collection area based on the one or more stored collectable symbols; moving the collected symbol to a second location in the collection area based on a first spin event; moving the collected symbol to a third location in the collection area based on a second spin event; and/or moving the collected symbol to an active area and modify the collected symbol into an active symbol based on one or more triggering events. The one or more triggering events may be based at least on the collection area being full.

In another embodiment, the electronic gaming system may include a server which includes a server processor and a server memory and a display device which includes a plurality of reels. The plurality of reels may include one or more areas. The server memory may include one or more treasure spin feature structures and the server processor may generate a first treasure symbol and move the first treasure symbol to a collection area, where the first treasure symbol has an equity value.

In another example, the server processor may initiate a base game, a bonus game, and/or a treasure spin game. Further, the server processor may store one or more collectable symbols in a collection area. In addition, the server processor may display a collected symbol in the collection area based on the one or more stored collectable symbols. In another example, the equity value has a cash value.

In another example, during the free spin, in addition to getting the standard line wins, the player may be able to collect treasure items. The collection method may vary by game or theme, but may include: symbol collection; win collection (e.g., 3 of a kind of a certain special symbol), collection of various bingo patterns (e.g., either class II and/or class III), and/or the collection of ranks or suits in video poker games. For the last bonus spin, the items collected may be exchanged for features, bonuses, or add-ons that increase the theoretical return percentage to the player. Thus the collection method gives the player equity that is redeemed on the last spin and/or any other spin. Some examples of what the player may redeem include: standard wilds; expanding wilds; stacked wilds; all win multipliers (e.g., 2× to Nth×), scatter pay, etc. In the examples cases, treasure may refer to the player-built equity that was collected during all free spins (and/or any other spin). This collection mechanism for player equity may be any of the ideas listed (e.g., symbol collection, win collection, etc.).

In another example, during the free spins, all the treasures collected are tallied on the top of the screen (and/or anywhere else—bottom, side, etc.) at the last spin (and/or any other spin) the items are randomly placed on the active screen by special characters (e.g., fairies, etc.). In another example, the player may sell his treasures for special bonus add-ons. A diamond may represent a stacked wild and an emerald could be an expanding wild, etc. In another example, during the free spins (and/or any other spins), treasures may be collected on top of each reels. In one example, collected treasures may globally affect all the reels (e.g., all wins multiplier, etc.). At the last spin, the treasures collected may be converted into one or more features. In another example, during a free spin (and/or any other spin), treasures may be collected within a tally. A different or the same amount of treasures may be needed to fill each tally. At the last spin (and/or any other spin), the tally with all the position filled may activate one or more special features.

In another example, 802 is a collection area including one or more collection areas 802A, 802B, 802C, and 802D. The characteristics of collection area 802 as a whole may be different from the characteristics of collection areas 802A, 802B, 802C, and 802D. Further, the characteristics of 802A, 802B, 802C, and 802D may be differ amongst themselves. Further, in FIG. 8R, tier 1 (or 802A) may be converted its symbols into a wild 807 which may drop in columns 809-817 (reels 1-5); in this case the middle column is targeted. Unlike 606, 612, and 614 which targeted a specific fixed column, in this embodiment the column affect may be dynamically chosen at run time.

In another example, in FIG. 8S, tier 2 is not converted into a wild; rather a one-to-one substitution is performed (as in FIGS. 5G-L). In this case, a row-to-row/left-to-right substitution is completed but this need not be the case in all embodiments. In another example in FIG. 8T, shows another conversion to a wild on an offset column (e.g., offset from its center point). In another example shown in FIGS. 8W and 8X, a nested collection area with diagonal winning collection areas and triangular winning collection areas are described.

Gaming system may be a “state-based” system. A state-based system stores and maintains the system's current state in a non-volatile memory. Therefore, if a power failure or other malfunction occurs, the gaming system will return to the gaming system's state before the power failure or other malfunction occurred when the gaming system is powered up.

State-based gaming systems may have various functions (e.g., wagering, payline selections, reel selections, game play, bonus game play, evaluation of game play, game play result, steps of graphical representations, etc.) of the game. Each function may define a state. Further, the gaming system may store game histories, which may be utilized to reconstruct previous game plays.

A state-based system is different than a Personal Computer (“PC”) because a PC is not a state-based machine. A state-based system has different software and hardware design requirements as compared to a PC system.

The gaming system may include random number generators, authentication procedures, authentication keys, and operating system kernels. These devices, modules, software, and/or procedures may allow a gaming authority to track, verify, supervise, and manage the gaming system's codes and data.

A gaming system may include state-based software architecture, state-based supporting hardware, watchdog timers, voltage monitoring systems, trust memory, gaming system designed communication interfaces, and security monitoring.

For regulatory purposes, the gaming system may be designed to prevent the gaming system's owner from misusing (e.g., cheating) via the gaming system. The gaming system may be designed to be static and monolithic.

In one example, the instructions coded in the gaming system are non-changeable (e.g., static) and are approved by a gaming authority and installation of the codes are supervised by the gaming authority. Any change in the system may require approval from the gaming authority. Further, a gaming system may have a procedure/device to validate the code and prevent the code from being utilized if the code is invalid. The hardware and software configurations are designed to comply with the gaming authorities' requirements.

As used herein, the term “mobile device” refers to a device that may from time to time have a position that changes. Such changes in position may comprise of changes to direction, distance, and/or orientation. In particular examples, a mobile device may comprise of a cellular telephone, wireless communication device, user equipment, laptop computer, other personal communication system (“PCS”) device, personal digital assistant (“PDA”), personal audio device (“PAD”), portable navigational device, or other portable communication device. A mobile device may also comprise of a processor or computing platform adapted to perform functions controlled by machine-readable instructions.

The methods and/or methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or a special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the arts to convey the substance of their work to others skilled in the art. An algorithm is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Reference throughout this specification to “one example,” “an example,” “embodiment,” and/or “another example” should be considered to mean that the particular features, structures, or characteristics may be combined in one or more examples.

While there has been illustrated and described what are presently considered to be example features, it will be understood by those skilled in the art that various other modifications may be made, and equivalents may be substituted, without departing from the disclosed subject matter. Additionally, many modifications may be made to adapt a particular situation to the teachings of the disclosed subject matter without departing from the central concept described herein. Therefore, it is intended that the disclosed subject matter not be limited to the particular examples disclosed. Further, one or more gaming options may be Internet based gaming options. Therefore, all of the examples and/or embodiments may be utilized via an Internet based gaming system.

1. An electronic gaming device comprising:
a plurality of reels, the plurality of reels including one or more areas;
a memory, the memory including one or more treasure spin feature structures;
a processor configured to generate one or more symbols to be located in the one or more areas, the processor configured to generate a first treasure symbol and move the first treasure symbol to a collection area, where the first treasure symbol has an equity value.

2. The electronic gaming device of claim 1, wherein the equity value is redeemable by a player.

3. The electronic gaming device of claim 1, wherein the processor is further configured to initiate a treasure spin gaming type in a base game mode, a bonus game mode, and a tournament game mode.

4. The electronic gaming device of claim 1, wherein the processor is further configured to allow a player to trade in a first treasure symbol for one or more gaming features.

5. The electronic gaming device of claim 4, wherein the one or more gaming features include at least one of a stacked wild, a wild, a scatter, a stacked symbol, a treasure symbol, a stacked treasure symbol, a payout modification, and a replacement symbol.

6. The electronic gaming device of claim 1, wherein the processor is further configured to move one or more collected treasure symbols to one or more active reel areas.

7. The electronic gaming device of claim 6, wherein the processor is further configured to move one or more placed symbols to one or more active reel areas based on a subsequent spin.

8. The electronic gaming device of claim 6, wherein the processor is further configured to transform the one or more collected treasure symbols into one or more transformed symbols based on moving the one or more collected treasure symbols to one or more active reel areas, where the one or more transformed symbols are different than the one or more collected treasure symbols.

9. A method of providing game play via an electronic gaming device comprising:
initiating via one or more processors a base game;
initiating via the one or more processors a treasure spin game; and
moving via the one or more processors one or more treasure symbols to one or more replacement locations.

10. The method of claim 9, further comprising storing one or more collectable symbols in a collection area.

11. The method of claim 10, further comprising displaying a collected symbol in the collection area based on the one or more stored collectable symbols.

12. The method of claim 11, further comprising moving the collected symbol to a second location in the collection area based on a first spin event.

13. The method of claim 12, further comprising moving the collected symbol to a third location in the collection area based on a second spin event.

14. The method of claim 13, further comprising moving the collected symbol to an active area and modify the collected symbol into an active symbol based on one or more triggering events.

15. The method of claim 14, wherein the one or more triggering events is based at least on the collection area being full.

16. An electronic gaming system comprising:
a server including a server processor and a server memory;
a display device including a plurality of reels, the plurality of reels including one or more areas;
the server memory including one or more treasure spin feature structures; and
the server processor is configured to generate a first treasure symbol and move the first treasure symbol to a collection area, where the first treasure symbol has an equity value.

17. The electronic gaming system of claim 16, wherein the server processor is further configured to initiate a base game, a bonus game, and a treasure spin game.

18. The electronic gaming system of claim 17, wherein the server processor is further configured to store one or more collectable symbols in a collection area.

19. The electronic gaming system of claim 18, wherein the server processor is further configured to display a collected symbol in the collection area based on the one or more stored collectable symbols.

20. The electronic gaming system of claim 16, wherein the equity value has a cash value.
